(19) United States
(12) Patent Application Publication
(10) Pub. No.: US 2007/0026990 A1
(43) Pub. Date: Feb. 1, 2007

(54) Oil pressure control apparatus for automatic transmission

(75) Inventor: Kiyoharu Takagi, Okazaki-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/493,588

(22) Filed: Jul. 27, 2006

(30) Foreign Application Priority Data
Jul. 27, 2005 (JP) 2005-218000
Jul. 29, 2005 (JP) 2005-221016

(51) Int. Cl. F16H 31/00

(52) U.S. Cl. 475/116

(57) ABSTRACT

In an oil pressure control apparatus for an automatic transmission, a specific combination of ON and OFF states of shift valves is assigned to an automatic shift pattern for operating solenoid valves for each shift stage of an automatic shift mode. One of other combinations of the ON and OFF states of the shift valves is assigned to a first fixed shift pattern of a first forward shift stage at which two predetermined solenoid valves from among the solenoid valves are employed. The other one of the other combinations is assigned to a second fixed shift pattern of a second forward shift stage at which other solenoid valves from among the solenoid valves are employed, one of the first and second fixed shift patterns being selected in response to operations of the shift valves for driving a vehicle.

### CROSS REFERENCE TO RELATED APPLICATIONS

This application is based on and claims priority under 35 U.S.C. § 119 to Japanese Patent Application 2005-218000, filed on Jul. 27, 2005, and Japanese Patent Application 2005-221016, filed on Jul. 29, 2005, the entire content of which is incorporated herein by reference.

### FIELD OF THE INVENTION

This invention generally relates to an oil pressure control apparatus for an automatic transmission that controls directly an oil pressure, which is supplied from an oil pressure source, by a linear solenoid valve. More particularly, this invention pertains to improvement of durability and reliability of an oil pressure control apparatus for an automatic transmission against electric disconnection failure.

### BACKGROUND

Japanese examined patent publication No. 5-63664 (reference 1) discloses a transmission control apparatus which includes solenoid valves at the same number as frictional engagement elements and is capable of selectively establishing six forward shift stages. In this transmission control apparatus, there are five solenoid valves (e.g., linear solenoid valves) each for the frictional engagement elements C1, C2, C3, C4 and C5; a single ON/OFF solenoid valve; and two shift valves. In the event of an electric disconnection failure mode (electric interruption), an automatic shift operation (1st-3rd, 2nd to 5th-4th, 6th-5th) is implemented in response to a currently selected shift stage.

Japanese patent No. 2925505 (reference 2) and Japanese patent No. 2925506 (reference 3) each disclose a transmission control apparatus including therein five frictional engagement elements. The five frictional engagement elements are frictionally engaged by use of two solenoid valves; three shift valves; and three ON/OFF solenoid valves controlling the shift valves so that six forward shift stages can be established in the transmission. This transmission control apparatus implements a shift operation by introducing a line pressure to at least a predetermined frictional engagement element from among the five frictional engagement elements and by changing the frictional engagement elements to be frictionally engaged in response to an operation of the solenoid valves. In the event of an electric disconnection failure mode (electric interruption), a shift stage, which can be established in the transmission, is controlled to be a predetermined shift stage apart from the first and sixth shift stage or a shift stage higher than the predetermined shift stage.

However, in the structures disclosed in the references 2 and 3, a jumping shift operation (hereinafter, referred to as a skip shift operation), such as a shift operation from the third shift stage to the fifth shift stage, from the second shift stage to the fourth shift stage, from the fourth shift stage to the sixth shift stage and vice versa, can not be achieved. For example, in order to attempt a skip shift from the third shift stage to the fifth shift stage, a shift operation step by step such as from the third shift stage to the fifth shift stage via the fourth shift stage needs to be performed. This type of operation, however, may give an operator a feeling such as excessive shift operation, responsibility degradation.

In the light of the foregoing, being compared with the number of respective components in each reference 2 and 3, U.S. Pat. No. 6,585,617 (reference 4) discloses an electro-hydraulic control system for a multi-speed power transmission which includes therein: four linear solenoid valves (added another two), two shift valves (reduced one), and an ON/OFF solenoid valve (reduced two). Further, a single oil pressure switch (hereinafter referred to as an oil pressure SW) is added to this electro-hydraulic control system disclosed in the reference 4 so that a skip shift operation between the second shift stage and the sixth shift stage is carried out.

FIG. 54 is a block view illustrating a portion relevant to a shift control of an oil pressure circuit disclosed in the reference 4. FIG. 55 is a table for explaining an operation of each shift valve at each solenoid valve pattern; linear solenoid valves to be controlled; a shift stage to be maintained at a time of an electric disconnection failure mode. In this table, NH represents a normal high type linear solenoid valve, which is held engaged at a time of electric disconnection, while NL represents a normal low type linear solenoid valve, which is shifted to a released state at a time of electric disconnection failure mode. In other words, in the event of the electric disconnection, the NH-type linear solenoid valve is not electrically energized and is kept being supplied with oil pressure, and so a corresponding frictional engagement element can be engaged, while the NL-type linear solenoid valve is not electrically energized and is not supplied with oil pressure, and so a corresponding frictional engagement element can be released from an engaged state.

Under the garage shift operation (R-N-D, D-N-R), an ON/OFF solenoid valve 1 (hereinafter referred to as S1) switches a shift valve 1 (hereinafter referred to as SV1), and a linear solenoid valve 1 (hereinafter referred to as SL1) switches a shift valve 2 (hereinafter referred to as SV2). When the ON/OFF solenoid valve S1 is switched ON (∘) and the shift valve SV1 is operated to an ON-side, the line pressure PL is supplied to a linear solenoid valve SL2 so that the linear solenoid valve SL2 is operated.

For example, as is obvious from FIG. 54, under the neutral range of a shift lever, an oil pressure switch (hereinafter, referred to as an oil pressure SW) is switched ON by an oil pressure (PL reduced pressure of FIG. 54) which is obtained by reducing a pressure level of a line pressure, which is guided from a control valve, down to a lower pressure level which is sufficient to release the clutch C1. The shift valve SV2 is then operated. A reverse shift range of the shift lever is achieved with the clutch C3 and the brake B2 (C5) brake engaged, i.e., with a linear solenoid valve 3 (hereinafter referred to as SL3) and the linear solenoid valve SL2 operated to an engagement side. Therefore, when a shift range is to be shifted from the N range to the R range, after detecting a selection of the R range, the linear solenoid valve SL2 is operated to an engagement so as to first engage the brake B2 (C5). Because a reverse pressure (R pressure) has been supplied to the linear solenoid valve SL3, the linear solenoid valve SL3 can be then operated to an engagement side smoothly, and the brake C3 is frictionally engaged. Therefore, it is possible to reduce a garage shock which may occur due to the frictional engagement of the brake C3. However, this operation is not applicable to a case in which the shift valve SV1 has been stuck, as being summarized in a pattern at a R-range which is not related to the stick of the shift valve SV1.

Meanwhile, when a shift range is to be shifted from the N range to the D range, likewise, after frictionally engaging the brake B2 (C5), the linear solenoid valve SL1 is gradually controlled to an engagement side by a drive pressure (D pressure) already being supplied to the linear solenoid valve SL1. As a result, the clutch C1 is engaged. Therefore, a possible garage shock, which may occur due to the frictional engagement of the clutch C1, can be reduced, and a first shift stage is established in the transmission. Further, a linear solenoid valve 4 (hereinafter referred to as SL4), which has been supplied with the D pressure, is controlled to an engagement side, and so the brake B1 (C4) is frictionally engaged, while the brake B2 (C5) is released from the engagement in response to a control of the linear solenoid valve SL2 to a release side. As a result, a shift stage in the automatic transmission is shifted to the second shift stage, as being summarized in a pattern of a 1-2 shift operation at the D range of FIG. 55.

Next, when the ON/OFF solenoid valve S1 is switched OFF (×) from an ON-state (∘), the line pressure (PL pressure) is supplied to the shift valves SV1 and SV2, and the oil pressure SW is turned on. The shift valve SV2 is hence maintained at the ON-state (∘) in favor of a step of the shift valve SV2, and the line pressure (PL pressure) is hence supplied to the linear solenoid valve SL3. Further, with the shift valve SV1 switched off (×), the linear solenoid valve SL2, which had communicated with the brake B2 (C5), then communicates with the clutch C2. The frictional engagement elements C1, C2, C3 and B1 (C4) are controlled independently, thereby enabling to freely establish a shift stage between the second shift stage and the sixth shift stage.

Meanwhile, according to the configuration disclosed in the reference 4, at a time of an occurrence of an all electric disconnection failure, the ON/OFF solenoid valve S1 and the shift valve SV1 is at the OFF-state (×), as being summarized in a pattern at a D-range during electric disconnection failure. In such circumstances, the NH-type linear solenoid valves SL2 and t SL3 are controlled to the engagement side, and the clutch C1 and the brake C3 are frictionally engaged. The third shift stage is hence established in the transmission. However, when the linear solenoid valve SL2 is controlled to the engagement side in a state of a multiple shift pattern with the ON/OFF solenoid valve S1 at the OFF-state (×) and the shift valve SV1 at the ON-state (∘), the PL pressure latches the shift valve SV2 to the on side. The linear solenoid valve SL2 is then kept communicating with the clutch C2 and the fifth shift stage is established with the clutch C2 and the brake C3 engaged in the transmission. Therefore, even at a time of all electric disconnection failure while a shift stage from among the fourth, fifth and sixth shift stages is being selected with the linear solenoid valves SL2 and the clutch C2, an actual shift stage in the transmission is controlled at the fifth shift stage and a speed reduction shock can be precluded. When a vehicle needs to re-start, a limping can be performed at the third shift stage. Further, at a time of all electric disconnection failure while the ON/OFF solenoid valve S1 is at the ON-state (∘) and the shift valve SV1 is at the OFF-state (×), only the brake B2 (C5) is frictionally engaged and a neutral shift stage is established.

As described above, according to the configuration of the reference 4, electric disconnection failure approach and a skip shift, which both could not be solved by the references 1, 2 and 3, are solved. However, the following matters still need to be considered.

Fist of all, being compared with a simple configuration each disclosed in the references 2 and 3, cost advantages are lost according to the configuration of the reference 4. For example, being compared with a simple configuration disclosed in the references 2 and 3, it may be inevitable to add another two to the linear solenoid valves in each reference 2 and 3, so that a skip shift can be achieved. However, the configuration disclosed in the reference 4 requires totally five oil pressure switches (added one). On the other hand, being compared with a simple configuration each disclosed in the references 2 and 3, the total number of the ON/OFF solenoid valves is reduced from three to one, and the total number of the shift valves is reduced from two to one. However, the reference 4 requires another oil pressure SW additionally. Because an oil pressure SW is expensive, this addition may cancel the aforementioned cost reduction. As a result, the additional two linear solenoid valves increase the manufacturing cost of the system disclosed in the reference 4.

15] Further, the configuration of the reference 4 excels in solving electric disconnection failure more than the configurations of the references 2 and 3. However, the electric disconnection failure can be solved on the assumption that the NL-type linear solenoid valves are turned off at a time of electric disconnection. Here, we will consider a case of an ON-failure of the NL-type linear solenoid valves. For example, in the event that the linear solenoid valve SL4 (NL) suffers from an ON-failure due to a short-circuit or a foreign obstacle while the sixth shift stage is being selected with the clutch C2 (linear solenoid valve SL2) and the brake B1 (C4) (linear solenoid valves SL4) frictionally engaged, a down-shift operation, such as 6th to 5th shift stage (C2 and C3 engaged), 6th to 4th (C1 and C2 engaged), and so on, may be performed in accordance with a predetermined shift map. In such circumstances, interlocking may occur, and the oil pressure SW detects the interlocking and an actually selected shift stage in the transmission is controlled to return to the sixth shift stage.

Electric disconnection failure is assumed to have occurred to the linear solenoid valve SL3 (NH), which is a secondary failure, while the vehicle is running under the above-described condition. In this case, even if the linear solenoid valve SL2 is controlled to the ON-side and the clutch C2 is released from the engagement, the brake C3 (SL3) and the brake B1 (C4) are both frictionally engaged so that any shift stage can not be selected and a planetary gear-locking may occur.

In the light of the foregoing, shift patterns can be changed so that the above problem could be solved. However, the same state or event is generated even during the all electric disconnection mode, in which both the ON/OFF solenoid valve S1 and the shift valve SV1 are at the OFF-state (×). It is hence necessary to control the ON/OFF solenoid valve S1 at the ON-state (∘) and to control the SV at the OFF-state (×). Alternatively, it is hence necessary to control both the ON/OFF solenoid valve S1 and the shift valve SV1 at the ON-state (∘). However, if the ON/OFF solenoid valve S1 is switched from the OFF-state (×) to the ON-state (∘) in state where the sixth shift stage is being selected with the clutch C2 (linear solenoid valve SL2) and the B1 (C4) (linear solenoid valve SL4) engaged, there is a danger that the output shaft is locked. Therefore, prior to this change, it is necessary to control the linear solenoid valve SL2 to the ON-side and to control the linear solenoid valve SL2 to the disengagement side, i.e., to control an output pressure of the linear solenoid valve SL2 to be OFF. However, in response to the control of the linear solenoid valve SL2 to the disengagement side, the shift valve SV2, which had been latched by the output pressure of the linear solenoid valve SL2, is switched to the OFF-state by a spring force. As a result, a shift range is shifted to the N range, in which only the brake C4 (B1) has been engaged, and a driving force will disappears.

The secondary failure, in which the linear solenoid valve SL3 (NH) is an OFF-failure, was described above. Likewise, in the event of the OFF-failure of the linear solenoid valve SL2 (NH), which is a secondary failure, a shift rage is forced to the N range, according to the configuration disclosed in the reference 4.

19] If all electric disconnection occurs due to an OFF-operation of an ignition key by an operator, a cable dropping due to vibration, fuse blowing due to excessive current, or the like, during the ON-failure of the linear solenoid valve SL4, the ON/OFF solenoid valve S1 and the shift valve SV1 are switched to the OFF-state (×), as being summarized in the pattern at the D-range of FIG. 55 during disconnection failure mode. Therefore, the clutch C1 (SL2-NH), the brake C3 (SL3-NH), and the brake C4 ((B1), ON-failure of the SL4) are engaged and an interlocking may occur. That is, the above-described disconnection failure safe system does not occur appropriately. Moreover, because of all electric disconnection failure, a change of a shift patter or reduction in an output pressure of the linear solenoid valve are disabled, and so there is a danger that a speed of a vehicle drops so rapidly.

Further, as is obvious from FIG. 55, when a third failure or more occurs, two linear solenoid valves are operated and a fixed shift mode is selected. Alternatively, because there is no pattern by which an N-mode is established only with a single linear solenoid valve, interlocking is inevitable. Therefore, although these can be approached by use of a slip of an frictional member inside an automatic transmission, it should be considered that no approach by an oil pressure control system is applicable

Further, JP2005-024059A (reference 5) discloses an oil pressure control circuit in which plural change valves are provided between solenoid valves and frictional engagement elements. The plural change valves serve as a fail-safe mechanism against the OFF-failure of the solenoid valves. When the solenoid valves are at the OFF-failure, the frictional engagement element corresponding to the position of the change valves is supplied with a D-position pressure PD, and a vehicle can run at an appropriate shift stage.

As illustrated in FIG. 75, there are three types of valves known as the solenoid valve of the oil pressure control apparatus for an automatic transmission described above: a direct driven type linear solenoid valve illustrated in FIG. 75A; a three-way type spool linear solenoid illustrated in FIG. 75B; and a two-way type bleed valve illustrated in FIG. 75C. Recent developments have contributed to a direct driven type spool linear solenoid valve illustrated in FIG. 75C. The direct driven type spool linear solenoid valve can control a level of a line pressure directly with no use of a pilot pressure.

As a direct driven type linear solenoid valve, there are two types of valves: a normal low type valve (NL), which is controlled to a disengagement side in the event of disconnection failure and a normal high type valve (NH), which is controlled to an engagement side in the event of disconnection failure. An NL-type valve have been practically used, which can assure a requisite amount of oil with high precision. Meanwhile, currently, no NH-type valve, which can contribute to an automatic transmission in which a clutch-to-clutch control should be performed, is present currently. In order for the NH-type solenoid valve to assure a requisite amount of oil and to raise an output pressure in response to reduction in an indicated current, a spring force can be designed to be greater. However, if a force of a spring, which is housed in a limited space, is increased, there is a danger that a biasing performance may deteriorate due to fluctuations of spring loads. Further, it is possible to reduce a diameter of a spool valve, in order for the NH-type solenoid valve to assure a requisite amount of oil and to raise an output pressure. However, in this case, it is apparent that the solenoid valve may not be able to output oil at a large amount if the diameter of the spool valve is reduced.

241 Therefore, if all the linear solenoid valves, which are employed in an oil pressure control apparatus for an automatic transmission, are the aforementioned directly driven type, in view of a cost or space matter, only a normal low-type linear solenoid valve is applicable. However, an actually selected shift stage may not be maintained in the event of electric disconnection failure.

The reference 5 discloses an approach with an OFF-failure safe mechanism for an oil pressure circuit with only the normal low-type linear solenoid valves. Practically speaking, in addition to the Off-failure change valves, so-called ON-failure change valves are required. Moreover, in the condition where these plural change valves are provided at a downstream side of the linear solenoid valves and are disconnected from the line pressure or branch (communication with a drain), a length of an oil passage between each solenoid valve and a corresponding frictional engagement element is increased, which may hinder a downsizing of an oil pressure control apparatus, and in addition may cause an oil pressure vibration. Further, if another consideration is given to locking or sticking of a valve body of a change valve, there is a danger that a vehicle can not keep running at an actually selected shift stage, in the event of the failure. As described above, the conventional works still discloses a possible approach for maintaining an actually selected shift stage, at the event of electric disconnection failure.

As described above, some of the conventional works disclose that both a slip shift operation and electric disconnection failure approach can be settled by use of the limited number of linear solenoid valves. However, these approaches still needs to be costly improved and should be improved in durability against the second and third failures. Further, it is necessary to provide an oil pressure control apparatus for an automatic transmission, the apparatus which can employ any types of solenoid valves and excels in durability and reliability against electric disconnection failure in addition manufacturing cost and space.

### SUMMARY OF THE INVENTION

According to an aspect of the present invention an oil pressure control apparatus for an automatic transmission includes: plural frictional engagement elements engageable and disengageable and operated to establish plural N forward shift stages by being engaged or disengaged; solenoid valves allocated for at least a corresponding frictional engagement element among from the plural frictional engagement elements and operated to achieve an automatic shift mode in which the plural N forward shift stages are switched; a controller for controlling oil pressure supplied to the frictional engagement elements via the solenoid valves so that engagement and disengagement of the frictional engagement elements are controlled; and shift valves shifted ON and OFF by the controller in accordance with a shift pattern for each shift stage among from the plural N forward shift stages and configured to establish an oil passage between the respective solenoid valves and the at least corresponding frictional engagement element by being shifted ON and OFF. A specific combination of ON and OFF states of the shift valves is assigned to an automatic shift pattern for operating the solenoid valves for each shift stage of the automatic shift mode. One of other combinations of the ON and OFF states of the shift valves is assigned to a first fixed shift pattern of a first forward shift stage at which two predetermined solenoid valves from among the solenoid valves are employed. The other one of the other combinations is assigned to a second fixed shift pattern of a second forward shift stage at which other solenoid valves from among the solenoid valves are employed, one of the first and second fixed shift patterns being selected in response to operations of the shift valves for driving a vehicle.

### BRIEF DESCRIPTION OF THE DRAWINGS

The foregoing and additional features and characteristics of the present invention will become more apparent from the following detailed description considered with reference to the accompanying drawings, wherein:

FIG. 1 is a block diagram illustrating an oil pressure circuit of an oil pressure control apparatus for an automatic transmission according to embodiments of the present invention;

FIG. 2 is a table illustrating a relation among shift valve patterns, frictional engagement elements (clutch and brake), and linear solenoid valves;

FIG. 3 is a table shown in FIG. 2 with types (NH/NL) of an electromagnetic valve;

FIG. 4 is a view for explaining an electromagnetic valve which is applicable for the embodiments of the present invention;

FIG. 5 is a block diagram illustrating an oil pressure circuit of an oil pressure control apparatus according to a first embodiment of the present invention;

FIG. 6 is a table illustrating a relation among shift valve patterns, frictional engagement elements, and linear solenoid valves according to the first embodiment of the present invention.

FIG. 7 is a block diagram shown in FIG. 5 with a brake control valve (pressure reducing valve);

FIG. 8 is a block diagram illustrating a condition of the oil pressure circuit under a 1-2 automatic shift mode according to the first embodiment of the present invention;

FIG. 9 is a block diagram illustrating a condition of the oil pressure circuit under a 2-6 automatic shift mode according to the first embodiment of the present invention;

FIG. 10 is a block diagram illustrating a condition of the oil pressure circuit under a first fixed shift mode according to the first embodiment of the present invention;

FIG. 11 is a block diagram illustrating a condition of the oil pressure circuit under a second fixed shift mode according to the first embodiment of the present invention;

FIG. 12 is a block diagram illustrating a condition of the oil pressure circuit under a third fixed shift mode according to the first embodiment of the present invention;

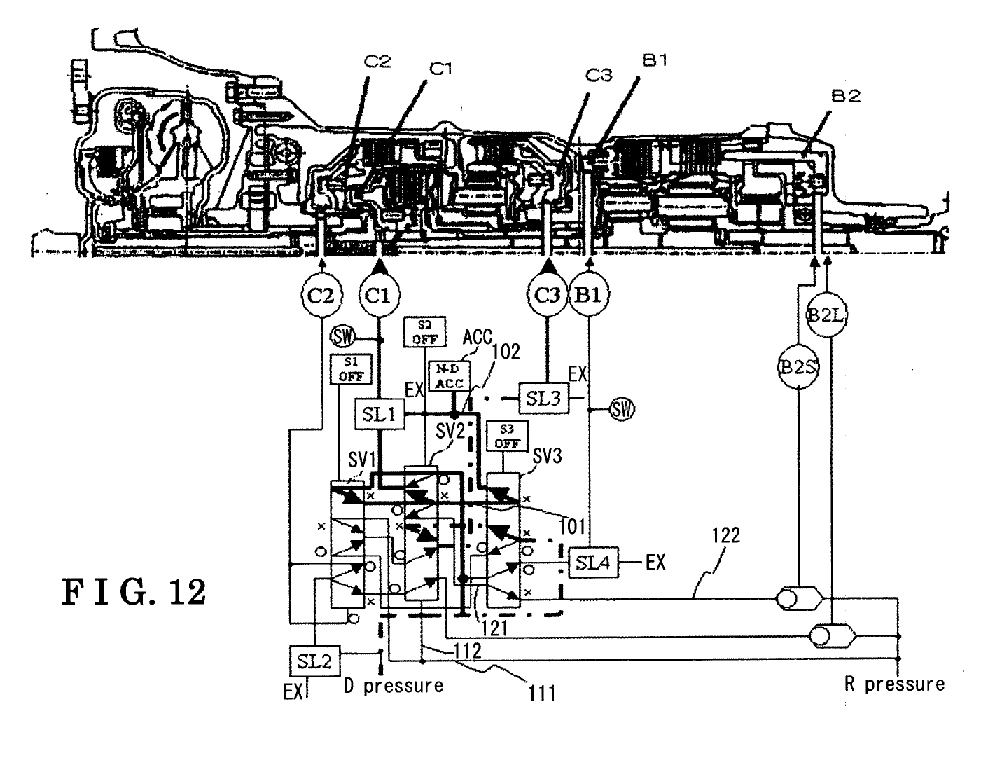

FIG. 13 is a block diagram illustrating a condition of the oil pressure circuit under a fourth fixed shift mode according to the first embodiment of the present invention;

FIG. 14 is a block diagram illustrating a condition of the oil pressure circuit under a fifth fixed shift mode according to the first embodiment of the present invention;

FIG. 15 is a block diagram illustrating a condition of the oil pressure circuit under a sixth fixed shift mode according to the first embodiment of the present invention;

FIG. 16 is a block diagram illustrating a condition of the oil pressure circuit when R-range is selected according to the first embodiment of the present invention;

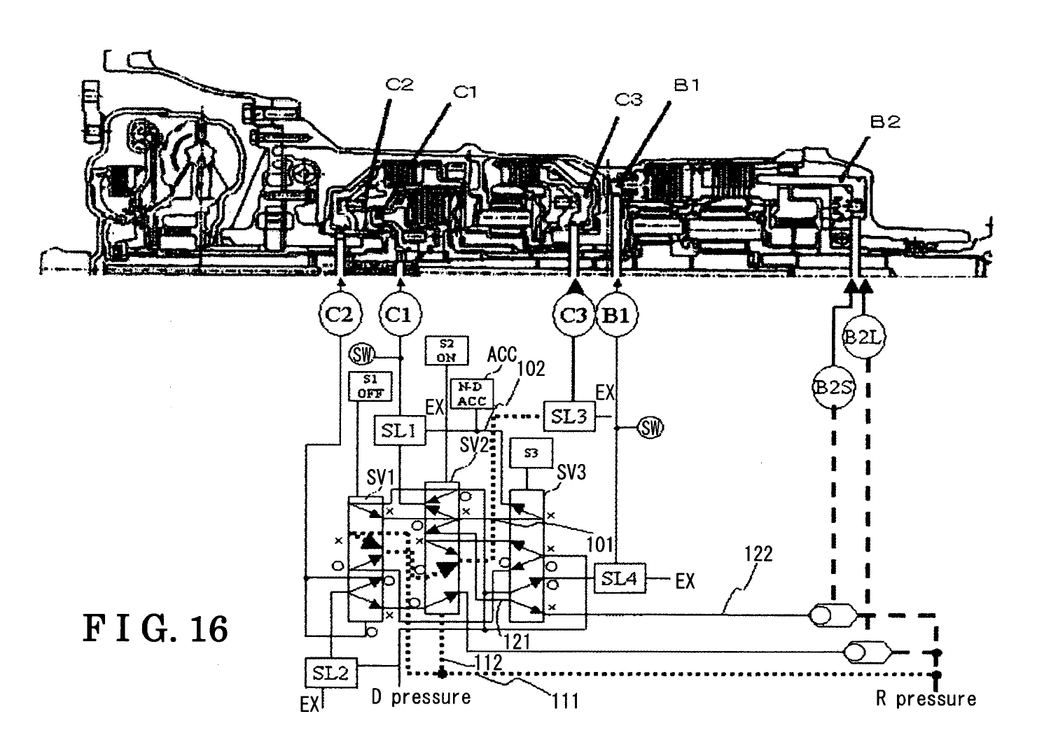

FIG. 17 is a block diagram illustrating a condition of the oil pressure circuit when ON/OFF solenoid valves S1 and S2 are OFF-state (×) at the R-range according to the first embodiment of the present invention;

FIG. 18 is a block diagram illustrating a condition of the oil pressure circuit when the ON/OFF solenoid valves S1 and S2 are at ON-, OFF-states (ox) or at ON-, ON-states (∘ ∘) at the R-range according to the first embodiment of the present invention;

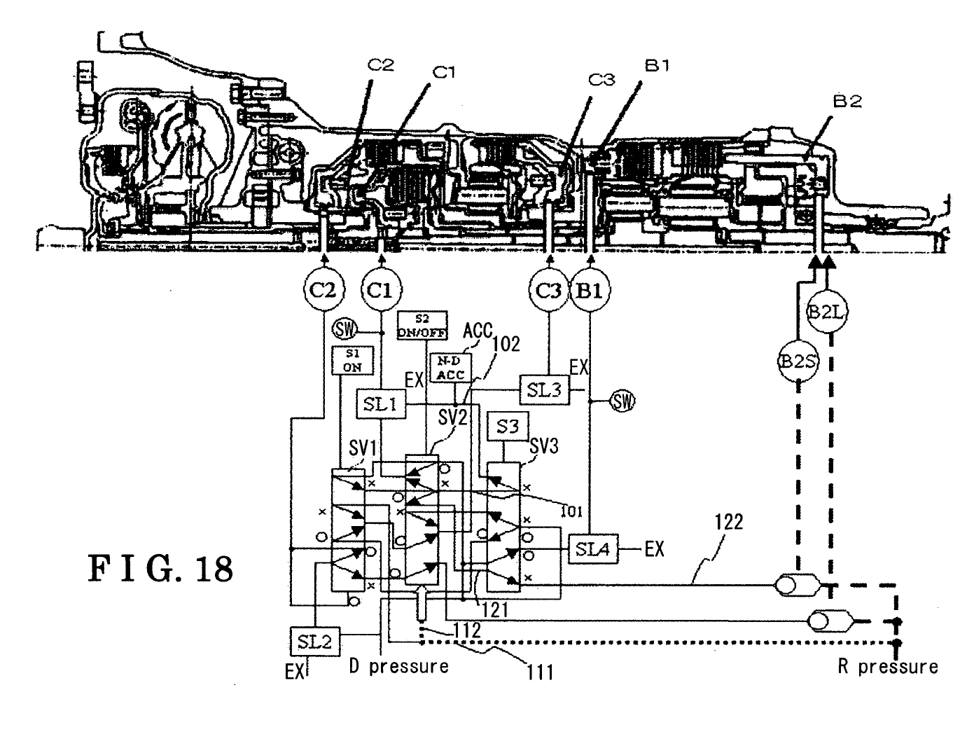

FIG. 19 is a block diagram illustrating an oil pressure circuit of an oil pressure control apparatus according to a second embodiment of the present invention;

FIG. 20 is a table illustrating a relation among shift valve patterns, frictional engagement elements, and linear solenoid valves according to the second embodiment of the present invention;

FIG. 21 is a view for explaining a relation between an output oil presser of linear solenoid valve SL2 and an indicator current;

FIG. 22 is a view for explaining a state of the frictional engagement elements and the linear solenoid valves in a condition where linear solenoid valve SL2 is turned on and solenoid S3 is turned from on to off according to the second embodiment of the present invention;

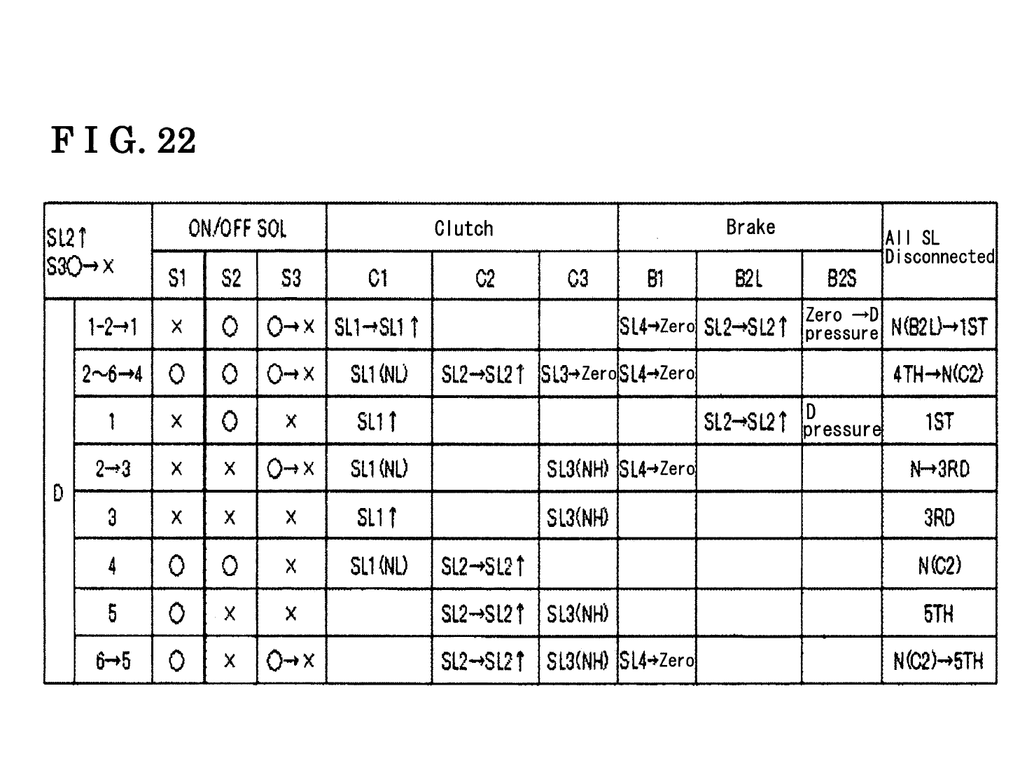

FIG. 23 is a block diagram illustrating a condition of the oil pressure circuit when ON/OFF solenoid valves S1 and S3 are at the OFF-state (×) at the R-range according to the second embodiment of the present invention;

FIG. 24 is a block diagram illustrating a condition of the oil pressure circuit when the ON/OFF solenoid valve S1 is at the ON-state (∘) and the ON/OFF solenoid valve S3 is at the OFF-state (×) at the R-range according to the second embodiment of the present invention;

FIG. 25 is a view for explaining a relation between an output oil presser of linear solenoid valve SLT and an indicator current;

FIG. 26 is a block diagram illustrating a first condition of the oil pressure circuit when the switching valve is activated at the R-range according to the second embodiment of the present invention;

FIG. 27 is a block diagram illustrating a second condition of the oil pressure circuit when the switching valve is activated at the R-range according to the second embodiment of the present invention;

FIG. 28 is a block diagram illustrating a condition of the oil pressure circuit under a first fixed shift mode according to the second embodiment of the present invention;

FIG. 29 is a block diagram illustrating a condition of the oil pressure circuit under a third fixed shift mode according to the second embodiment of the present invention;

FIG. 30 is a block diagram illustrating a condition of the oil pressure circuit under a fourth fixed shift mode according to the second embodiment of the present invention;

FIG. 31 is a block diagram illustrating a condition of the oil pressure circuit under a fifth fixed shift mode according to the second embodiment of the present invention;

FIG. 32 is a block diagram illustrating an oil pressure circuit of an oil pressure control apparatus according to a third embodiment of the present invention;

FIG. 33 is a table illustrating a relation among shift valve patterns, frictional engagement elements, and linear solenoid valves according to the third embodiment of the present invention;

FIG. 34 is a block diagram illustrating a condition of the oil pressure circuit under a first to second automatic shift mode according to the third embodiment of the present invention;

FIG. 35 is a block diagram illustrating a condition of the oil pressure circuit under a second though sixth automatic shift mode according to the third embodiment of the present invention;

FIG. 36 is a block diagram illustrating a condition of the oil pressure circuit under a first fixed shift mode according to the third embodiment of the present invention;

FIG. 37 is a block diagram illustrating a condition of the oil pressure circuit under a second fixed shift mode according to the third embodiment of the present invention;

FIG. 38 is a block diagram illustrating a condition of the oil pressure circuit under a third fixed shift mode according to the third embodiment of the present invention;

FIG. 39 is a block diagram illustrating a condition of the oil pressure circuit under a fourth fixed shift mode according to the third embodiment of the present invention;

FIG. 40 is a block diagram illustrating a condition of the oil pressure circuit under a fifth fixed shift mode according to the third embodiment of the present invention;

FIG. 41 is a block diagram illustrating a condition of the oil pressure circuit under a sixth fixed shift mode according to the third embodiment of the present invention;

FIG. 42 is a block diagram illustrating a condition of the oil pressure circuit at the R-range according to the third embodiment of the present invention;

FIG. 43 is a block diagram illustrating a condition of the oil pressure circuit when a solenoid valve S2 is stuck at the R-range according to the third embodiment of the present invention;

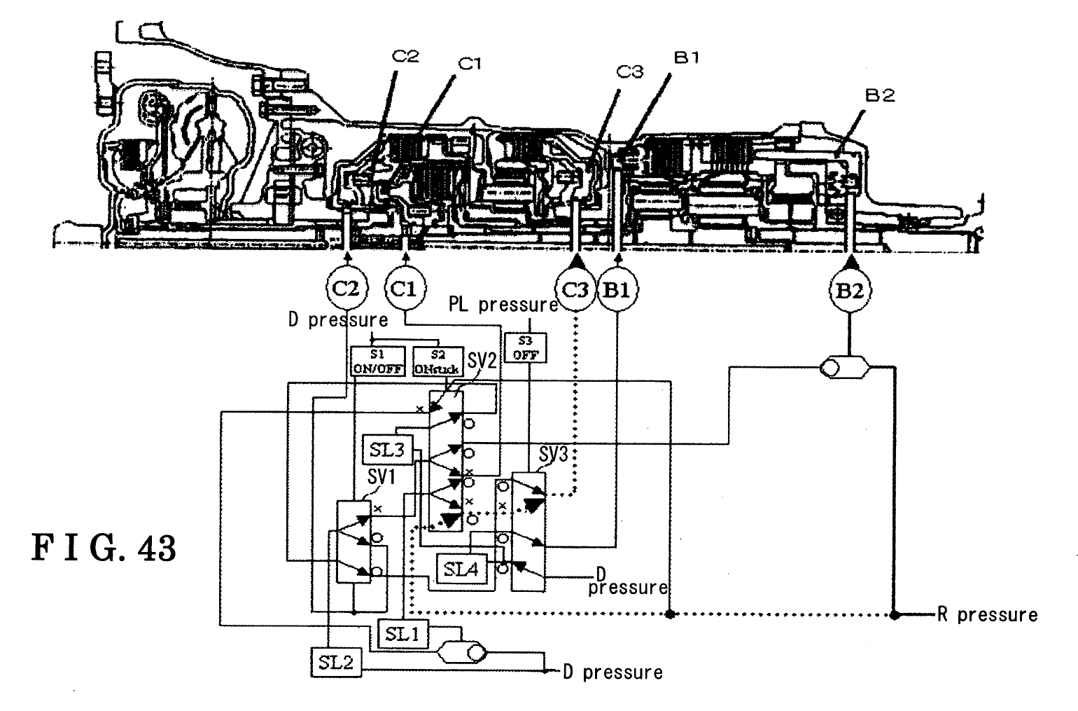

FIG. 44 is a block diagram illustrating an oil pressure circuit of an oil pressure control apparatus according to a fourth embodiment of the present invention;

FIG. 45 is a block diagram illustrating an oil pressure circuit of an oil pressure control apparatus according to a fifth embodiment of the present invention;

FIG. 46 is a table illustrating a relation among shift valve patterns, frictional engagement elements, and linear solenoid valves according to the fifth embodiment of the present invention;

FIG. 47 is a block diagram illustrating a condition of the oil pressure circuit under a second fixed shift mode according to the fifth embodiment of the present invention;

FIG. 48 is a block diagram illustrating a condition of the oil pressure circuit under a sixth fixed shift mode according to the fifth embodiment of the present invention;

FIG. 49 is a block diagram illustrating an oil pressure circuit of an oil pressure control apparatus according to a sixth embodiment of the present invention;

FIG. 50 is a block diagram illustrating an oil pressure circuit shown in FIG. 32 with an oil pressure switch;

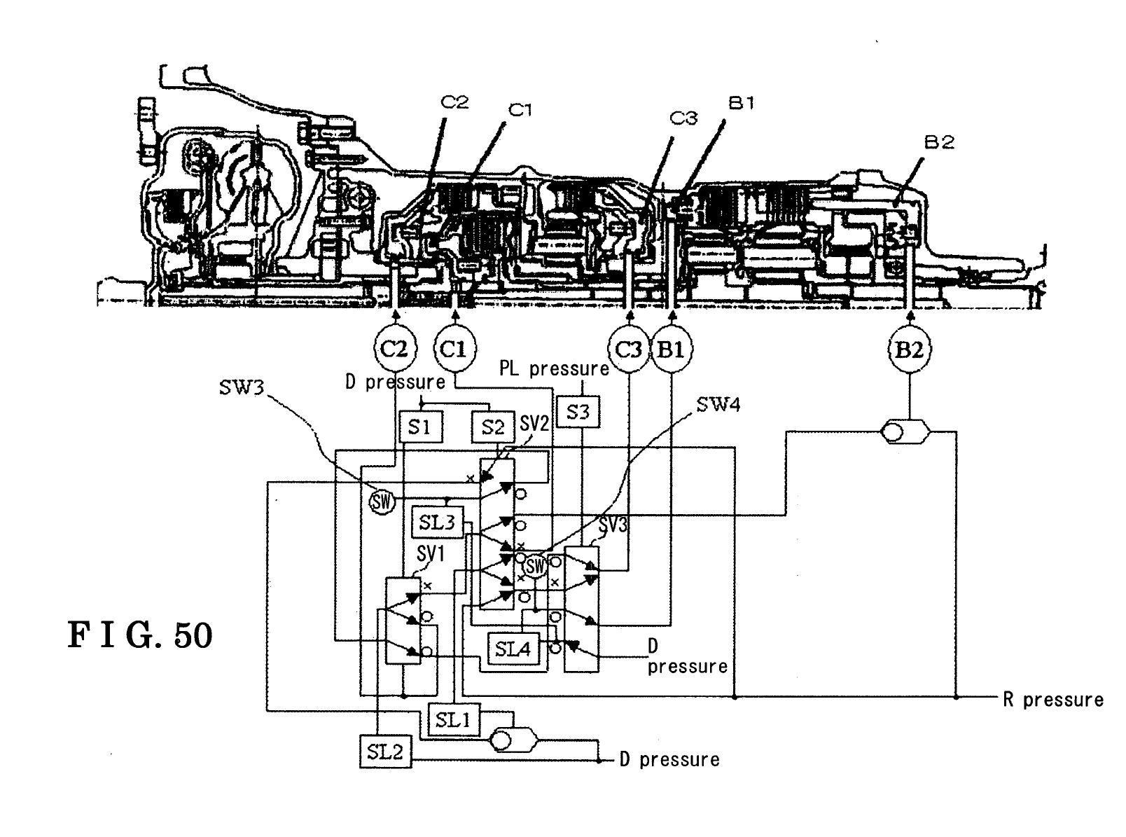

FIG. 51 is a block diagram illustrating an oil pressure circuit shown in FIG. 44 with an oil pressure switch;

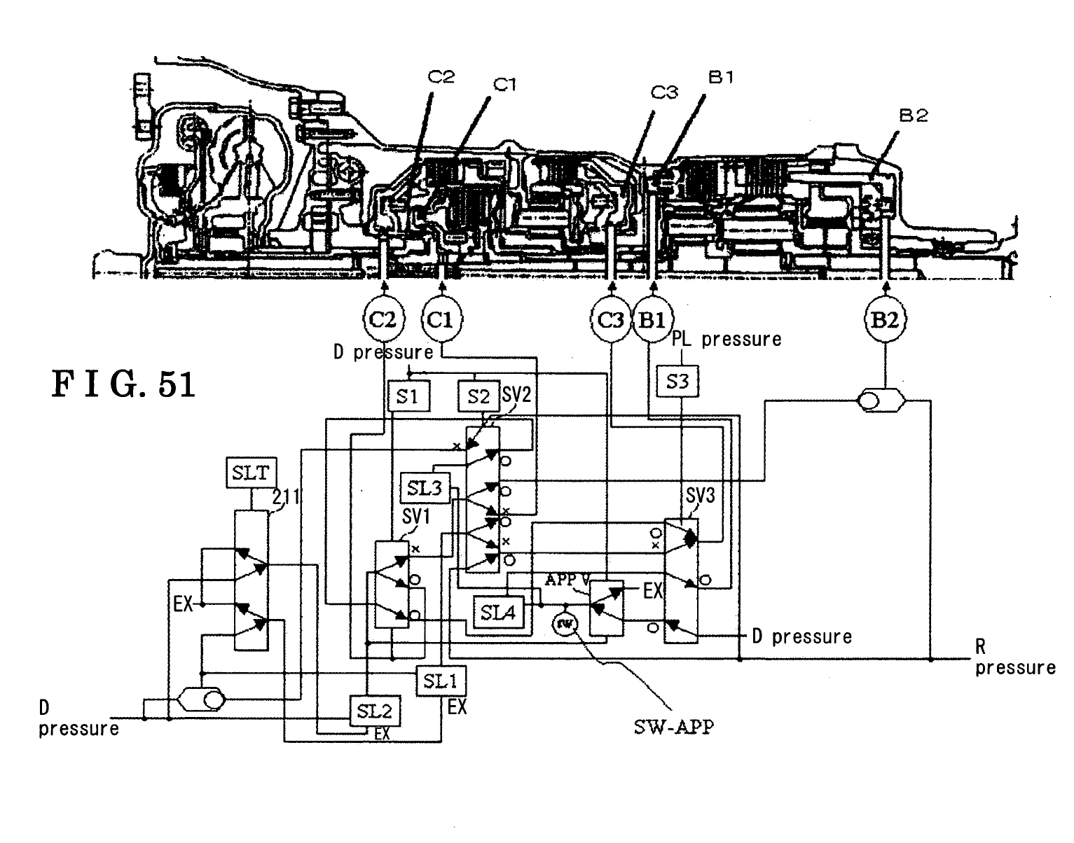

FIG. 52 is a block diagram illustrating an oil pressure circuit shown in FIG. 45 with an oil pressure switch;

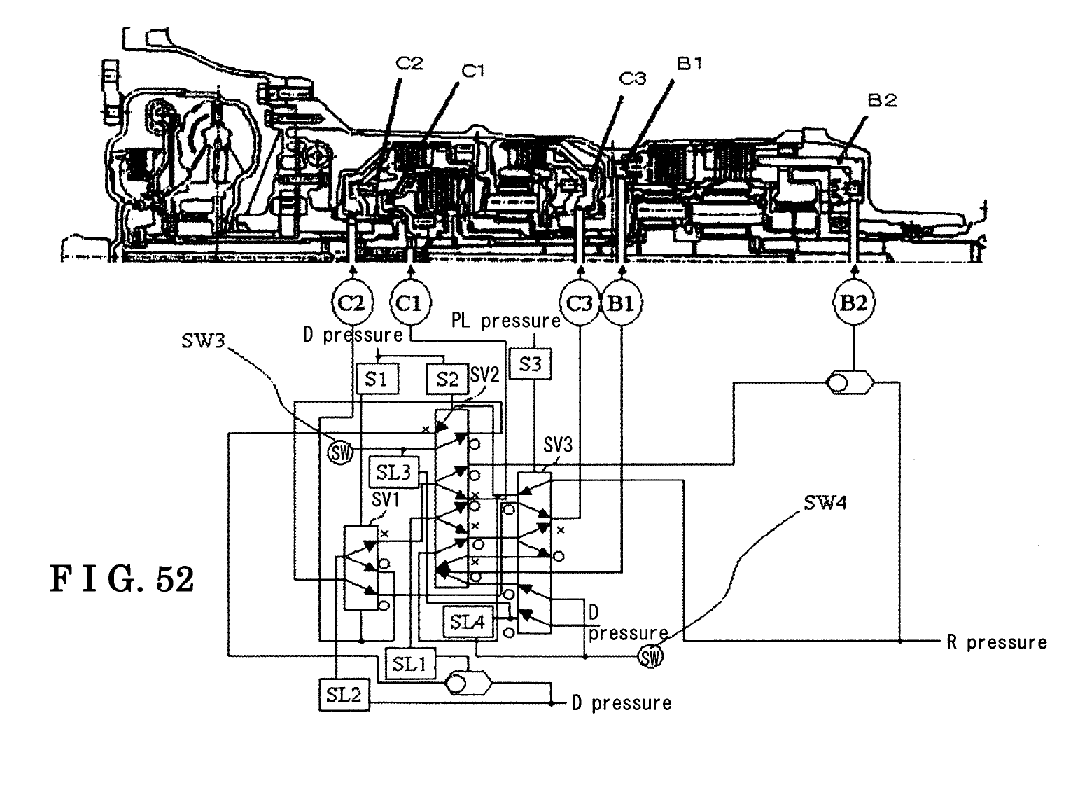

FIG. 53 is a block diagram illustrating an oil pressure circuit shown in FIG. 49 with an oil pressure switch;

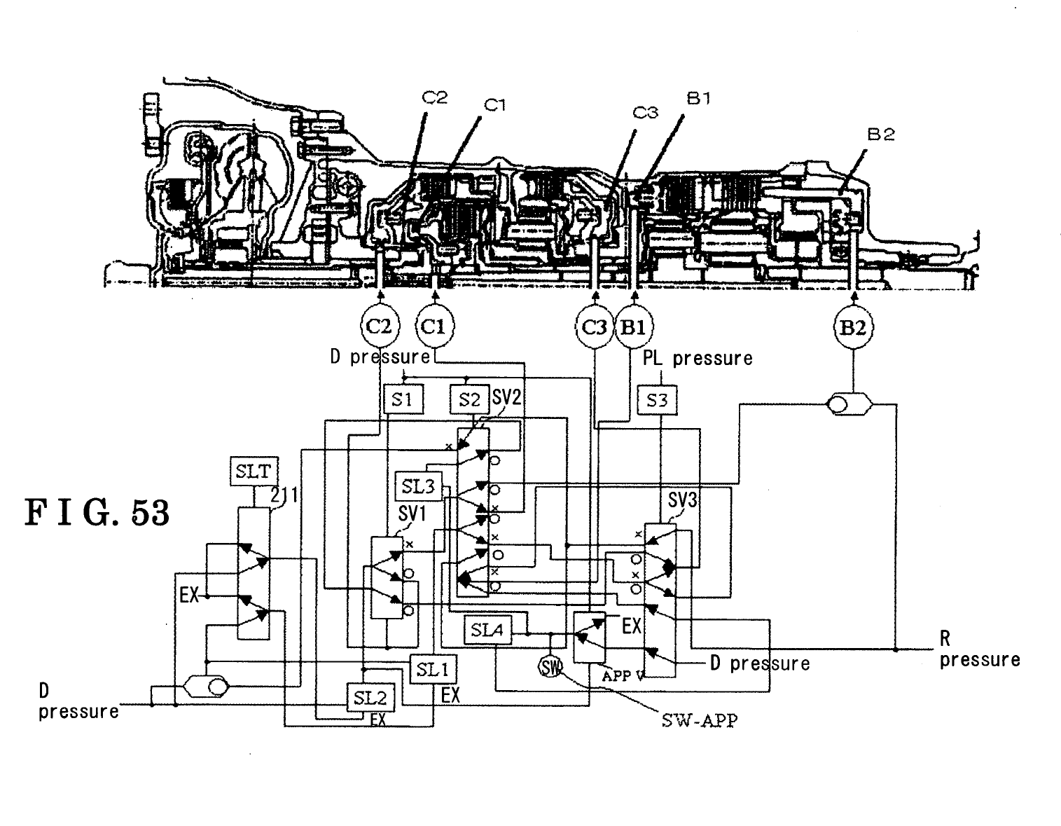

FIG. 54 is a block diagram illustrating a related part of a shift control according to a fourth related art;

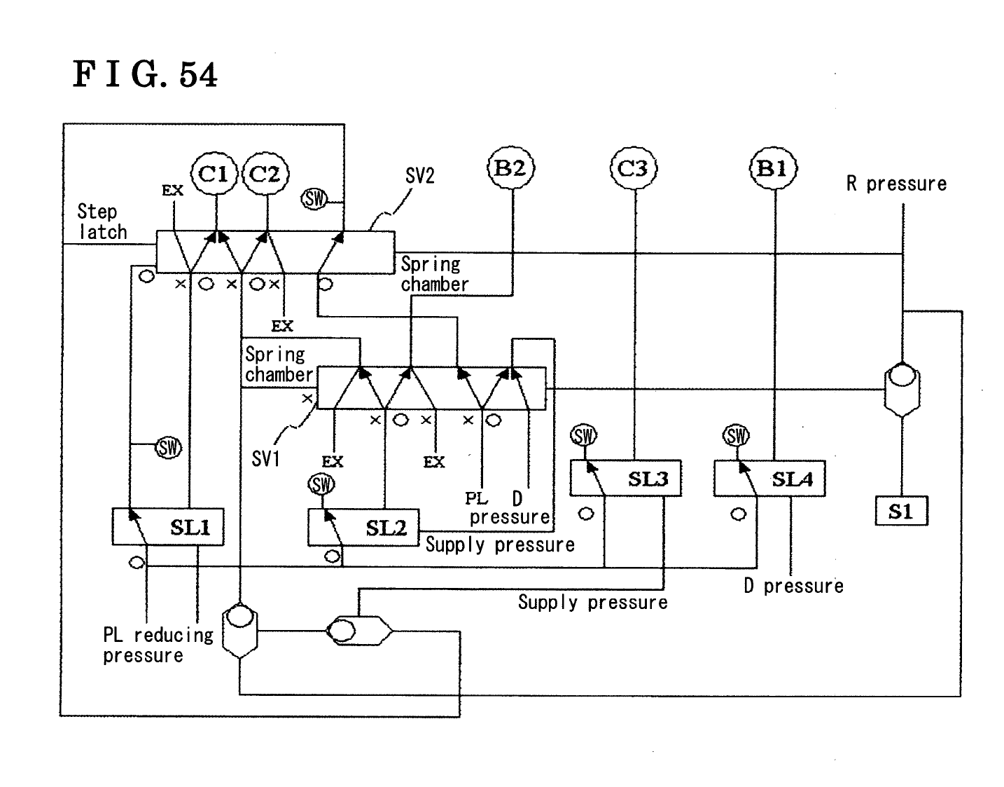

FIG. 55 is a table illustrating a relation among shift valve patterns, frictional engagement elements, and linear solenoid valves according to the fourth related art;

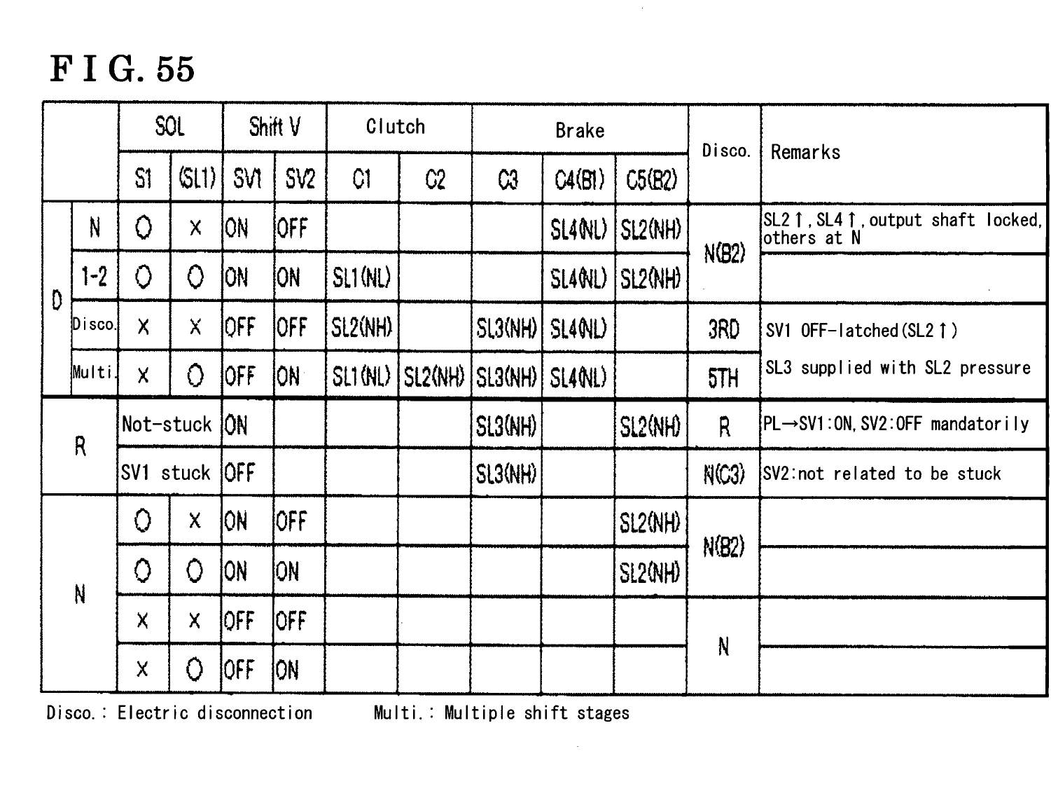

FIG. 56 is a block view illustrating an oil pressure circuit of an oil pressure control apparatus for an automatic transmission according to a sixth embodiment of the present invention;

FIG. 57 is a table summarizing a relation of shift valve patterns; frictional engagement elements and linear solenoid valves;

FIG. 58 is a block view shown in FIG. 56 with a brake control valve (pressure reducing valve);

FIG. 59 is a block view illustrating a condition of the oil pressure circuit under a 1-2 automatic shift mode according to the sixth embodiment of the present invention;

FIG. 60 is a block view illustrating a condition of the oil pressure circuit under a 2-6 automatic shift mode according to the sixth embodiment of the present invention;

FIG. 61 is a block view illustrating a condition of the oil pressure circuit under a first fixed shift mode according to the sixth embodiment of the present invention;

FIG. 62 is a block view illustrating a condition of the oil pressure circuit under a second fixed shift mode according to the sixth embodiment of the present invention;

FIG. 63 is a block view illustrating a condition of the oil pressure circuit under a third fixed shift mode according to the sixth embodiment of the present invention;

FIG. 64 is a block view illustrating a condition of the oil pressure circuit under a fourth fixed shift mode according to the sixth embodiment of the present invention;

FIG. 65 is a block view illustrating a condition of the oil pressure circuit under a fifth fixed shift mode according to the sixth embodiment of the present invention;

FIG. 66 is a block view illustrating a condition of the oil pressure circuit under a sixth fixed shift mode according to the sixth embodiment of the present invention;

FIG. 67 is an example of a shift valve applicable for the embodiments of the present invention;

FIG. 68 is a block view illustrating an oil pressure circuit of an oil pressure control apparatus for an automatic transmission according to a seventh embodiment of the present invention;

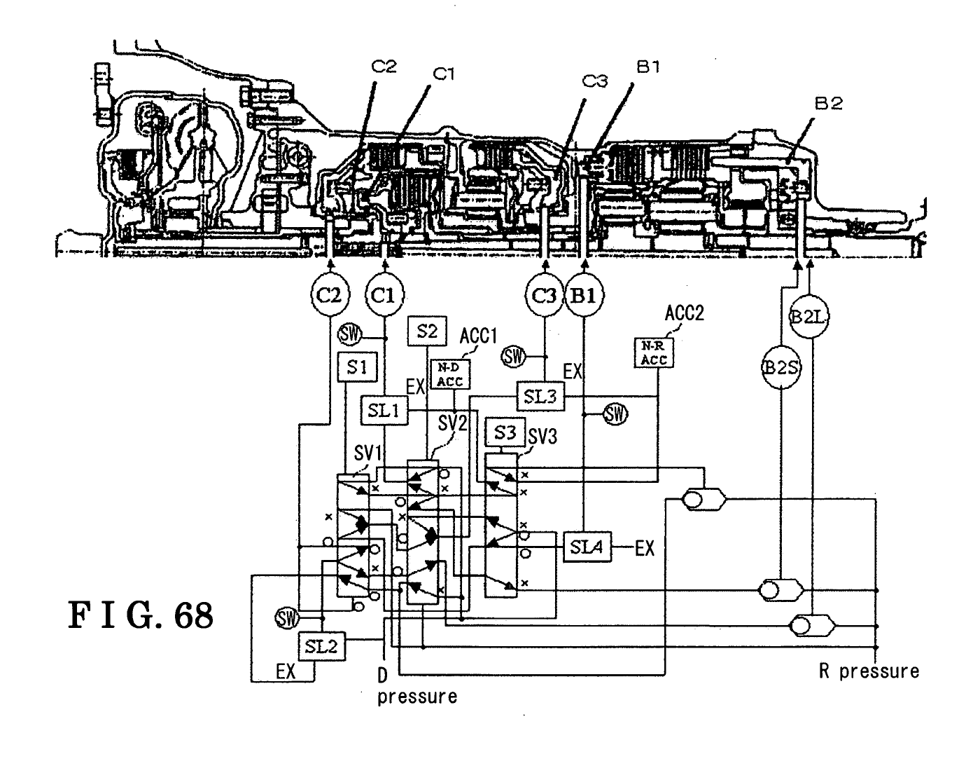

FIG. 69 is a table summarizing a relation of shift valve patterns; frictional engagement elements and linear solenoid valves;

FIG. 70 is a block view illustrating an oil pressure circuit of an oil pressure control apparatus for an automatic transmission according to an eighth embodiment of the present invention;

FIG. 71 is a table summarizing a relation of shift valve patterns, frictional engagement elements and linear solenoid valves;

FIG. 72 is a block view illustrating an oil pressure circuit of an oil pressure control apparatus for an automatic transmission according to a ninth embodiment of the present invention;

FIG. 73 is a block view illustrating an oil pressure circuit of an oil pressure control apparatus for an automatic transmission according to a tenth embodiment of the present invention;

FIG. 74 is a table summarizing a relation of shift valve patterns, frictional engagement elements and linear solenoid valves; and

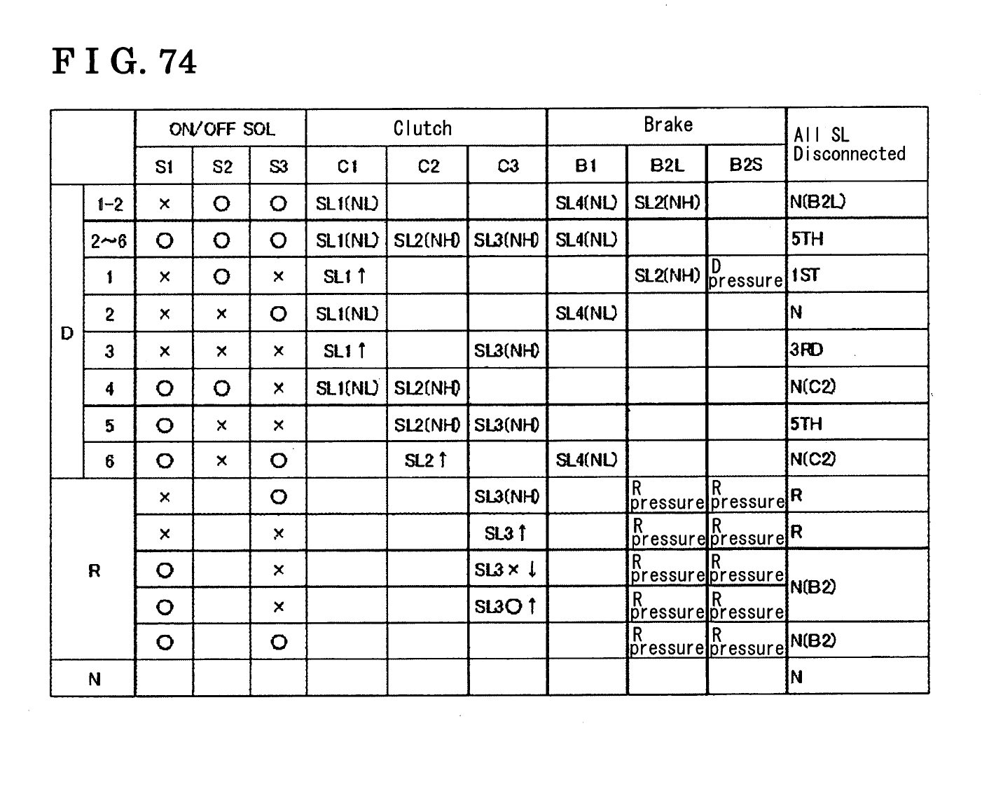

FIG. 75 is a view for explaining an example of a solenoid valve applicable for the embodiments of the present invention.

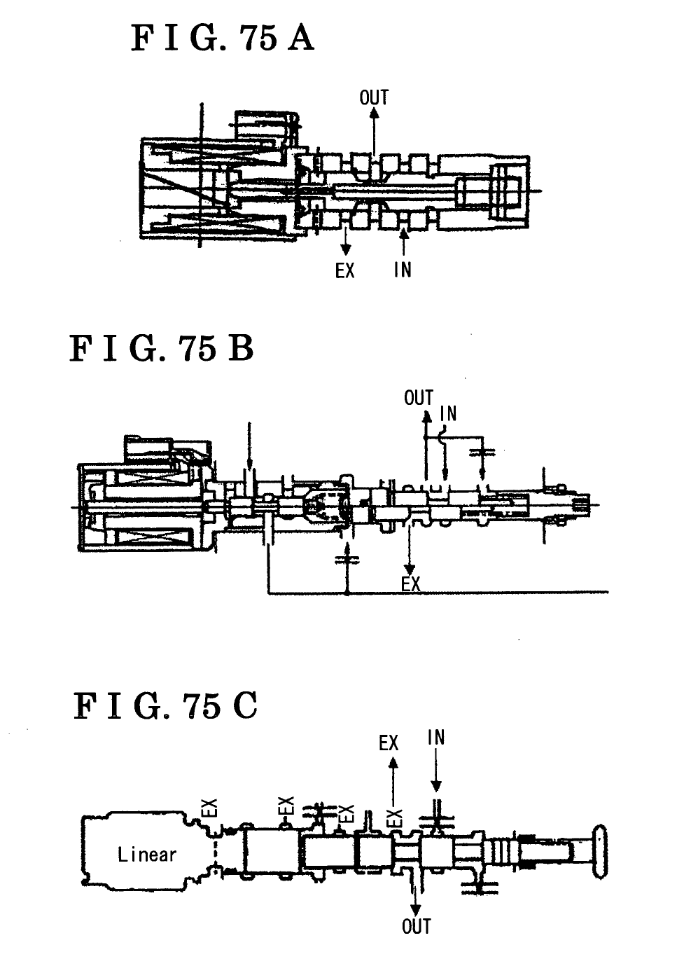

### DETAILED DESCRIPTION

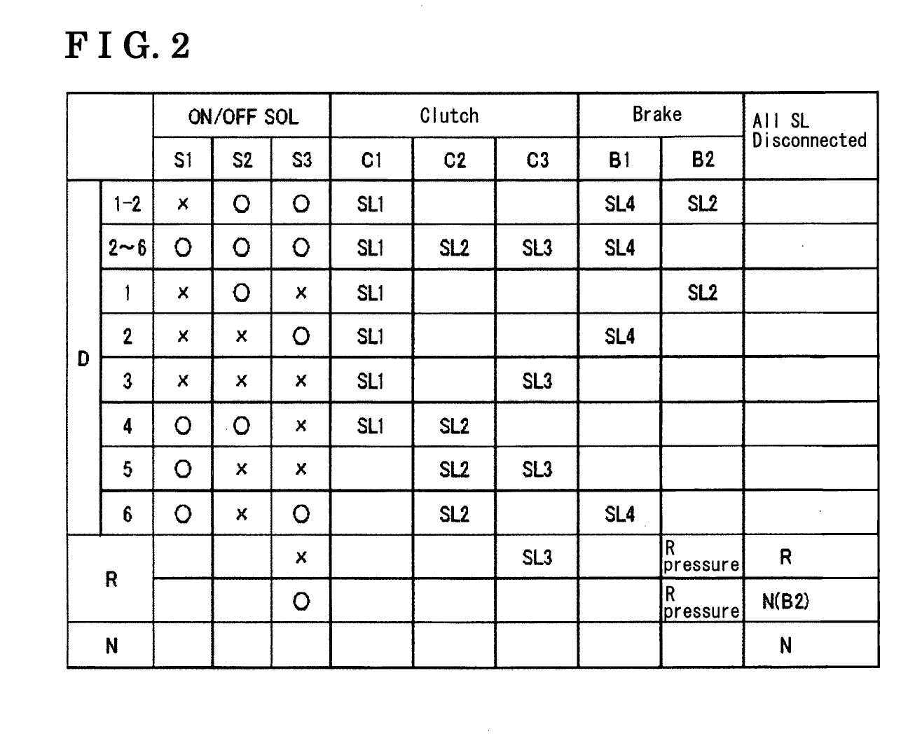

Embodiments of the present invention will be described hereinbelow with reference to the attached drawings. An oil pressure control apparatus according to the embodiments of the present invention includes an ECU (Electronic Control Unit; not illustrated), three shift valves (shift valves SV1, SV2, and SV3), and three solenoid valves (solenoid valves S1, S2, and S3) which respectively switch the shift valves SV1, SV2, SV3 on and off. With reference to a D-range in FIG. 2, eight shift patterns, which are prescribed by the third power of two (2 are configurable by means of operations of the solenoid valves S1, S2, S3. Two of the eight shift patterns are assigned to a multiple shift pattern (i.e., a first automatic shift pattern), in which a skip shift operation can be performed, and to a lower shift pattern (i.e., a second automatic shift pattern), in which a lower shift operation can be performed. Further, the other six of the eight shift patterns are assigned to fixed shift stages.

According to the embodiments of the present invention, six forward shift stages can be established by an appropriate combination of five frictional engagement elements. In the second automatic shift pattern, in which the lower shift operation can be performed, three linear solenoid valves SL1, SL2, and SL4 out of four linear solenoid valves SL1, SL2, SL3, SL4 are controlled for shifting from a first shift stage to a second shift stage and for shifting from the second shift stage to the first shift stage (1st-2nd), as illustrated in the automatic shift pattern 1-2 at the D-range in FIG. 2. In the first automatic shift pattern, in which the skip shift operation can be performed, all the four linear solenoid valves SL1, SL2, SL3, SL4 are controlled for establishing any shift stage between the second shift stage and the sixth shift stage, as illustrated in the automatic shift pattern 2-6 at the D-range in FIG. 2. In each fixed shift stage pattern of 1st, 2nd, 3rd, 4th, 5th, 6th, two linear solenoid valves out of the four linear solenoid valves are automatically engaged for establishing each fixed shift stage, as illustrated in the fixed shift stages 1, 2, 3, 4, 5 and 6 at the D-range in FIG. 2.

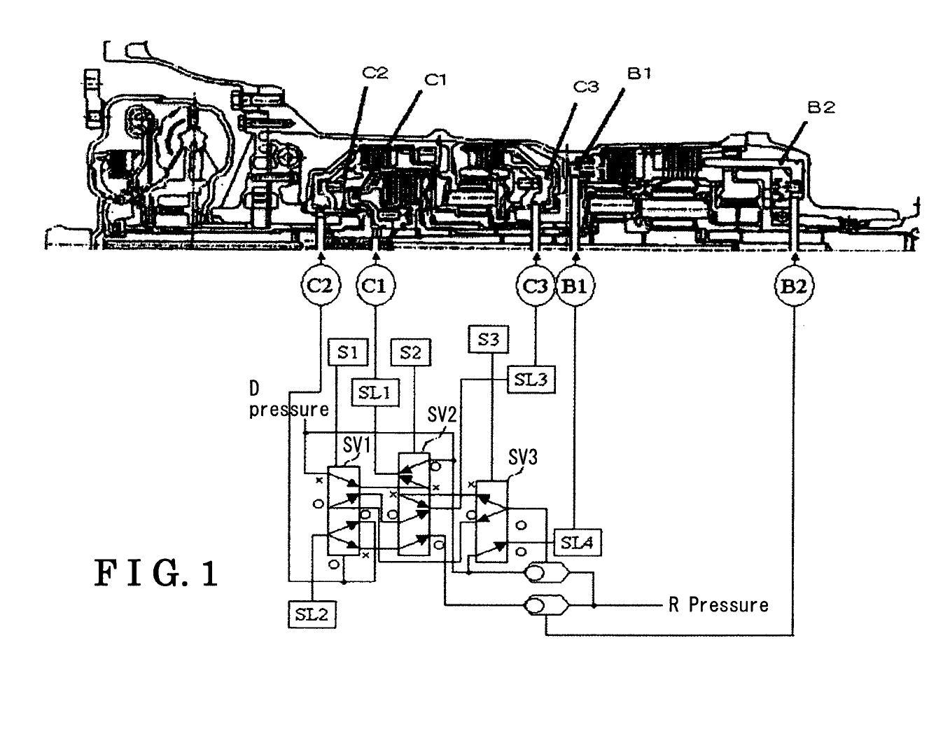

With reference to FIGS. 1 and 2, output oil passages of the linear solenoid valve SL2, which works for engaging and disengaging both the clutch C2 and the brake B2, are switched by the shift valve SV2. The linear solenoid valve SL1 is exclusively used for control of a clutch C1, the linear solenoid valve SL3 is exclusively used for control of a clutch C3, and the linear solenoid valve SL4 is exclusively used for control of a brake B1.

A normal high type (hereinafter, referred to as NH) linear solenoid valve holds an engagement of the frictional engagement element at the time of disconnection of the linear solenoid valve, while a normal low type (hereinafter, referred to as NL) linear solenoid valve releases the engagement thereof at the time of disconnection of the linear solenoid valve. Two of the four linear solenoid valves, which are the linear solenoid valve SL2 and one of linear solenoid valve SL1 and linear solenoid valve SL3, are NH type, and the other linear solenoid valves are NL type. A fixed shift stage (fifth shift stage), which is employed in the event of all electric disconnection at which two linear solenoid valves are used, and a fixed shift stage, which is employed in the event of the ON-failure of the NL-type linear solenoid valve at which at least one NH-type linear solenoid valve is used, are established by a selected combination of,the shift valves. Therefore, it is possible to preclude an impossibility of engagement of the frictional engagement elements, the impossibility which may occur due to the all-electric disconnection as a primary failure. It is further possible to avoid a possible interlock due to an ON-failure of the NL-type linear solenoid valve.

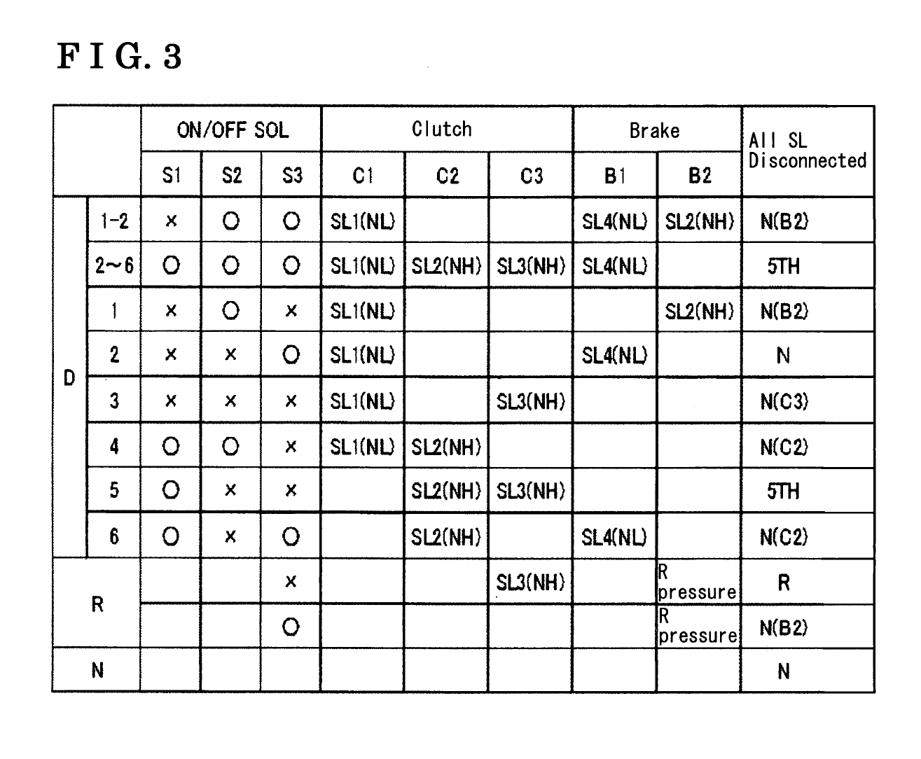

Illustrated in FIG. 3 is a relation among shift valve patterns, the frictional engagement elements (clutches and brakes), and the linear solenoid valves according to the embodiments of the present invention in which the linear solenoid valve SL1 exclusively for the clutch C1 is NL type, the linear solenoid valve SL2, which works for engaging and disengaging both the clutch C2 and the brake B2, is NH type, the linear solenoid valve SL3 exclusively for the clutch C3 is NH type, and the linear solenoid valve SL4 exclusively for the brake B1 is NL type. In a condition where all the linear solenoid valves are disconnected at the D-range, a vehicle can be driven at least at the fifth shift stage. Therefore, even in the event that the ON-failure occurs to the NL-type linear solenoid valve SL1, a fixed shift pattern can be selected. That is, it is possible to address a secondary failure of the other linear solenoid valves.

As illustrated in FIG. 1, an increase of the number of oil passages is minimized, a length of each oil passage between each frictional engagement element and the electromagnetic valve (i.e., linear solenoid valve) is reduced, and each electromagnetic valve is arranged appropriately relative to each frictional engagement element.

According to an example shown in FIG. 3, because a vehicle can drive only at the fifth shift stage in the event that the electric disconnection occurs while the D-range is being selected, restart of the vehicle may become difficult although there is no problem at the time of a high-speed driving. In the light of the forgoing, the vehicle can be driven by selecting a fixed shift stage pattern with all NH-type linear solenoid valves.

However, as described above, if all the linear solenoid valves are changed into NH type, an interlock may be created at the primary failure during a shift mode. Therefore, a fail-safe valve, or the like, is required for preventing the interlock and the number of components may thereby be increased and oil passage structures may thereby be complicated. Further, the oil passages may be configured in such a manner that target frictional engagement elements (the clutch C1 and the brake B1) are supplied with line pressure by interrupting output oil passages by means of the shift valve. However, it may cause the NL-type linear solenoid valves SL1 and SL4 at the upstream side of the shift valves against a disconnection failure. Further, it may lose an oil passage configuration illustrated in FIG. 1 in which all linear solenoid valves are provided at the downstream side of the shift valves.

### First Embodiment

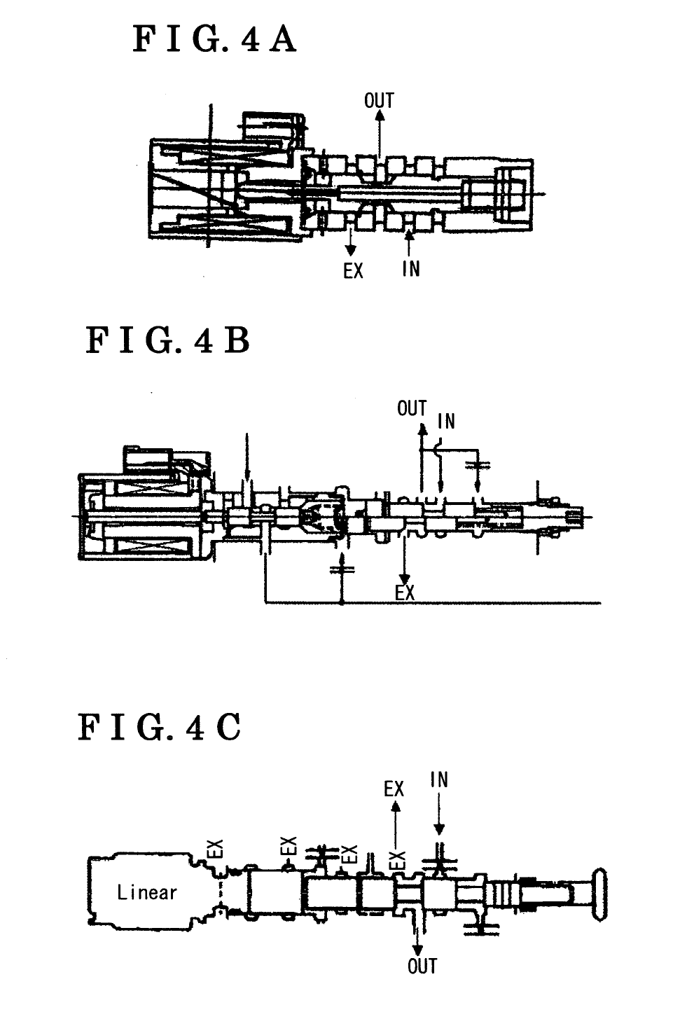

A first embodiment of the present invention will be explained hereinafter. The oil pressure control apparatus according to the first embodiment of the present invention is applicable for a direct pressure type linear solenoid valve shown in FIG. 4A and a linear solenoid valve with a control valve shown in FIGS. 4B and 4C. The frictional engagement elements can be engaged, regardless of the type (NH/NL) of the linear solenoid valve, by supplying the line pressure through an exhaust port (refer to EX in FIG. 4) in a condition where a supply port (refer to IN in FIG. 4) of the electromagnetic valve is being supplied with an oil pressure.

According to the first embodiment of the present invention, the brake B2 is divided into two brakes such as a brake B2S with a small piston oil chamber and a brake B2L with a large piston oil chamber. The other structure of the oil pressure control apparatus according to the first embodiment is similar to that of the oil pressure control apparatus illustrated in FIG. 3. The linear solenoid valve SL1 exclusively for the clutch C1 is NL type, the linear solenoid valve SL2 exclusively for the clutch C2 and the brake B2L is NH type, the linear solenoid valve SL3 exclusively for the clutch C3 is NH type, and the linear solenoid valve SL4 exclusively for the brake B1 is NL type.

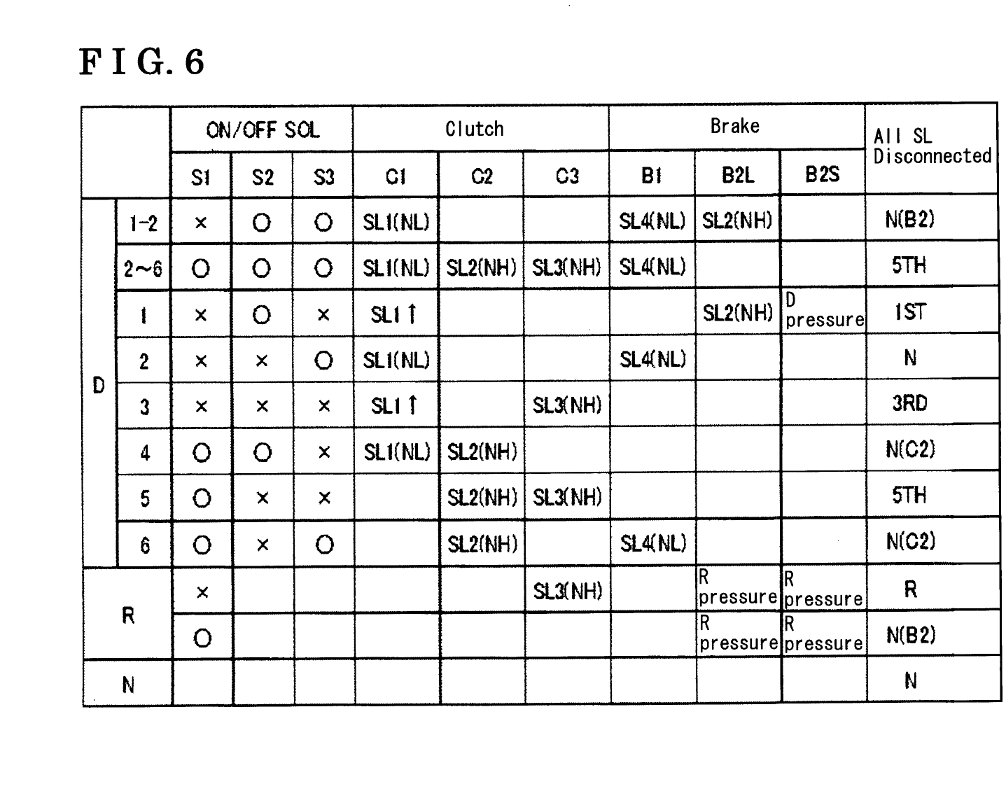

As illustrated in FIG. 6, the multiple shift pattern (i.e., the first automatic shift pattern), in which the skip shift operation can be performed, and one of the fixed shift stage patterns 4th, 5th, 6th are selected when the solenoid valve S1 is at the ON-state, and the other lower shift stages are established when the solenoid valve S1 is at the OFF-state. Further, the shift valve SV1 is configured to be latched to an ON-side with a pressure to be supplied to the clutch C2. Therefore, sudden speed reduction of the vehicle from a higher shift stage to the lower shift stage, which may occur in the event of a malfunction of the solenoid valve S1, can be prevented.

In order to supply the line pressure to the exhaust port of the NL type linear solenoid valve SL1, forward pressure (hereinafter, referred to as D pressure) is supplied to the exhaust port of the linear solenoid valve SL1 only in a condition where the solenoid valves S1 and S3 are at the OFF-state (×), and so the first shift stage and the third shift stage of the fixed shift pattern can be selected by an operation of the ON/OFF solenoid valve S2. On this occasion, the fixed shift pattern is limited to the first shift stage and the third shift stage for minimizing the increase in the number of the oil passages. However, if there is a space, the vehicle can be driven at all fixed shift stages at the time of all disconnection, which is described according to the other embodiments of the present invention described below.

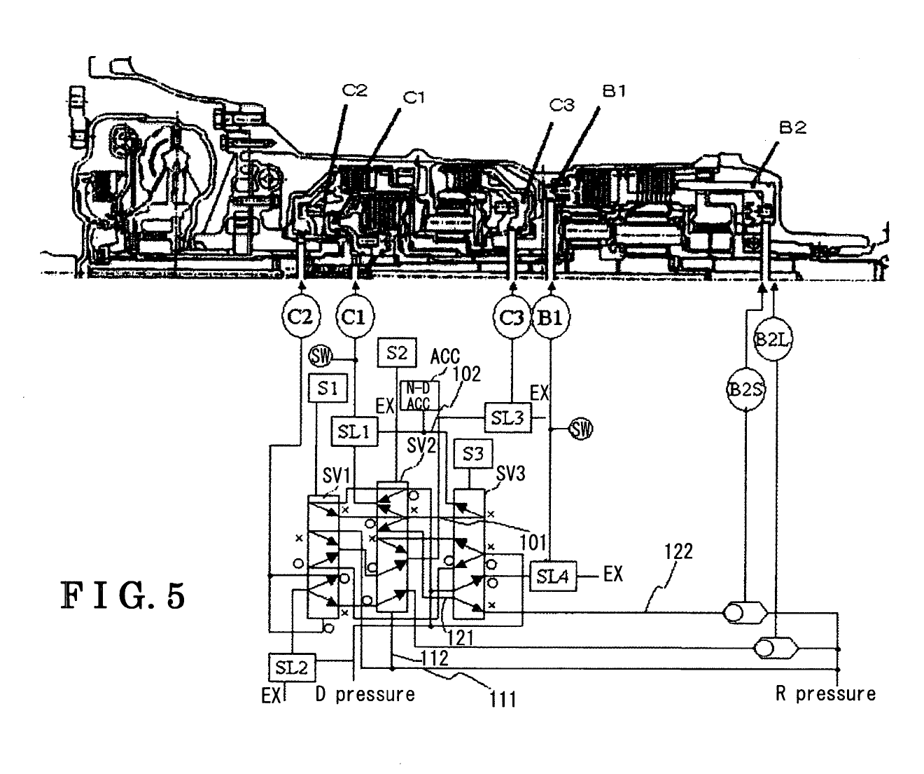

As is obvious from FIG. 5, according to the first embodiment of the present invention, an oil passage 101 for transmitting the D pressure from the shift valve SV2 to a switch port of the shift valve SV3 and an oil passage 102 for transmitting the D pressure from the shift valve SV3 to the exhaust port of the linear solenoid valve SL1 are added to the oil passage structure shown in FIG. 1. An accumulator (N-D ACC) ACC1 is provided at an oil passage 102. By delaying supply of the D pressure toward the linear solenoid valve SL1 for a predetermined period of time, by means of an orifice (not illustrated), a shift operation from the N-range to the D-range can be performed without causing a shifting shock that may occur due to a direct introduction of the line pressure. Accordingly, with a shift lever switched from the N-range to the D-range, a garage shift operation is established by respectively controlling the solenoid valves S1, S2, S3 at the OFF-, ON-, OFF-states (×∘×). Further, with the shift lever switched from the N-range to the D-range, if the solenoid valves S1, S2, S3 are respectively controlled at the OFF-, ON-, ON-states (×∘∘), the clutch C1 is controlled to be engaged with an output pressure of the linear solenoid valve SL1, thereby enabling to perform an automatic shift operation

At the first fixed shift stage pattern, the line pressure is directly supplied to the clutch C1. It means that a lock valve or a gain switching valve are not additionally required in a condition where a pressure more than the maximum output pressure of the linear solenoid valve is required at the time of start from torque converter stall, or the like. Accordingly, the oil passage according to the first embodiment of the present invention can be simplified and a manufacturing cost thereof can be reduced.

The oil passage structure according to the first embodiment of the present invention is further provided with an oil passage 111 for transmitting reverse pressure (hereinafter, referred to as R pressure) to a switching circuit of the shift valve SV1 and an oil passage 112 for transmitting the R pressure to the shift valve SV2 to forcibly turn on the shift valve SV2, instead of adding another shuttle valve. Therefore, even in a condition where the shift valve SV1 is at the OFF-state (×), as far as the R pressure is being supplied to the shift valve SV1, the clutch C3 used for a reverse shift stage can be engaged by means of the linear solenoid valve SL3 by turning on the shift valve SV2.

The oil passage structure according to the first embodiment of the present invention is still further provided with an oil passage 121 for transmitting the D pressure, which was sent from the switching circuit of the shift valve SV1 to the shift valve SV2, to the switching circuit of the shift valve SV3 and an oil passage 122 communicating with a shuttle valve connected to the brake B2S. In a condition where the shift valve SV1 is at the OFF-state (×), the shift valve SV2 is at the ON-state (∘), and the shift valve SV3 is at the OFF-state (×), the D pressure is supplied to the brake B2S, and the brake B2L having larger dimensions communicate with the linear solenoid valve SL2. With the above structure, in proportion to an increase in a required torque capacity because of the increased number of shift stages in the transmission and in order to reduce a manufacturing cost and a space, use of a 1-2 one-way clutch (i.e., O.W.C) can be abolished. More particularly, even in the event that the OFF-failure occurs to the NL-type linear solenoid valve SL2, the vehicle can be started on the first shift stage with the brake B2S engaged, and a coast control can be carried out.

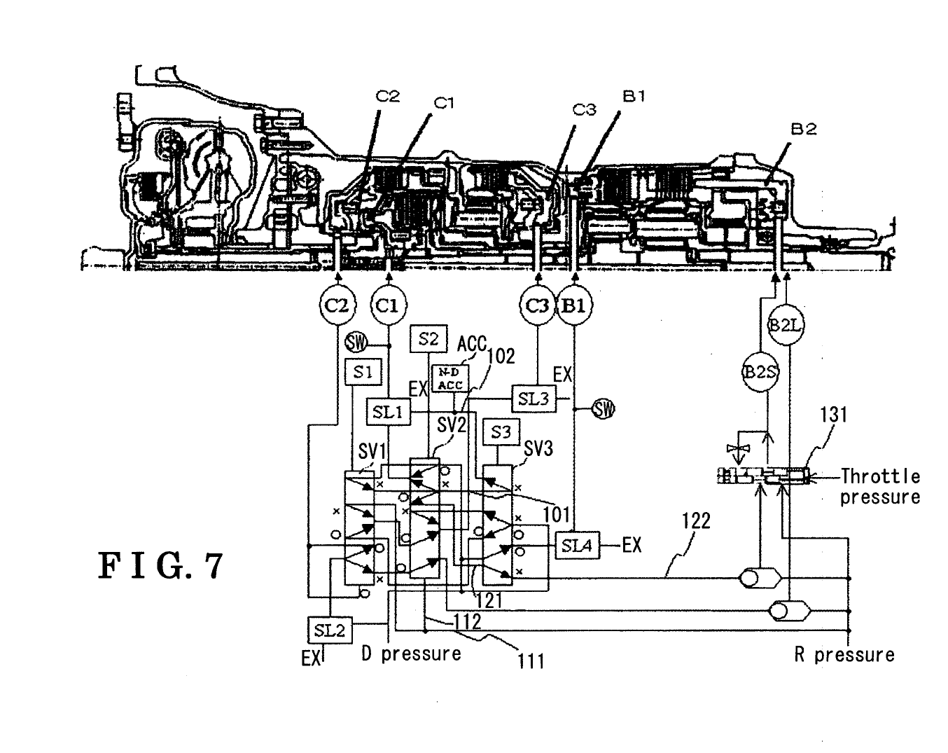

According to an example shown in FIG. 5, the D pressure is directly transmitted to the brake B2S on the assumption that piston dimension of the brake B2 has been divided appropriately. However, occasionally, the brake B2 can not be divided appropriately, for example because of the configuration of the cross section of the brake B2, or when a coast control is desired to be sensitively controlled according to the type of the vehicle or an engine. In such circumstances, a brake control valve (i.e., a pressure reducing valve) 131 may be provided between the brake B2S and the shuttle valve as illustrated in FIG. 7. With such configuration, when the shift pattern of the reverse shift stage is selected, a spool of the brake control valve 131 is moved to a left side in FIG. 7 in response to an introduction of the R pressure to a spring chamber of the brake control valve 13 1, and the R pressure is transmitted from a supply port to a exhaust port of the brake control valve 131 through the shuttle valve and the R pressure is accordingly transmitted to the brake B2S. Further, when the first shift stage of the fixed shift pattern is selected, the D pressure transmitted through the shift valves SV1, SV2, and SV3, is transmitted to the supply port of the brake control valve 131 through the shuttle valve. In this case, if a throttle pressure is controlled to encourage a spring force of the brake control valve 131, the brake B2S can be controlled by reducing the D pressure in proportion to the throttle pressure.

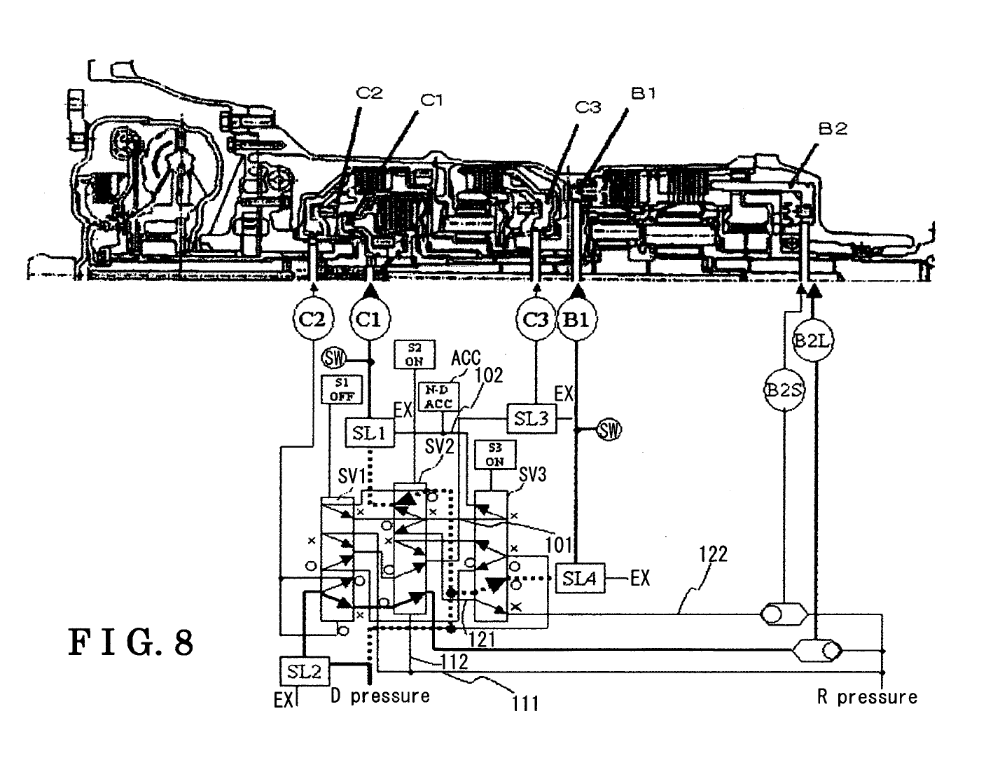

An operation of the oil pressure control apparatus according to the first embodiment of the present invention at each shift pattern will individually be explained hereinafter.

[D-range 1st-2nd Automatic Shift Mode]
Under the first to second (second to first) automatic shift mode (1-2 automatic shift mode) at the D-range, in which a shift operation is performed from the first shift stage to the second shift stage and from the second shift stage to the first shift stage, the D pressure from a manual valve (not shown) is normally transmitted to a supply port of the linear solenoid valve SL2 as illustrated in FIG. 8. On this occasion, because the solenoid valve S3 is at the ON-state (∘),
the D pressure is transmitted to a supply port of the linear solenoid valve SL4 through a second bottom switching circuit of the shift valve SV3. Further, because the solenoid valve S2 is at the ON-state (∘), the D pressure is transmitted to a supply port of the linear solenoid valve SL1 through a first top switching circuit of the shift valve SV2.

An oil passage for transmitting the D pressure to the shift valve SV1 through a third bottom switching circuit of the shift valve SV3 is interrupted because the shift valve SV1 is at the OFF-state (×), and the D pressure is thereby not transmitted to a supply port of the linear solenoid valve SL3. Further, the D pressure transmitted through a first top switching circuit of the shift valve SV1 is interrupted by the shift valves SV2 and SV3 and is not supplied to the brake B2S and the exhaust port of the linear solenoid valve SL1. An output oil passage of the linear solenoid valve SL2 reaches the brake B2L through a first bottom switching circuit of the shift valve SV1, a first bottom switching circuit of the shift valve SV2, and a shuttle valve (i.e., check ball valve).

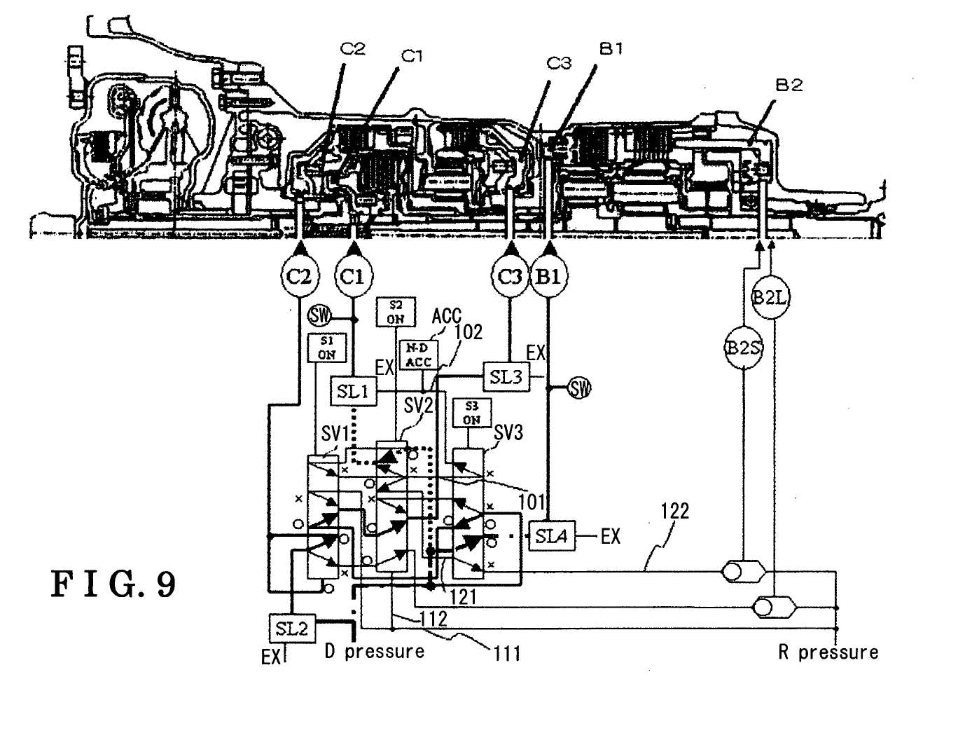

Accordingly, the clutch C1 (SL1), the brake B1 (SL4), and the brake B2L (SL2) can be controlled. Therefore, the automatic lower-shift pattern can be achieved, in which the first shift stage with the clutch C1 (SL1) and the brake B2L (SL2) engaged and the second shift stage with the clutch C1 (SL1) and the brake B1 (SL4) engaged are shifted mutually.

[D-range 2nd-6th Automatic Shift Mode]
Under the second though sixth automatic shift mode (2-n automatic shift mode) at the D-range, the solenoid valve S1 is at the ON-state (∘) as illustrated in FIG. 9. Therefore, an output oil pressure of the linear solenoid valve SL2 is transmitted through the second bottom switching circuit of the shift valve SV1 and latches the shift valve SV1 to an ON-side (∘) and is supplied to the clutch C2. Further, because the solenoid valve S3 is at the ON-state (∘), the D pressure is transmitted through the second bottom switching circuit of the shift valve 3 and is supplied to the supply port of the linear solenoid valve SL4. Moreover, because the solenoid valve S2 is at the ON-state (∘), the D pressure is transmitted through a third bottom switching circuit of the shift valve SV3, a third bottom switching circuit of the shift valve SV1, and a second bottom switching circuit of the SV2 and is supplied to the supply port of a linear solenoid valve SL3.

Although there is an oil passage for transmitting the D pressure to the first top switching circuit of the shift valve SV1, the oil passage is interrupted because the shift valve SV1 is at the ON-state (∘). Therefore, the D pressure does not reach the brake B2S and the exhaust port of the linear solenoid valve SL1.

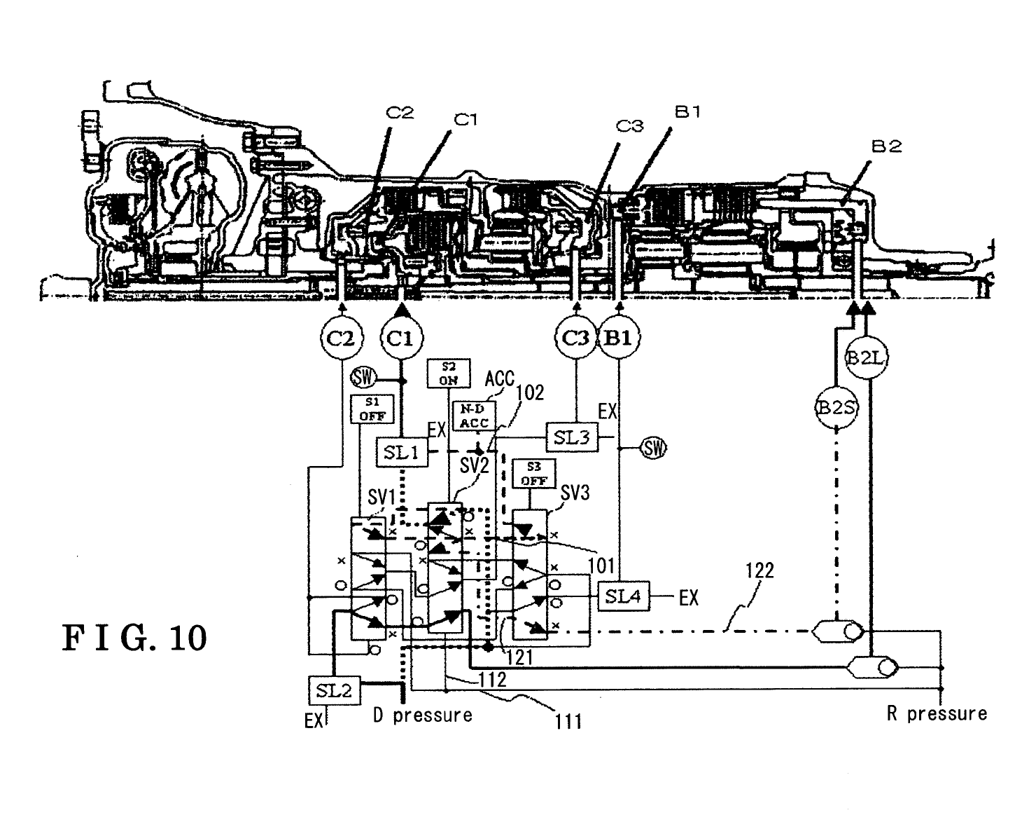

Accordingly, the clutch C1 (linear solenoid valve SL1), the clutch C2 (linear solenoid valve SL2), the clutch C3 (linear solenoid valve SL3), and the brake B1 (linear solenoid valve SL4) can be controlled, and the automatic shift pattern at the middle shift stages can be established in which a skip shift operation can be implemented. The linear solenoid valves SL2 and SL3 are NH-type so that the fifth shift stage can be established automatically during electric disconnection of all the linear solenoid valves.
2nd clutch C1 (linear solenoid valve SL1), brake B1 (linear solenoid valve SL4)
3rd clutch C1 (linear solenoid valve SL1), clutch C3 (linear solenoid valve SL3)
4th clutch C1 (linear solenoid valve SL1), clutch C2 (linear solenoid valve SL2)
5th clutch C2 (linear solenoid valve SL2), clutch C3 (linear solenoid valve SL3)
6th clutch C2 (linear solenoid valve SL2), brake B1 (linear solenoid valve SL4)

[D-range 1st Fixed Shift Mode]
Under the first fixed shift mode at the D-range, the solenoid valve S1 is at the OFF-state (×), the solenoid valve S2 is at the ON-state (∘), and the solenoid valve S3 is at the OFF-state (×) as illustrated in FIG. 10. Therefore, the output oil pressure of the linear solenoid valve SL2 is transmitted through the first bottom switching circuit of the shift valve SV1, the first bottom switching circuit of the shift valve SV2, and the shuttle valve and is supplied to the brake B2L. Further, the D pressure is transmitted through the first top switching circuit of the shift valve SV2 and is supplied to the supply port of the linear solenoid valve SL1. On this occasion, the D pressure is also transmitted through the first top switching circuit of the shift valve SV1 and a first top switching circuit of the shift valve SV3 and is supplied to the exhaust port of the linear solenoid valve SL1 and the accumulator (N-D ACC) ACC 1. In consequence, the D pressure is supplied to the clutch C1. The D pressure transmitted through the first top switching circuit of the shift valve SV1 is further-transmitted through a third top switching circuit of the shift valve SV2, a first bottom switching circuit of the shift valve SV3, and the shuttle valve and reaches the brake B2S.

Because the solenoid valve S3 is at the OFF-state (×), the D pressure is interrupted at the second bottom switching circuit of the shift valve SV3 and does not reach the supply port of the linear solenoid valve SL4. Further, the D pressure transmitted through a second top switching circuit of the shift valve SV3 is interrupted at the third bottom switching circuit of the SV2 and does not reach the supply port of the linear solenoid valve SL3.

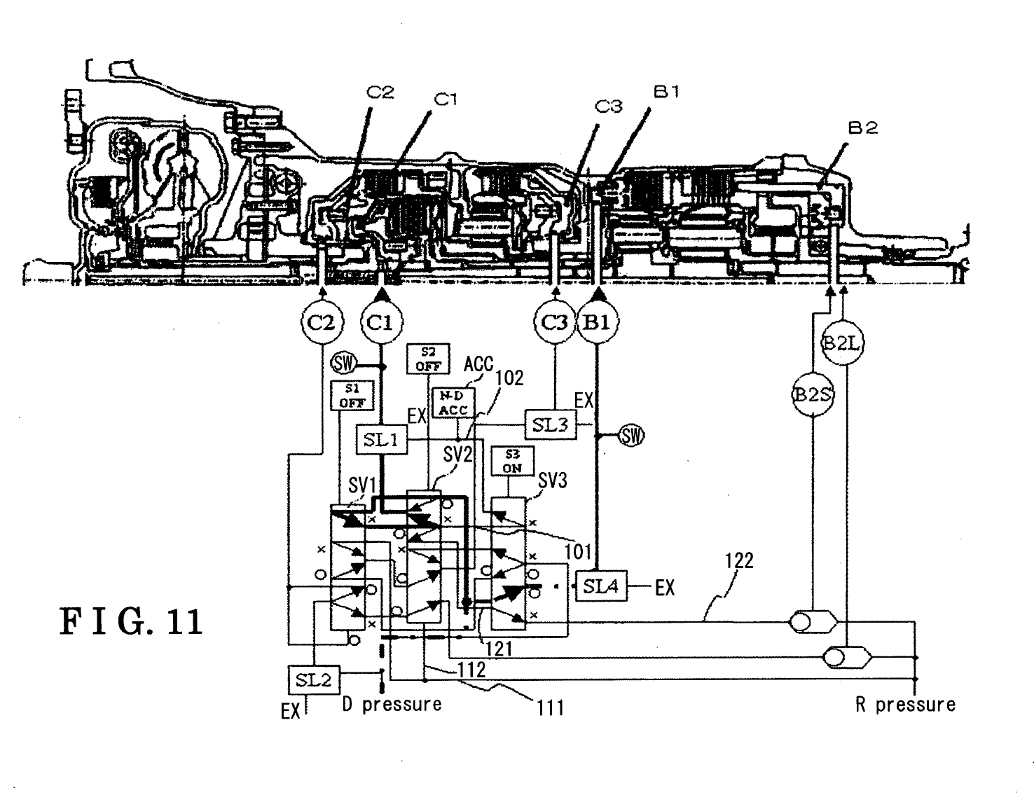

Accordingly, the clutch C1 (D pressure), the brake B2S (D pressure), and the brake B2L (SL2) are engaged and the first shift stage is thereby established. On this occasion, even in the event that the OFF-failure occurs to the linear solenoid valve SL2 which activates the brake B2L, the coast control is implemented by means of the brake B2S. Further, it may be difficult to start from the torque converter stall, however the vehicle can be driven at the first shift stage.

[D-range 2nd Fixed Shift Mode]
Under the second fixed shift mode at the D-range, the solenoid valves S1 and S2 are at the OFF-state (×) as illustrated in FIG. 11. Therefore, although the output oil pressure of the linear 20 solenoid valve SL2 is transmitted through the first bottom switching circuit of the shift valve SV1, the output oil pressure is interrupted at the first bottom switching circuit of the shift valve SV2 and reaches neither the brake B2L nor the clutch C2. On this occasion, because the solenoid valve S3 is at the ON-state (∘), the D pressure is transmitted through the second bottom switching circuit of the shift valve SV3 and is supplied to the supply port of the linear solenoid valve SL4. Further, the D pressure is transmitted through the first top switching circuit of the shift valve SV1 and the second top switching circuit of the shift valve SV2 and is supplied to the supply port of the linear solenoid valve SL1.

Because the D pressure transmitted through the third bottom switching circuit of the shift valve SV3 is interrupted at the third bottom switching circuit of the shift valve SV1, the D pressures is not supplied to the supply port of the linear solenoid valve SL3. Further, although the D pressure transmitted through the first top switching circuit of the shift valve SV1 also reaches the first top switching circuit of the shift valve SV3, the D pressure is interrupted at the first top switching circuit of the shift valve SV3 and is not supplied to the brake B2S and the exhaust port of the linear solenoid valve SL1. Accordingly, the clutch C1(SL1) and the brake B1 (SL4) are engaged and the second shift stage is thereby established.

[D-range 3rd Fixed Shift Mode]
Under the third fixed shift mode at the D-range, the all solenoid valves are disconnected, i.e., the solenoid valves S1, S2, and S3 are at the OFF-state (×). Therefore, although the output oil pressure of the linear solenoid valve SL2 is transmitted through the first bottom switching circuit of the shift valve SV1, the output oil pressure of the linear solenoid valve SL2 is interrupted at the first bottom switching circuit of the shift valve SV2 and reaches neither the brake B2L nor the clutch C2. On this occasion, the D pressure is transmitted through the second top switching circuit of the shift valve SV3 and the third bottom switching circuit of the shift valve SV2 and is supplied to the supply port of the linear solenoid valve SL3. Further, the D pressure transmitted through the first top switching circuit of the shift valve SV1 is interrupted at the third top switching circuit of the shift valve SV2 and does not reach the brake B2S. However, the D pressure transmitted through the second top switching circuit of the shift valve SV2 reaches the supply port of the linear solenoid valve SL1 and the D pressure transmitted through the first top switching circuit of the shift valve SV3 reaches the exhaust port of the linear solenoid valve SL1 and the accumulator (N-D ACC) ACC1. In consequence, the D pressure is supplied to the clutch C1.

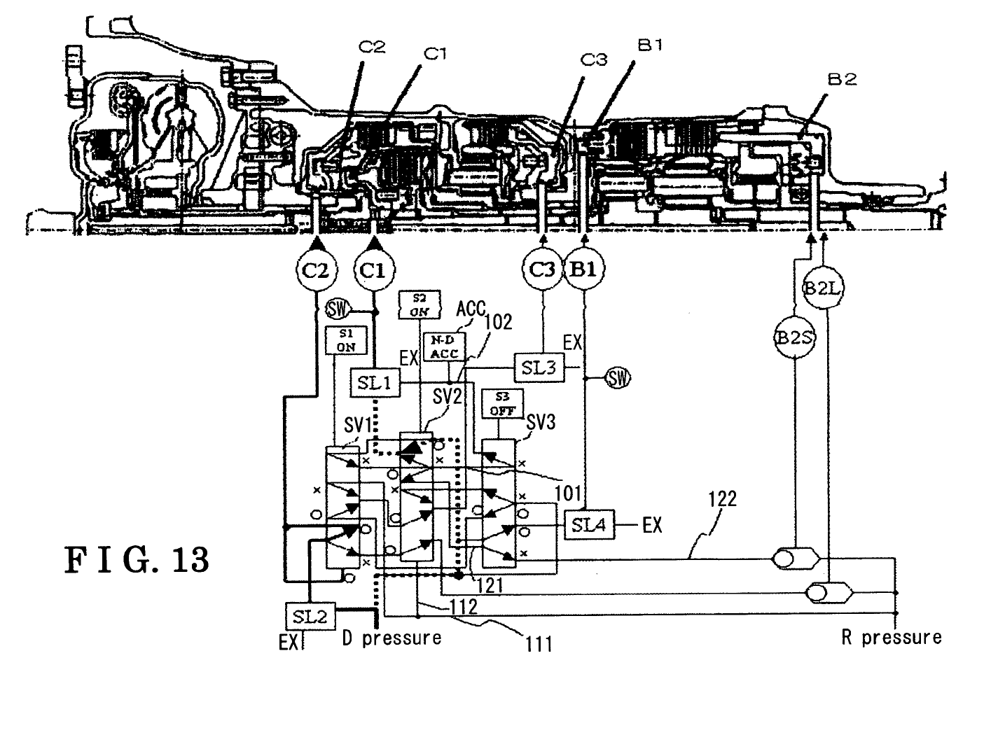

In the aforementioned condition, the D pressure to the supply port of the linear solenoid valve SL4 is interrupted at the second bottom switching circuit of the shift valve SV3. Accordingly, the clutch C1 (D pressure) and the clutch C3 (SL3) are engaged and the third shift stage is thereby established. As a result, the vehicle can be driven not only in a condition where all the linear solenoid valves are disconnected but also in a condition where all the solenoid valves including the ON/OFF solenoid valves are disconnected.

[D-range 4th Fixed Shift Mode]
Under the fourth fixed shift mode at the D-range, the ON/OFF solenoid valves S1 and S2 are at the ON-state (∘) as illustrated in FIG. 13. Therefore, the output oil pressure of the linear solenoid valve SL2 transmitted through the second bottom switching circuit of the shift valve SV1 latches the shift valve SV1 to the ON-side and is transmitted to the clutch C2. Further, the output oil pressure of the linear solenoid valve SL2 is transmitted through the first top switching circuit of the shift valve SV2 and is supplied to the supply port of the linear solenoid valve SL1. In contrast, the D pressure divided before the first top switching circuit of the shift valve SV2 is not supplied to the exhaust port of the linear solenoid valve SL1 and the brake B2S because the D pressure is interrupted at the first top switching circuit of the shift valve SV1.

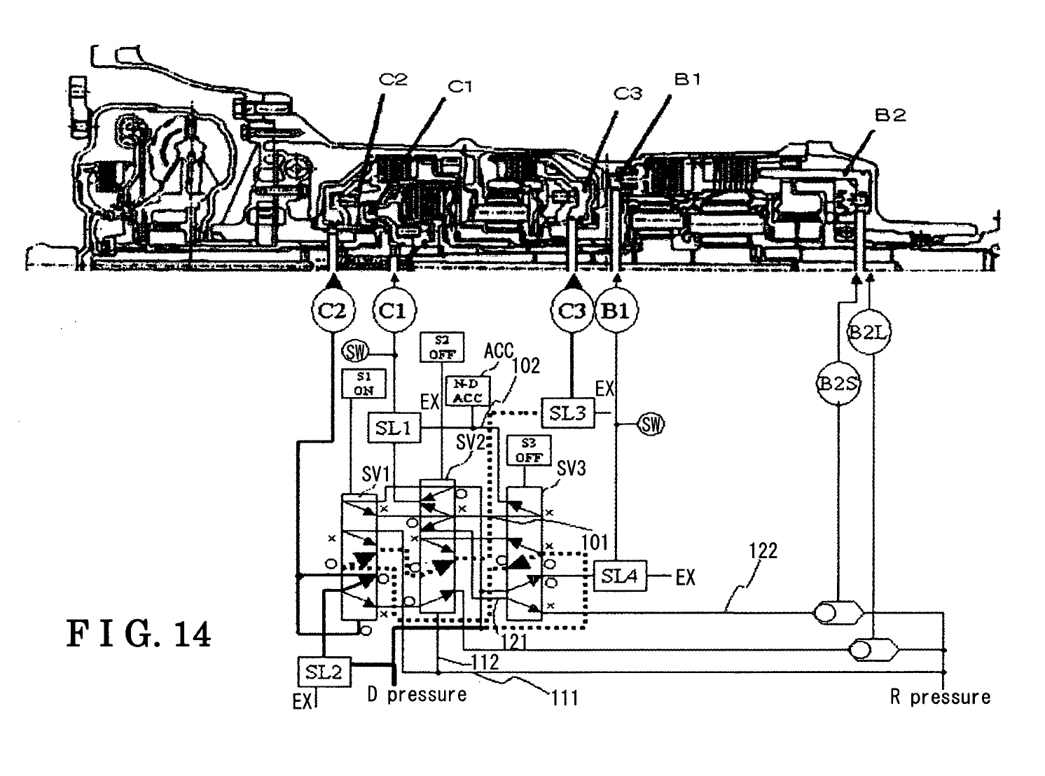

Because the ON/OFF solenoid valve S3 is at the OFF-state (×), the D pressure is interrupted at the second bottom switching circuit of the shift valve SV3 and is not reached to the supply port of the linear solenoid valve SL4. Further, the D pressure transmitted through the second top switching circuit of the shift valve SV3 is interrupted at the third bottom switching circuit of the shift valve SV2 and is not reached to the supply port of the linear solenoid valve SL3. Accordingly, the clutch C1 (SL1) and the clutch C2 (SL2) are engaged and the fourth shift stage is thereby established.

[D-range 5th Fixed Shift Mode]
Under the fifth fixed shift mode at the D-range, the ON/OFF solenoid valve S1 is at the ON-state (∘) as illustrated in FIG. 14. Therefore, the output oil pressure of the linear solenoid valve SL2 transmitted through the second bottom switching circuit of the shift valve SV1 latches the shift valve SV1 to the ON-side and is supplied to the clutch C2. In contrast, because the ON/OFF solenoid valves S2 and S3 are at the OFF-state (×), the D pressure transmitted through the second top switching circuit of the shift valve SV3 and the third bottom switching circuit of the shift valve SV2 is supplied to the supply port of the linear solenoid valve SL3.

The D pressure does not reach the supply port of the linear solenoid valve SL4, the supply port of the linear solenoid valve SL1, the exhaust port of the linear solenoid valve SL1, and the brake B2S because the D pressure is interrupted at the second bottom switching circuit of the shift valve SV3, the first top switching circuit of the shift valve SV2, and the first top switching circuit of the shift valve SV1. Accordingly, the clutch C2 (SL2) and the clutch C3 (SL3) are engaged and the fifth shift stage is thereby established. On this occasion, the vehicle can be driven in a condition where all the linear solenoid valves are disconnected.

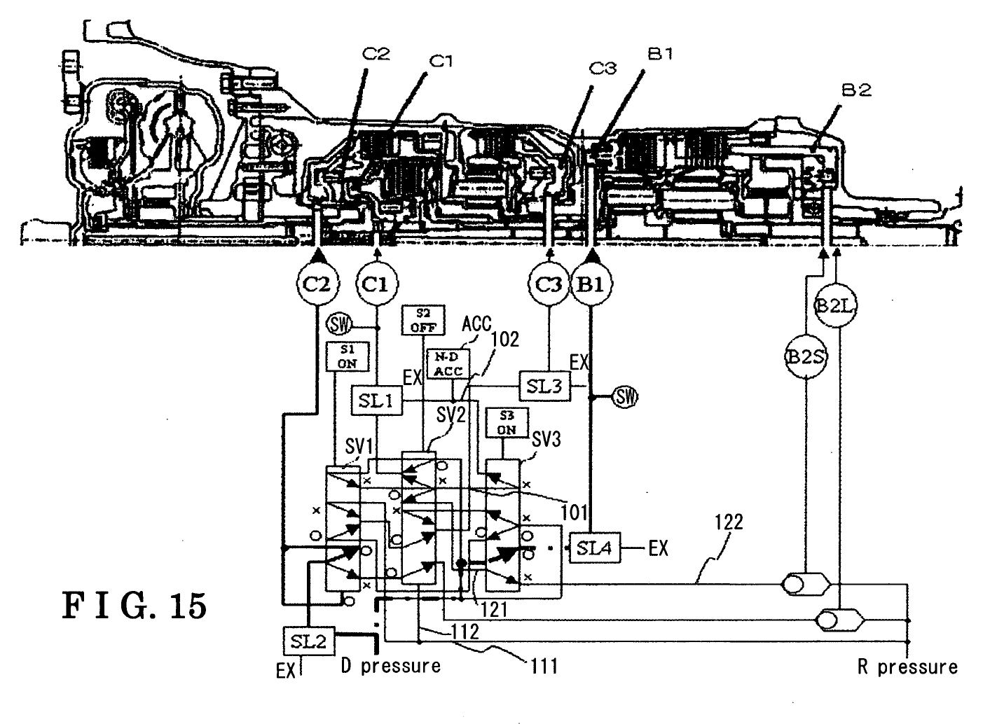

When all solenoid valves are disconnected in a condition where the fourth shift stage or a higher shift stage than the fourth shift stage is established in which the clutch C2 is engaged, because pressure of the clutch C2 (SL2) latches the shift valve SV1 to the ON-side (∘), the shift valve SV1 is remained at ON-state (∘) without switching even in a condition where the ON/OFF solenoid valve S1 comes to the OFF-state (×) from the ON-state (∘). Therefore, the vehicle can be driven at the fifth shift stage. According to the embodiment of the present invention, when the disconnection of all the linear solenoid valves is generated in a condition where the vehicle is driven at the fourth shift stage or at the higher shift stage than the fourth shift stage at the second through sixth shift mode (the 2-n automatic shift mode), the vehicle is driven not at the third fixed shift mode but at the fifth fixed shift mode. Therefore, sudden speed reduction of the vehicle can be prevented. Further, after the vehicle is stopped, when the pressure of the clutch C2 is reduced by shifting from D-range to N-range, P-range, and R-range, and by turning off the ignition switch, the latch of the shift valve SV1 is released. Therefore, the vehicle can be restarted at the third shift stage. Further, when the ON/OFF solenoid valve S2 can be at the ON-state (∘), the vehicle can be started at the first shift stage.

[D-range 6th^{th} Fixed Shift Mode]
Under the sixth fixed shift mode at the D-range, the ON/OFF solenoid valves S1 and S3 are at the ON-state (∘) as illustrated in FIG. 15. Therefore, the output oil pressure of the linear solenoid valve SL2 transmitted through the second bottom switching circuit of the shift valve SV1 latches the shift valve SV1 to the ON-side and is supplied to the clutch C2. Further, the D pressure is transmitted through the second bottom switching circuit of the shift valve SV3 and is supplied to the supply port of the linear solenoid valve SL4.

Because the ON/OFF solenoid valve S2 is at the OFF-state (×), the D pressure transmitted through the third bottom switching circuit of the shift valve SV3 and the third bottom switching circuit of the shift valve SV2 is interrupted at the second bottom switching circuit of the shift valve SV2 and is not reached to the supply port of the linear solenoid valve SL3. Further, the D pressure is interrupted at the first top switching circuit of the shift valve SV2 and at the first top switching circuit of the shift valve SV1 and is not reached to the supply port of the linear solenoid valve SL1, the exhaust port of the linear solenoid valve SL1, and the brake B2S. Accordingly, the clutch C2 (SL2) and the brake B1 (SL4) are engaged and the sixth shift stage is thereby established.

[R-range]
Under the R-range, when the ON/OFF solenoid valve S1 is at the OFF-state (×) and the solenoid valve S2 is at the ON-state (∘), reverse driving of the vehicle can be performed. On this occasion, because the ON/OFF solenoid valve S3 is not involved in the switching of the D pressure, the ON/OFF-state of the solenoid valve S3 is not stable. However, in consideration of consistency of the shift pattern among R-range, N-range, and the D-range, the state of the solenoid valve S3 is desired to suit to the shift pattern at the first to second shift mode at the D-range (1-2 automatic shift mode). For example, if the first to second shift mode at the D-range is achieved if the ON/OFF solenoid valves S1, S2, S3 are controlled at the OFF-, ON-, ON-states (×∘∘), the reverse driving of the vehicle may be performed in a condition where the ON/OFF solenoid valves S1, S2, S3 are controlled at the OFF-, ON-, ON-states (×∘∘). Further, if the first to second shift mode at the D-range is achieved if the ON/OFF solenoid valves S1, S2, S3 are controlled at the OFF-, ON-, OFF-states (×∘×), the reverse driving of the vehicle may be performed in a condition where the ON/OFF solenoid valves S1, S2, S3 are controlled at the OFF-, ON-, OFF-states (×∘×).

When the R-range is selected, the R pressure from the manual valve (not shown) is transmitted through the shuttle valve (i.e., the check ball valve) and is supplied to the brakes B2S and B2L. Further, because the ON/OFF solenoid valve S1 is at the OFF-state (×), and the ON/OFF solenoid valve S2 is at the ON-state (∘), the R pressure transmitted through the second top switching circuit of the shift valve SV1 and the second bottom switching circuit of the shift valve SV2 is supplied to the supply port of the linear solenoid valve SL3.

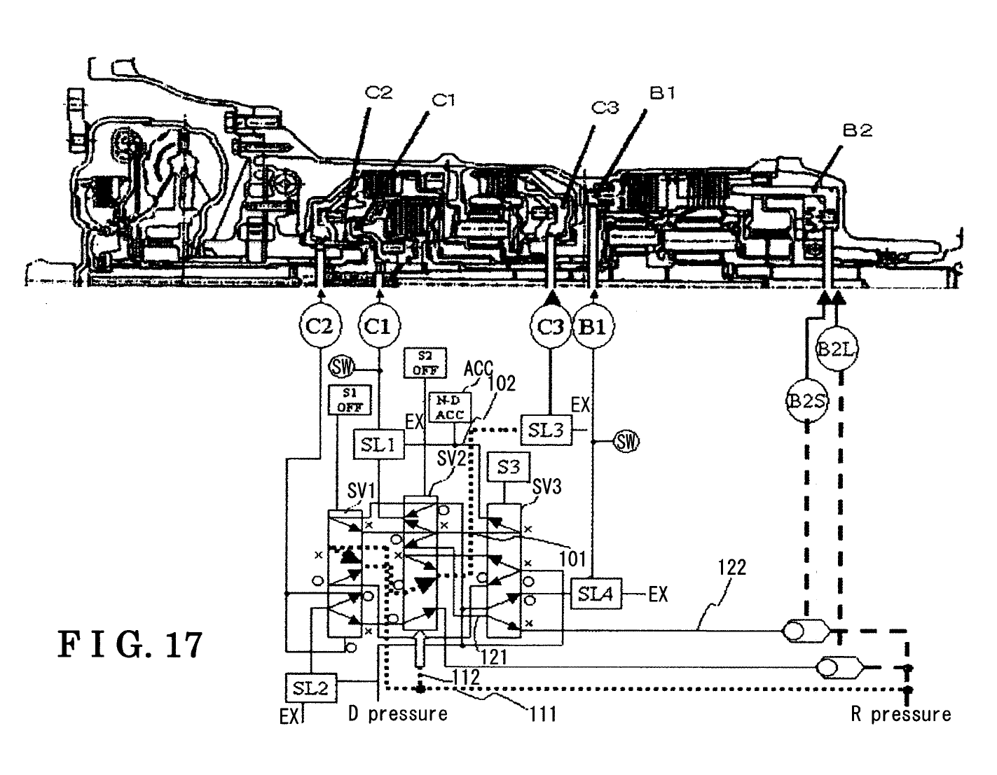

According to the first embodiment of the present invention, the R pressure is transmitted to an end of the shift valve SV2 for forcibly move the shift valve SV2 to the ON-side (∘) as illustrated in FIG. 17. Therefore, the reverse driving of the vehicle may be performed even in a condition where all the linear solenoid valves are disconnected.

According to the first embodiment of the present invention, reliability of a hold back control at the R-range is improved. Generally, in the hold back control, a reverse inhibitor is performed by turning on the linear solenoid valve SL3 and releasing the clutch C3 in order to prevent the vehicle from shifting to a reverse driving mode in a condition where the vehicle drives equal to or faster than a predetermined speed. According to the first embodiment of the present invention, even in the event that the ON-failure occurs to the linear solenoid valve SL3, transmission of the R pressure to the supply port of the linear solenoid valve SL3 can reliably be interrupted at the second top switching circuit of the shift valve SV1 as long as the ON/OFF solenoid valve S1 is at the ON-state (∘). Accordingly, the reverse inhibitor can reliably be performed when the shift mode is changed to the R-range from the first shift stage, in which the ON/OFF solenoid valves S1, S2, S3 are controlled at the OFF-, ON-, OFF-states (×∘×), from the 1-2 automatic shift mode in which the solenoid valves S1, S2, S3 are controlled at the OFF-, ON-, ON-states (×∘∘), or from the 2-6 automatic shift mode, in which the solenoid valves S1, S2, S3 are controlled at the ON -, ON-, ON-states (∘∘∘).

According to the embodiment of the present invention, an oil pressure switch SW is respectively provided at an oil passage to the clutch C1 and an oil passage to the brake B1. In the event that the ON-failure occurs to the linear solenoid valve SL2 because of the disconnection state, or the like, at the first to second shift mode at the D-range the, if the first shift stage is established in which the clutch C1 (SL1) and the brake B2 (SL2) are engaged, the shift stage may be remained at the first shift stage. In contrast, if the second shift stage is established in the aforementioned condition, the interlock may be generated due to an engagement of the clutch C1 (SL1), the brake B1 (SL4), and the brake B2 (SL2). On this occasion, the oil pressure switch SW detects the condition of the oil passage and the shift stage can be returned to the first shift stage.

Likewise, in the event that the ON-failure occurs to the linear solenoid valve SL4 because of the disconnection state, or the like, at the first to second shift mode at the D-range, the similar phenomenon as described above may be generated. However, the oil pressure switch SW detects the condition of the oil passage and the shift stage can be remained at or returned to the second shift stage.

According to the first embodiment of the present invention, measures to a secondary failure of the ON/OFF solenoid valve is prepared, the secondary failure of the ON/OFF solenoid valve being generated after the shift pattern is shifted to the fixed shift mode at the D-range due to a primary failure of the ON/OFF solenoid valve. Even in the event that the ON-failure occurs to one or two of the ON/OFF solenoid valves S1, S2, and S3, or one or two of the ON/OFF solenoid valves S1, S2, and S3 is disconnected, the shift stage can be remained or the sudden speed reduction of the vehicle can be prevented by operating the third ON/OFF solenoid valve. Further, if the third failure of the ON/OFF solenoid valve is generated, the sudden speed reduction of the vehicle can be prevented by remaining the shift stage at the current shift stage or shifting to the N range. Accordingly, if the shift pattern can be shifted to the fixed shift mode, the first or the secondary failure, or the more, can be accessed. In consequence, the oil passage structure according to the first embodiment of the present invention is predominant from the oil passage structure using a fail-safe valve of the other company in a point that a failure mode is determined due to a malfunction of a failure valve.

### Second Embodiment

A second embodiment of the present invention will be described hereinafter. The same structure as described in the aforementioned embodiment is not repeatedly explained. By adding oil passages to the first embodiment of the present invention, the second embodiment of the present invention realizes the following functions:
1) early stage detection of the ON-failure of the linear solenoid valve
2) improvement in reliability at the R-range
3) measures to the OFF-failure of the linear solenoid valve.
In the second embodiment of the present invention, an example including all three functions is explained. However, the present invention is not limited thereto. Alternatively, or in addition, each function may be individually adopted as an option to the first embodiment of the present invention.

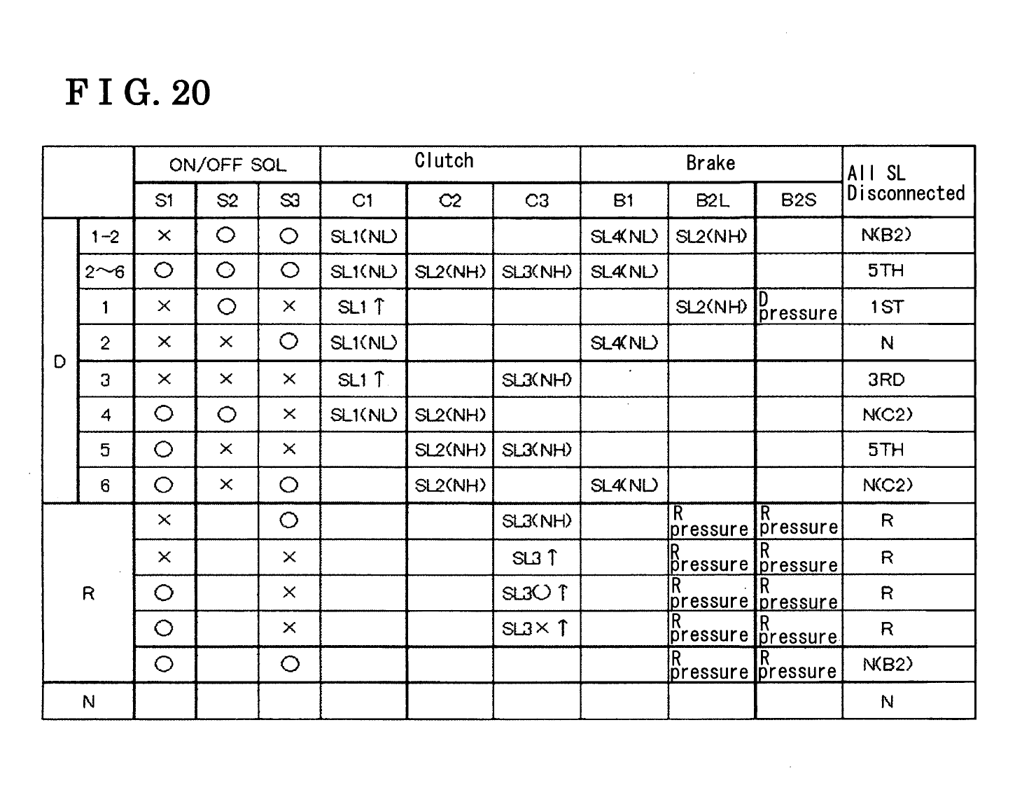

With reference to FIG. 6 and FIG. 20, the type (NL/NH) of the linear solenoid valve used for a control of each frictional engagement element according to the second embodiment of the present invention is similar to that of the first embodiment of the present invention. According to the second embodiment of the present invention, shift patterns applicable for the R-range, in which the reverse driving of the vehicle can be performed in a condition where the ON/OFF solenoid valve S1 is at the ON-state (∘), is added as illustrated in FIG. 20.

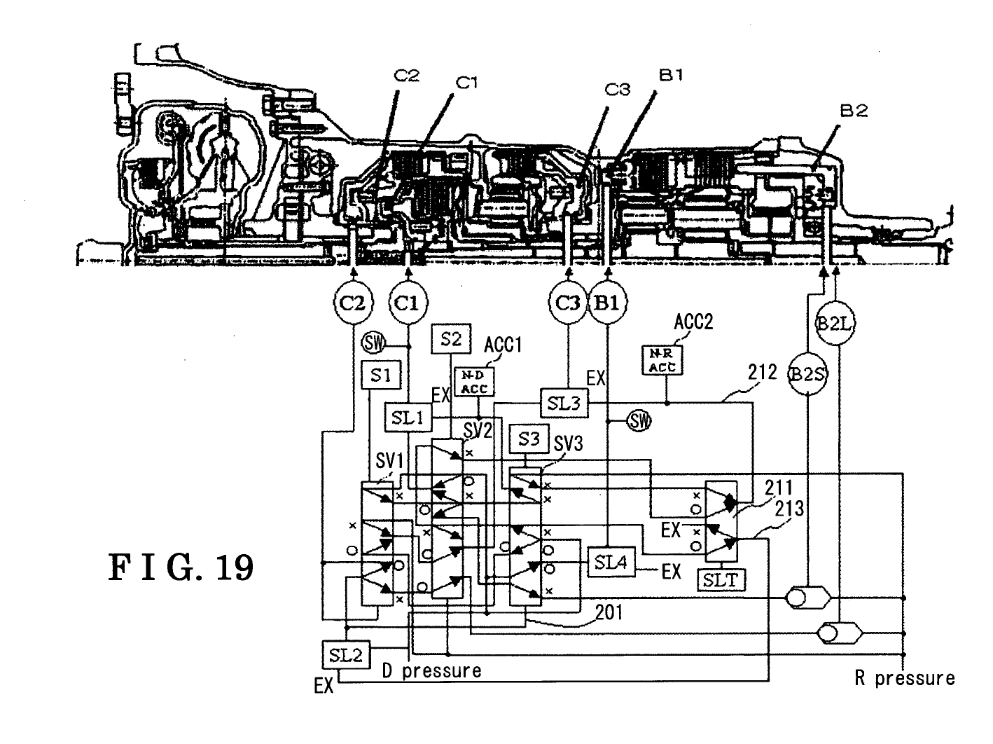

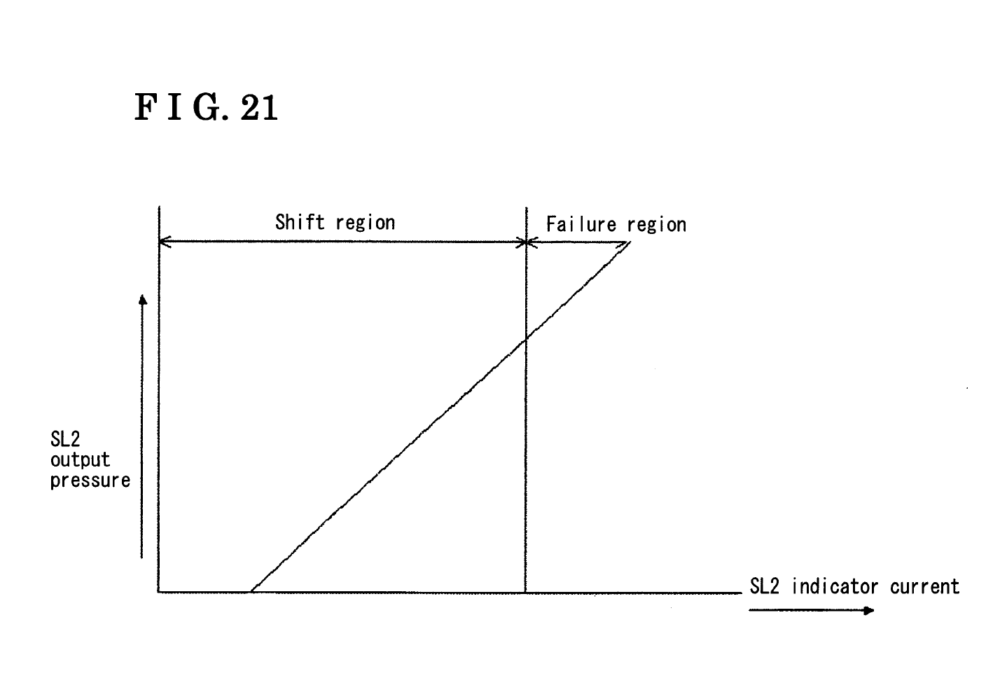

With reference to FIG. 19, according to the second embodiment of the present invention, an oil passage 201, a switching valve 211, an oil passage 212, an accumulator (N-R ACC) AC2, and an oil passage 213 are added to the oil structure shown in FIG. 5. The oil passage 201 transmits the output oil pressure of the linear solenoid valve SL2 to an end of the shift valve SV3 and forcibly moves the shift valve SV3 to the OFF-side (×) in a condition where the output oil pressure becomes equal to or more than a predetermined vale. The switching valve 211 is operated by a linear solenoid valve SLT. The oil passage 212 communicates a first switching circuit of the switching valve 211 and the exhaust port of the linear solenoid valve SL3. The accumulator (N-R ACC) AC2 is provided at the oil passage 212. The oil passage 213 communicates a second switching circuit of the switching valve 211 with the exhaust port of the linear solenoid valve SL2.

[Early Stage Detection of The ON-failure of the Linear Solenoid Valve]
As illustrated in FIG. 21, the output oil pressure of the linear solenoid valve SL2 includes a shift range, in which the output oil pressure is used in a normal use range, and a failure range, in which the output oil pressure exceeds the shift range. The failure range is detected in a condition where the failure of the linear solenoid valve SL2 is generated. The shift valve SV3 is designed in such a manner that the output oil pressure of the linear solenoid valve SL2 is transmitted to a spring chamber at an end portion of the valve through the oil passage 201. Further, when the output oil pressure of the linear solenoid valve SL2 exceeds the shift range, the shift valve SV3 is latched to the OFF-side (×).

Accordingly, in the event that the ON-failure occurs to the linear solenoid valve SL2, the state of the solenoid valve S3 is immediately shifted from the ON-state to the OFF-state, without relying on a type (NL/NH) linear solenoid valve according to the first embodiment. The shift pattern is then shifted from the 1-2 automatic shift mode at the D-range to the first fixed shift mode at the D-range or from the 2-6 automatic shift mode at the D-range to the fourth fixed shift mode at the D-range. Alternatively, or in addition, an additional switching valve for interrupting the supply pressure of the linear solenoid valves SL3 and SL4 by means of the output oil pressure of the linear solenoid valve SL2 may be arranged at an upstream of the supply port of the linear solenoid valves SL3 and SL4.

As described above, according to the first embodiment of the present invention, the interlock due to the ON-failure of the linear solenoid valves SL2 and SL4 because of disconnection-state, or the like, is required to be prevented at the first to second shift mode at the D-range. Especially at the second shift stage, which is faster than the first shift stage, the interlock is required to be detected at the early stage and the shift pattern is required to be shifted to an appropriated shift pattern. However, according to the second embodiment of the present invention, to which the oil passage 201 is added and the structure of the shift valve SV3 is changed, if the ON-failure occurs to the linear solenoid valve SL2 in a condition where the vehicle is driving at the second shift stage, the output oil pressure of the linear solenoid valve SL2 is shifted to the failure range from the shift range. Further, because the shift valve SV3 is turned off, the driving pressure to the linear solenoid valve SL4 is interrupted at the second bottom switching circuit of the shift valve SV3 and a down shift operation from the second shift stage to the first shift stage is automatically performed without depending on a detection and an operation of an Electronic Control Unit (i.e., ECU).

There is a method of verifying interlocking on the basis of change in rotation monitored by the ECU in a condition where the oil pressure switch SW is broken down. However, performing the down shift operation from the second shift stage to the first shift stage as described above is more safe than performing the interlock. Further, if the down shift operation from the second shift stage to the first shift stage is implemented, a safety level is enhanced and an enough time is assured. Therefore, it is possible to shift to a safer fixed shift mode by detecting the difference between the second shift stage and the first shift stage by the ECU.

The ON-failure of the linear solenoid valve SL4 in a condition where the vehicle is driving at the first shift stage may occur soon after the down shift operation from the second shift stage to the first shift stage is performed. For example, if the output oil pressure of the linear solenoid valve SL2 is shifted from the shift range to the failure range in a condition where the down shift operation from the second shift stage to the first shift stage requires longer time than a predetermined time, the shift operation can be promoted by interrupting the supply of the driving pressure to the linear solenoid valve SL4. On this occasion, the output oil pressure may be increased close to the failure range. Therefore, the shift stage can quickly be shifted to the first shift stage relative to a method of switching the shift valve by means of the ON/OFF solenoid valve after the interlock is detected by the ECU.

As well as the first to second shift mode, detection of the interlock generated at the second through sixth shift mode is required at the early stage and at the higher shift stage than the lower shift stage. On this occasion, it is necessary to shift to the suitable shift pattern in a short period of time. According to the second embodiment of the present invention, when the ON-failure occurs to the linear solenoid valve SL2 at the higher shift stages (i.e., fourth to sixth stages), the output oil pressure of the linear solenoid valve SL2 is shifted from the shift range to the failure range and the driving pressure to the linear solenoid valves SL3 and SL4 is interrupted by means of the shift valve SV3. In consequence, the clutch C2 (SL2-ON) and the clutch C1 (SL1) are engaged to establish the fourth shift stage and the interlock can be avoided without depending on the detection and the operation of the ECU.

For example, if the ON-failure occurs to the linear solenoid valve SL1SL2 in a condition where the vehicle is driving at the fourth shift stage at the second through sixth shift mode, the shift stage is remained at the fourth shift stage. Further, if the ON-failure occurs to the linear solenoid valve SL1 SL2 in a condition where the vehicle is driving at the fifth shift stage at the second through sixth shift mode, supply of the driving pressure to the linear solenoid valve SL3 is interrupted and the shift pattern is shifted to the N range in which only the clutch C2 is engaged. In this state, the change in rotation of the driving shaft is detected. If the vehicle condition is judged that the vehicle can be driven at the fourth shift stage, the linear solenoid valve SL1 is controlled at the ON-state and down shift operation to the fourth shift stage is performed. If the vehicle condition is judged that the shift stage is required to be remained at the fifth shift stage, the ON/OFF solenoid valve S2 is controlled from the ON-state to the OFF-state to shift the shift pattern to the fifth shift stage of the fixed shift mode. Moreover, if the ON-failure occurs to the linear solenoid valve SL2 in a condition where the vehicle is driving at the sixth shift stage at the second through sixth shift mode, supply of the driving pressure to the linear solenoid valve SL3 is interrupted and the shift pattern is shifted to the N-range in which only the clutch C2 is engaged. In this state, the change in rotation is detected. If the vehicle condition is judged that the fourth shift stage is applicable, the linear solenoid valve SL1 is controlled at the ON-state and down shift operation to the fourth shift stage is performed. If the vehicle condition is judged that the fifth shift stage is applicable, the ON/OFF solenoid valve S2 is controlled from the ON-state to the OFF-state to shift the shift pattern to the fifth shift stage of the fixed shift mode. On this occasion, because the sixth shift stage cannot be remained, the downshift operation is waited until the vehicle speed is lowered if the down shift operation to the fourth shift stage or the fifth shift stage is not applicable.

In a condition where the vehicle is driving at the second shift stage at the second through sixth automatic shift mode, the clutch C1 (SL1) and the brake B1 (SL4) are engaged. Therefore, generation of the interlock is limited to the ON-failure of the linear solenoid valve SL3 or SL2. Further, in a condition where the vehicle is driving at the third shift stage at the second through sixth automatic shift mode, the clutch C1 (SL1) and the clutch C3 (SL3) are engaged. Therefore, generation of the interlock is limited to the ON-failure of the linear solenoid valve SL4 or the linear solenoid valve SL2. Even when interlocking is created during the second or third shift stage, the clutch C2 (SL2-ON) and the clutch C1 (SL1-ON) are automatically engaged due to the ON-failure of the linear solenoid valve SL2 so that the fourth shift stage is established and sudden speed reduction can be prevented.

If the ON-failure occurs to the linear solenoid valve SL3 in a condition where the vehicle is driving at the second shift stage. (downshift operation from the third shift stage to the second shift stage) and if the ON-failure occurs to the linear solenoid valve SL4 in a condition where the vehicle is driving at the third shift stage (downshift operation from the fourth shift stage to the third shift stage), the solenoid valve S2 is controlled from the ON-state to the OFF-state to establish the sixth shift stage at the fixed shift mode or the ON/OFF solenoid valve S3 is controlled from the ON-state to the OFF-state to establish the fourth shift stage at the fixed shift mode. According to the second embodiment of the present invention, even in the event that the ON-failure occurs to the ON/OFF solenoid valve, the fourth shift stage at the fixed shift mode can be established by increasing the output oil pressure of the linear solenoid valve SL2 to the failure range, as long as the shift valve SV3 is not stuck. Therefore, reliability of the failure-safe is improved relative to the first embodiment of the present invention.

[Improvement in Reliability at the R-range]

As illustrated in FIG. 19, because of the switching valve 211 and the oil passage 212, the R pressure from the manual valve can be transmitted to the accumulator (N-R ACC) ACC2 and the exhaust port of the linear solenoid valve SL3 through the first top switching circuit of the shift valve SV3 when the ON/OFF solenoid valve S3 is at the OFF-state (×) and the throttle pressure is equal to or higher than a predetermined value.

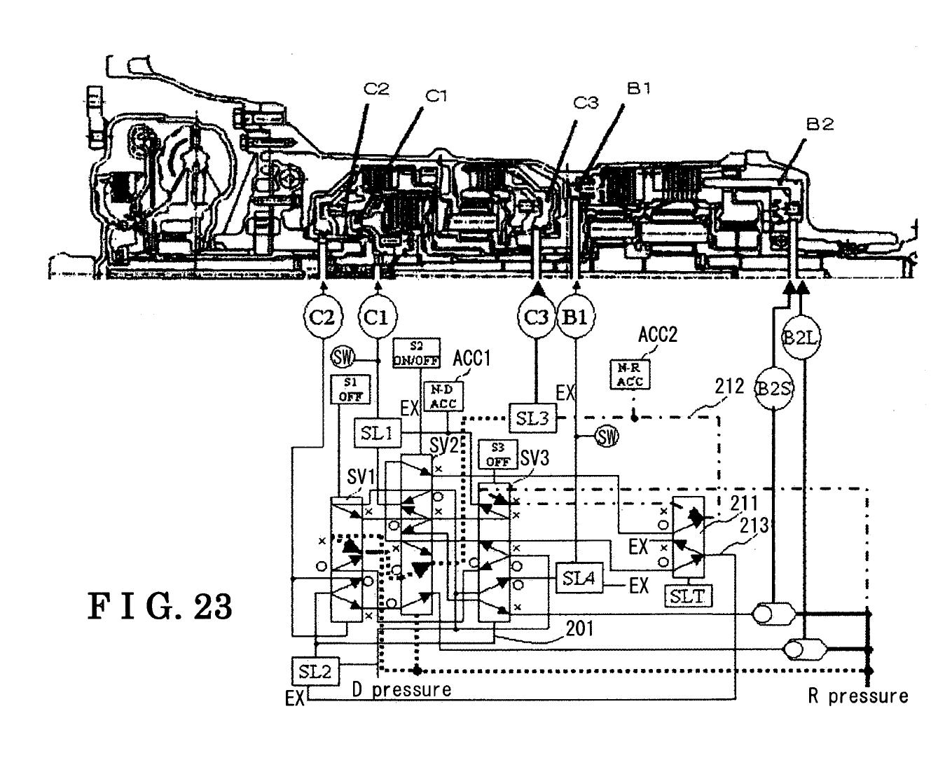

As illustrated in FIG. 23, in a condition where the ON/OFF solenoid valves S1 and S3 are at the OFF-state (×), the R pressure is transmitted to the exhaust port of the linear solenoid valve SL3 and the accumulator (N-R ACC) ACC2. Therefore, even in the event that the OFF-failure occurs to the linear solenoid valve SL3, the reverse driving of the vehicle can be performed. Further, shift shock can be reduced.

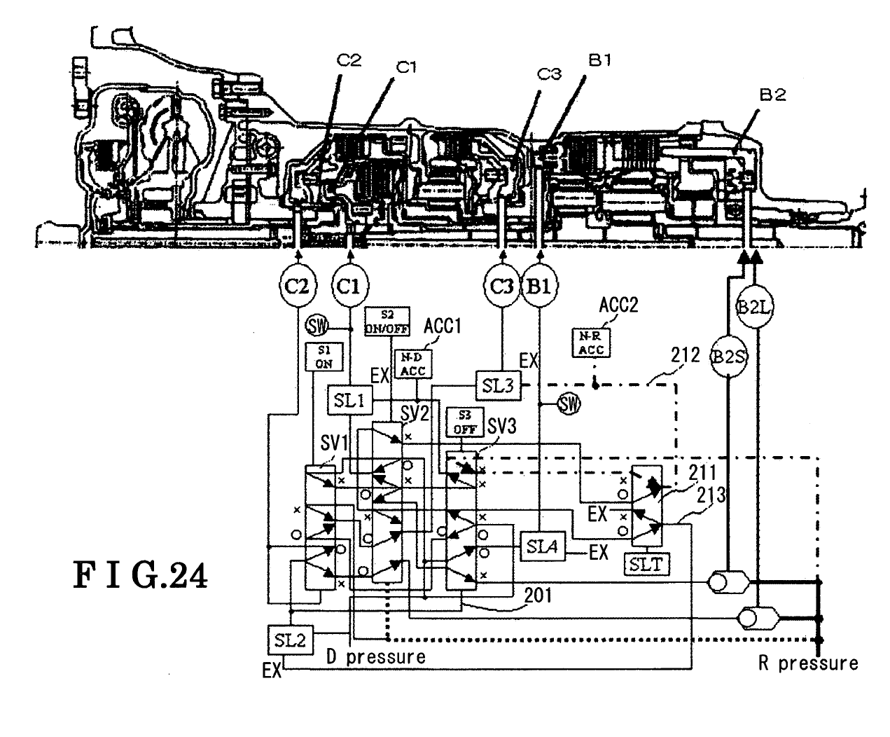

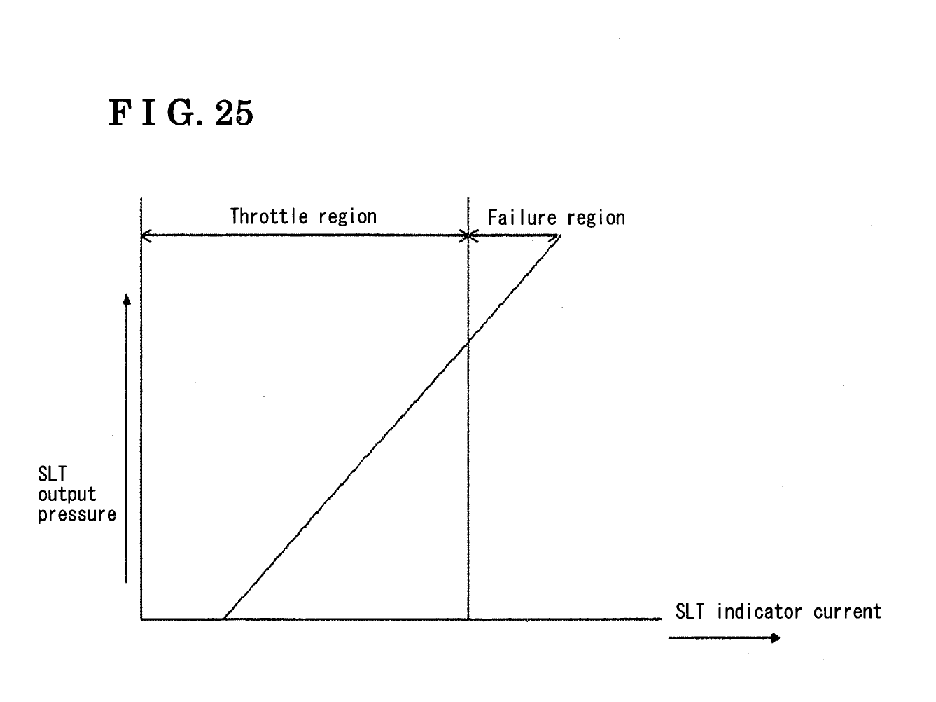

In contrast, with reference to FIG. 24, in a condition where the ON/OFF solenoid valve S1 is at the ON-state (∘) and the ON/OFF solenoid valve S3 is at the OFF-state (×), the NH type linear solenoid valve SL3 is changed to the NL type ON/OFF solenoid valve. Accordingly, with this pattern, the reverse driving of the vehicle is performed when the OFF-failure occurs to the linear solenoid valve and the reverse inhibitor is performed when the ON-failure of the inhibitor linear solenoid valve SL3 is generated.

[Measures to the OFF-Failure of the Linear Solenoid Valve]
As illustrated in FIG. 25, the output oil pressure of the linear solenoid valve (SLT) includes a throttle range, in which the output oil pressure is activated as the throttle pressure for adjusting a regulator valve, and a failure range, in which the output oil pressure exceeds the throttle range. The failure range is detected in a condition where the failure of the linear solenoid valve (SLT) is generated. The output oil pressure of the linear solenoid valve (SLT) is transmitted to an oil chamber provided at an end of the switching valve 211. The switching valve 211 is biased to remain at an OFF-state in a condition where the output oil pressure of the linear solenoid valve (SLT) is in the normal throttle range and the switching valve 211 is biased to turn on the linear solenoid valve (SLT) in a condition where the output oil pressure of the linear solenoid valve (SLT) is in the failure range.

In a condition where the output oil pressure of the linear solenoid valve (SLT) is in the normal throttle range, the exhaust port of the linear solenoid valve SL2 communicates with a drain (EX) and the oil passage of the first top switching circuit of the shift valve SV3 communicates with the exhaust port of the linear solenoid valve SL3 through each switching circuit of the switching valve 211. In contrast, when the output oil pressure of the linear solenoid valve (SLT) reaches the failure range, the output oil passage provided at the third-range from the top of the shift valve SV3 (the D pressure is outputted when the ON/OFF solenoid valve S3 is turned off) communicates with the exhaust port of the linear solenoid valve SL2 through the second top switching circuit of the switching valve 211. Further, the output oil circuit provided at the first range from the top of the shift valve 2 (the D pressure is outputted when the ON/OFF solenoid valves S2 and S3 are turned off) communicates with the exhaust port of the linear solenoid valve SL3 through the first top switching circuit of the switching valve 211. Alternatively, or in addition, if the [Improvement in Reliability at the R-range] is not required, a state in which the exhaust port of the linear solenoid valve SL2 communicates with the Ex (drain) and a sate in which the exhaust port of the linear solenoid valve SL2 communicates with an output oil passage of the D pressure may be changeable by remaining only the switching circuit of the switching valve 211 provided at the first range from the bottom thereof.

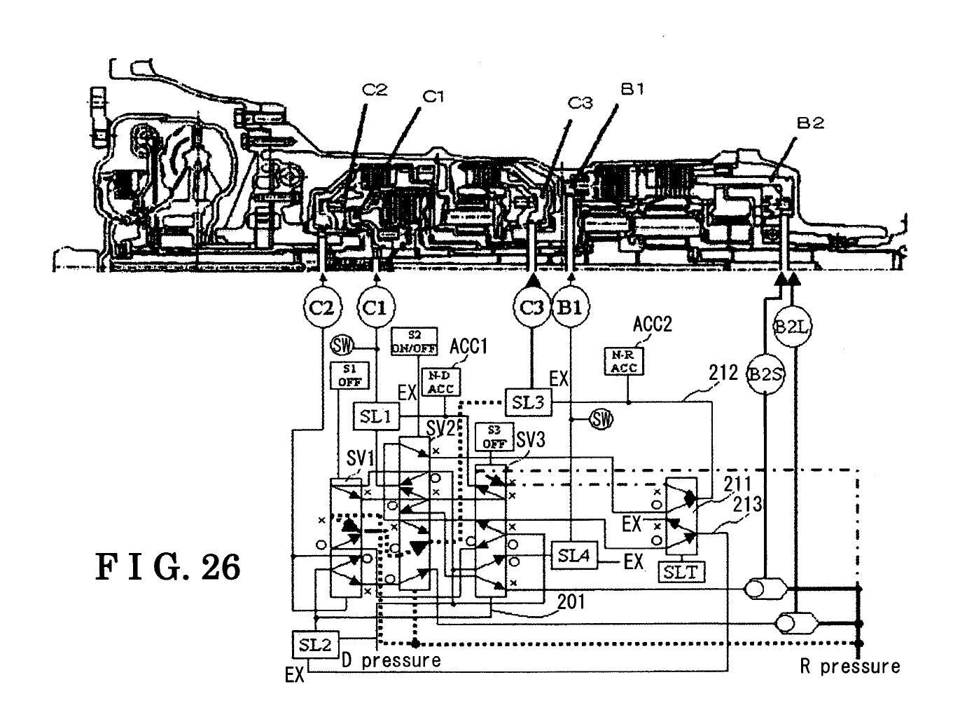

An operation of the oil pressure control apparatus according to the second embodiment of the present invention at each shift pattern will individually be explained hereinafter. The same operation as described in the first embodiment is not repeatedly explained.

[R-Range]
Under the R-range, if the output pressure of the linear solenoid valve SLT exceeds the throttle range, the R pressure is not transmitted to the clutch C3 regardless of a condition (ON/OFF) of the linear solenoid valve SLT. On this occasion, the clutch C3 can be controlled by the linear solenoid valve SL3 as illustrated in FIG. 26. When the shift pattern is shifted to the R-range from the first shift stage of the fixed shift mode at the D-range or the third shift stage of the fixed shift mode at the D-range in a condition where the output pressure of the linear solenoid valve SLT is in the throttle range, the ON/OFF solenoid valve S1 is controlled from the OFF-state to the ON-state so that the oil passage structure comes into a condition shown in FIG. 24 and the reverse inhibitor is performed. On this occasion, if the failure of the linear solenoid valve SLT is detected, the pressure of the clutch C3 can be drained at the linear solenoid valve linear solenoid valve SL3 as shown in FIG. 26 even in the event that the OFF-failure occurs to the ON/OFF solenoid valve S1. More specifically, a failure-safe mechanism, in which the vehicle comes into a N state by draining the pressure of the clutch C3 when a shift operation is mistakenly performed to the R-range in a condition where the vehicle is driving at the third shift stage at the D-range (in a condition where the primary failure is generated), can be added to the oil pressure control apparatus according to the second embodiment of the present invention.

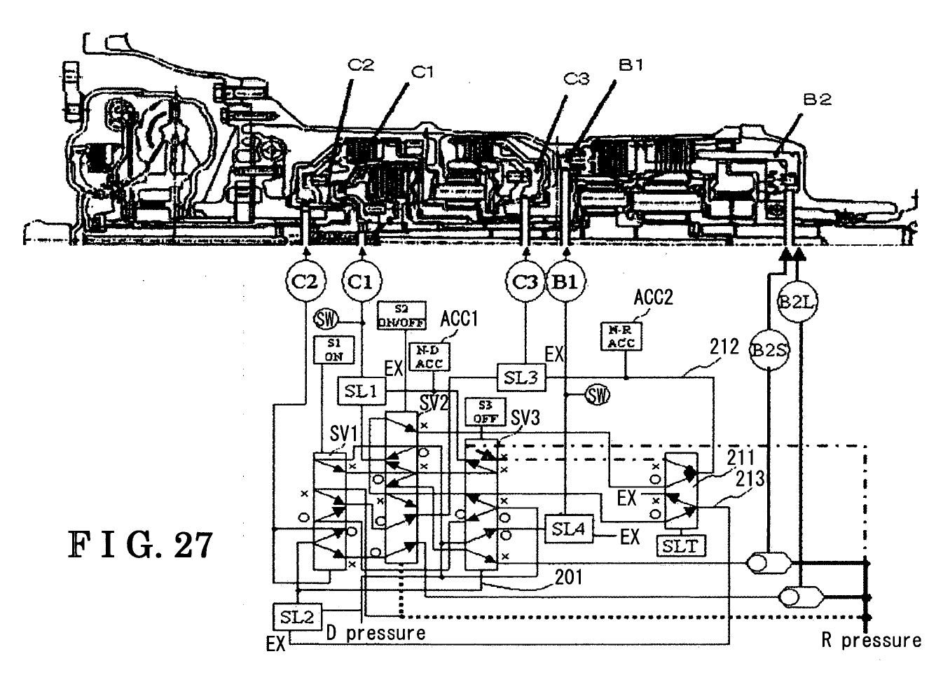

In a condition where the output pressure of the linear solenoid valve SLT exceeds the throttle range, the vehicle can completely be brought into the N-state as shown in FIG. 27 even when the ON/OFF solenoid valve S1 is at the ON-state (∘). Further, even when the shift pattern is shifted to the R-range from the fourth shift stage of the fixed shift mode at the D-range or the fifth shift stage of the fixed shift mode at the D-range, if the switching valve is operated to the ON-side, the R pressure is interrupted and the vehicle can be brought into the N-state at the early stage. As described above, according to the second embodiment of the present invention including measures to the OFF-failure of the linear solenoid valve, contrary to the D-range, the vehicle can be brought into the N-state from the reverse driving soon after the failure is detected.

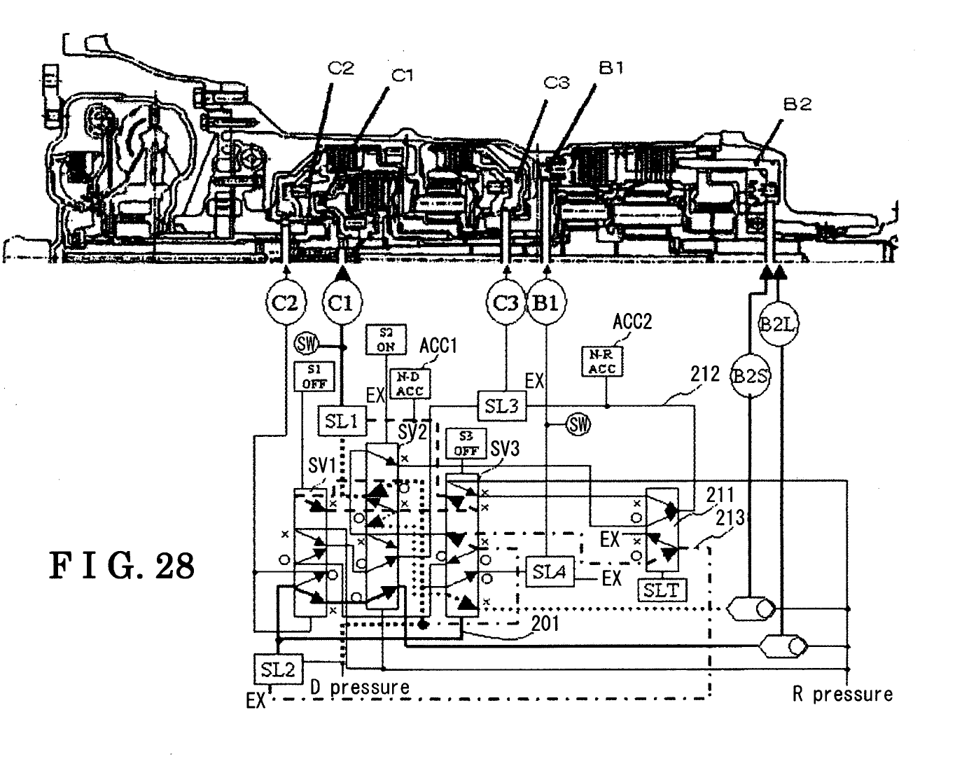

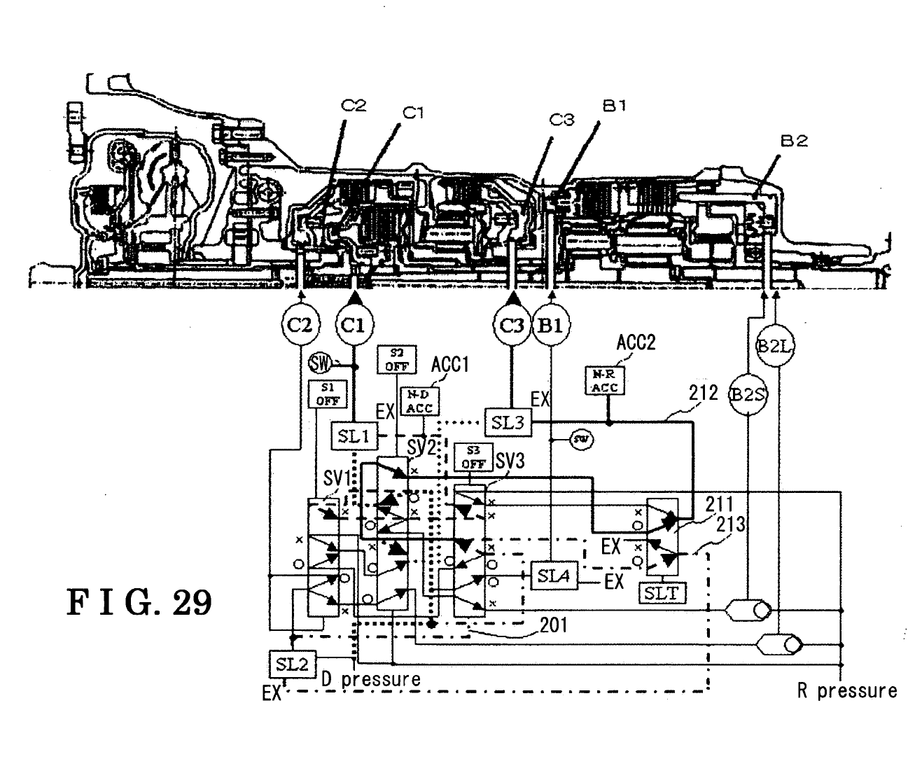

Under the D-range, in a condition where the ON/OFF solenoid valve S3 is at the ON-state (∘), the operation of the oil pressure control apparatus of the second embodiment is similar to that of the first embodiment. Therefore, an operation of the oil pressure control apparatus at the 1st, 3rd, 4th, and 5th shift stages in a condition where the ON/OFF solenoid valve S3 is at the OFF-state (×)will be explained hereinafter.

[D-range 1st Fixed Shift Mode]
Under the first fixed shift mode at the D-range, the ON/OFF solenoid valve S3 is at the OFF-state (×) as illustrated in FIG. 28. Therefore, the D pressure transmitted through the third top switching circuit of the shift valve SV3 is transmitted through the first bottom switching circuit of the switching valve 211 in the failure mode and is supplied to the exhaust port of the linear solenoid valve SL2. Accordingly, if the OFF-failure occurs to the linear solenoid valve SL2, the D pressure can be supplied to the brake B2 and the vehicle can be started from the torque converter stall.

[D-range 3rd Fixed Shift Mode]
Under the third fixed shift mode at the D-range, the ON/OFF solenoid valve S3 is turned off as illustrated in FIG. 29. Therefore, the D pressure transmitted through the third top switching circuit of the shift valve SV3 is transmitted through the first bottom switching circuit of the switching valve 211 in the failure mode and is supported to the exhaust port of the linear solenoid valve SL2. Although the output oil pressure of the linear solenoid valve SL2 becomes the D pressure, because the ON/OFF solenoid valve S2 is turned off, the D pressure is interrupted at the first bottom switching circuit of the shift valve SV2 and is not transmitted to the brake B2L.

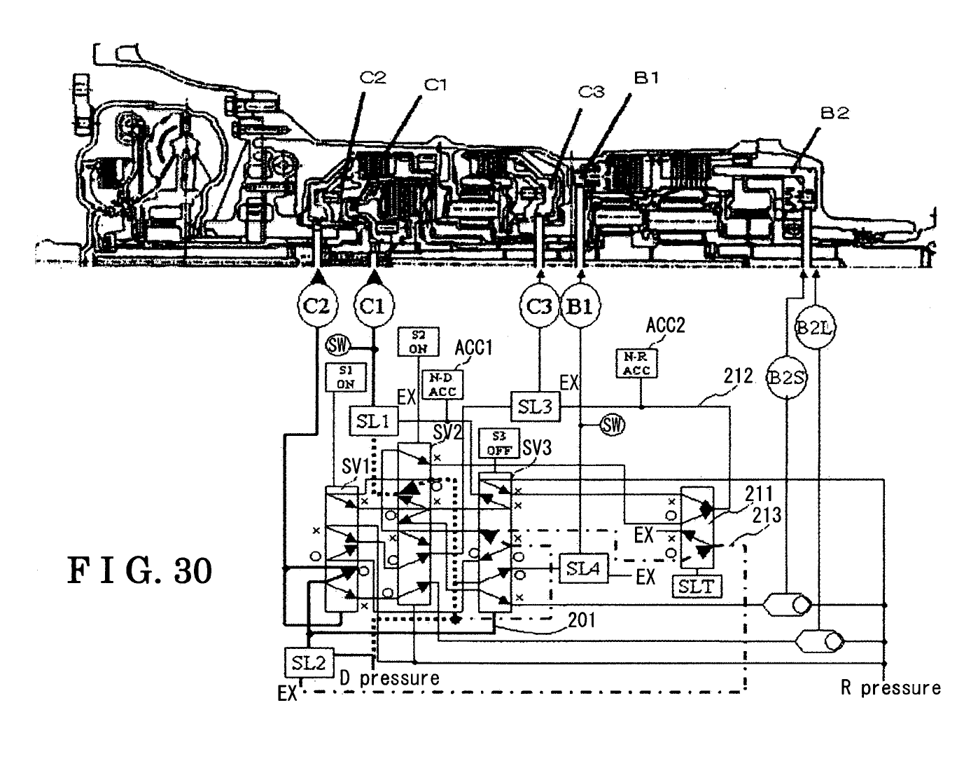

In contrast, the D pressure transmitted though the third top switching circuit of the shift valve SV3 is transmitted through the first top switching circuit of the shift valve SV2 and reaches the second top switching circuit of the switching valve 211. Then, the D pressure is supplied to the accumulator and the exhaust port of the linear solenoid valve SL3 in the failure mode and the output oil pressure of the linear solenoid valve SL3 becomes the D pressure. Accordingly, the clutch C1 (D pressure) and the clutch C3 (D pressure) are engaged to establish the third shift stage and the vehicle can be driven regardless of the OFF-failure of the linear solenoid valves SL1 and SL3.

[D-range 4th Fixed Shift Mode]
Under the fourth fixed shift mode at the D-range, the ON/OFF solenoid valve S3 is at the OFF-state (×) as illustrated in FIG. 30. Therefore, the D pressure transmitted through the third top switching circuit of the shift valve SV3 is transmitted through the first bottom switching circuit of the switching valve 211 in the failure mode. Then, the D pressure is supplied to the exhaust port of the linear solenoid valve SL2 and the output oil pressure of the linear solenoid valve L2 becomes the D pressure. Accordingly, even when the OFF-failure occurs to the linear solenoid valve SL2, the clutch C2 can be engaged and the vehicle can be driven at the fourth shift stage.

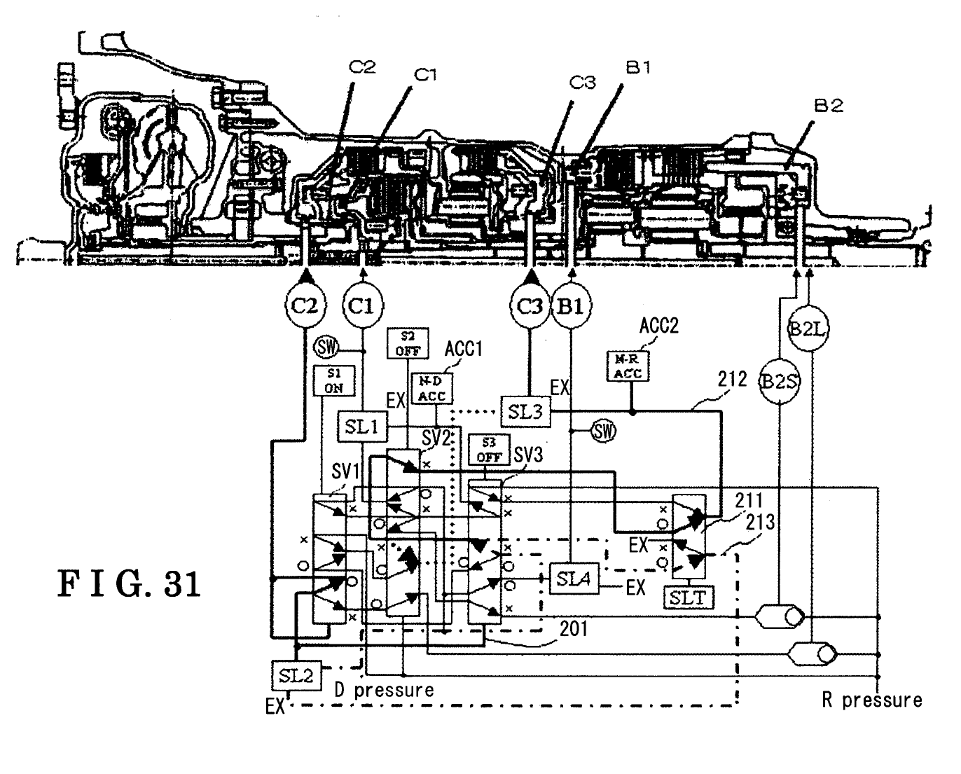

According to the second embodiment of the present invention, if the OFF-failure occurs to the linear solenoid valve SL1, the vehicle is brought into the N state in which only the clutch C2 is engaged. However, the present invention is not limited thereto. Alternatively, or in addition, the vehicle may be driven even in a condition where the OFF-failure occurs to the linear solenoid valve SL1 by adding a switching circuit to each shift valve for supplying the oil pressure to the exhaust port of the linear solenoid valve SL1.

[D-range 5th Fixed Shift Mode]
Under the fifth fixed shift mode at the D-range, the ON/OFF solenoid valve S3 is at the OFF-state (×) as illustrated in FIG. 31. Therefore, the D pressure transmitted through the third top switching circuit of the shift valve SV3 is transmitted thorough the first bottom switching circuit of the switching valve 211 in the failure mode and is supplied to the exhaust port of the linear solenoid valve SL2. Accordingly, the output oil pressure of the linear solenoid valve SL2 becomes the D pressure.

Further, the D pressure transmitted through the third top switching circuit of the shift valve SV3 is transmitted through the first top switching circuit of the shift valve SV2 and the second top switching circuit of the switching valve 211. Then, the D pressure is supplied to the accumulator and the exhaust port of the linear solenoid valve SL3 and the output oil pressure of the linear solenoid valve SL3 becomes the D pressure. Accordingly, in a condition where the OFF-failure occurs to the linear solenoid valve SL2 or SL3, the D pressure is supplied to the clutch C2 and the clutch C3 and the vehicle can thereby be driven at the fifth shift stage.

Accordingly, in the second embodiment of the present invention, several functions are added to the oil pressure control apparatus according to the first embodiment of the present invention. According to the second embodiment of the present invention, length of the oil passage of each electromagnetic valve and frictional engagement element is reduced and each electromagnetic valve is arranged in the vicinity of an oil opening of the frictional engagement element provided at an automatic transmission body for improving functionality. However, the present invention is not limiter thereto. Alternatively, or in addition, restriction of an arrangement of each electromagnetic valve and frictional engagement element may be eased.

### Third Embodiment

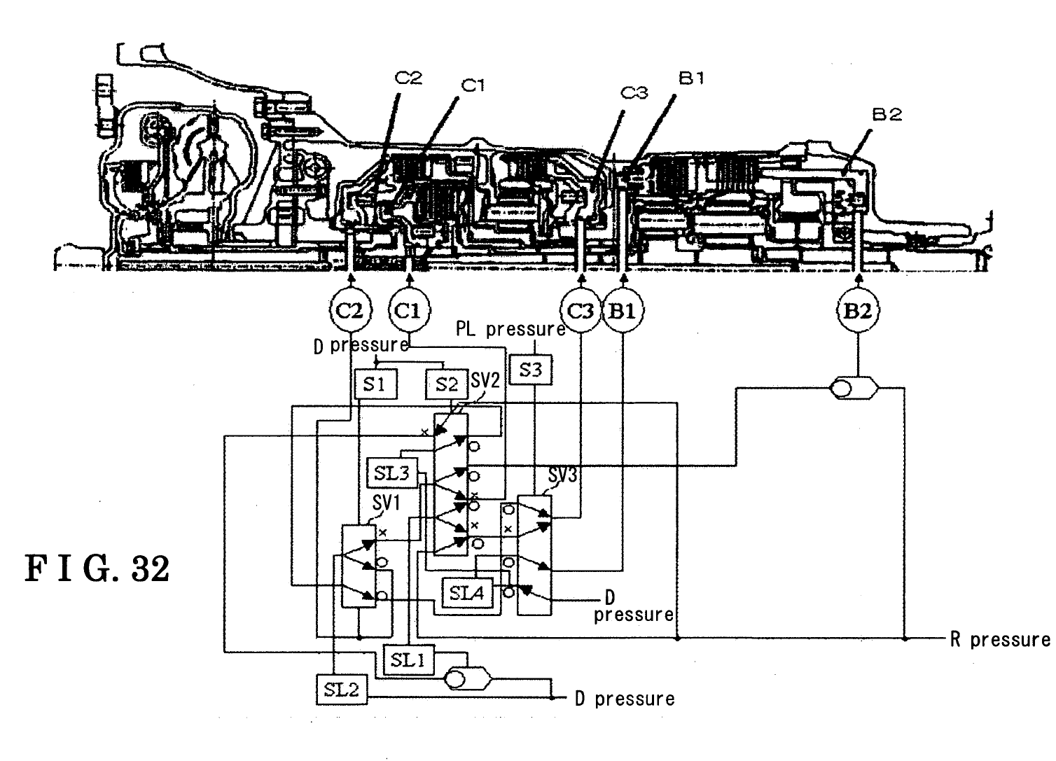

A third embodiment of the present invention is described hereinafter. The same structure as described in the aforementioned embodiments is not repeatedly explained. In the third embodiment, the restriction of the length of the oil passage of each electromagnetic valve and frictional engagement element is eased relative to the first and second embodiments of the present invention. In FIG. 32, the drain (Ex) is omitted in view of simplification of the figure. However, if the oil pressure is interrupted at the shift valve SV, the Ex (drain) can appropriately be provided for draining the oil pressure as well as the first and second embodiments.

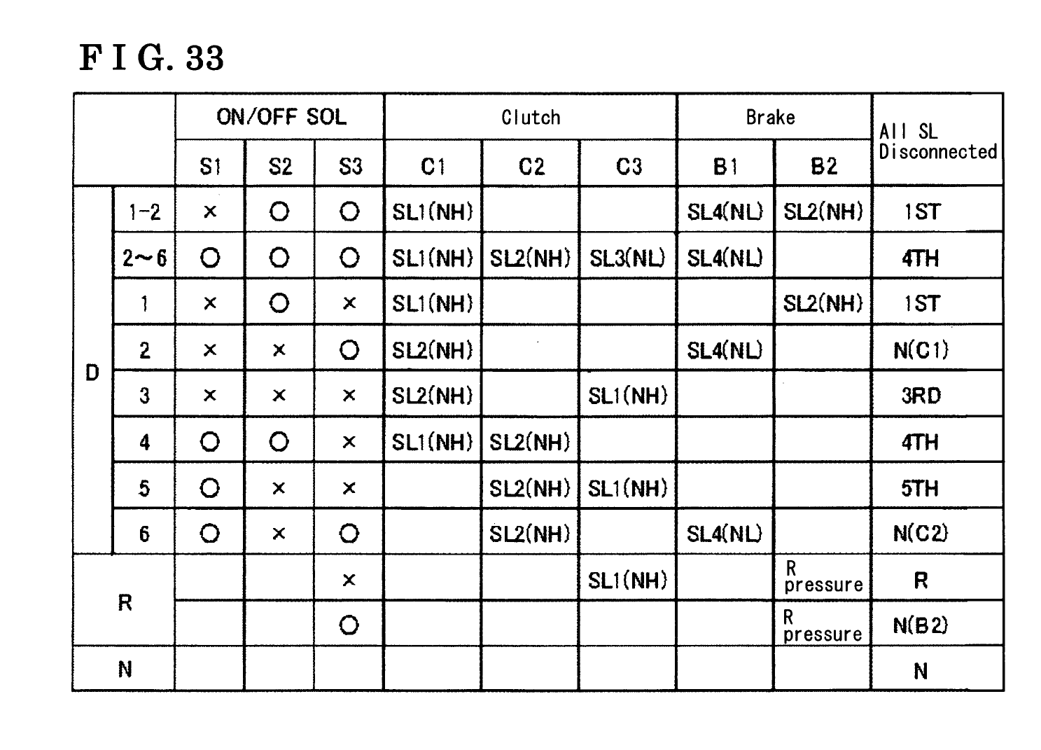

Unlike in the case of the first and second embodiments, according to the third embodiment of the present invention, the linear solenoid valve is arranged at the upstream of the shift valve as illustrated in FIGS. 32 and 33. Therefore, a distance between the electromagnetic valve and the frictional engagement element is longer than that of the first and second embodiments. Further, according to the third embodiment of the present invention, linear solenoid valves are not exclusively used for each frictional engagement element but two NH type linear solenoid valves SL1 and SL2 are provided. The oil passage is configured in such a manner that near shift stage is established by means of the NH type linear solenoid valves when all the linear solenoid valves are disconnected. As well as the first and second embodiment of the present invention, certain shift patterns (ON/OFF) condition of the shift valves are assigned to the first to second shift mode and second through sixth shift mode and other shift patterns are assigned to the fixed shift stages.

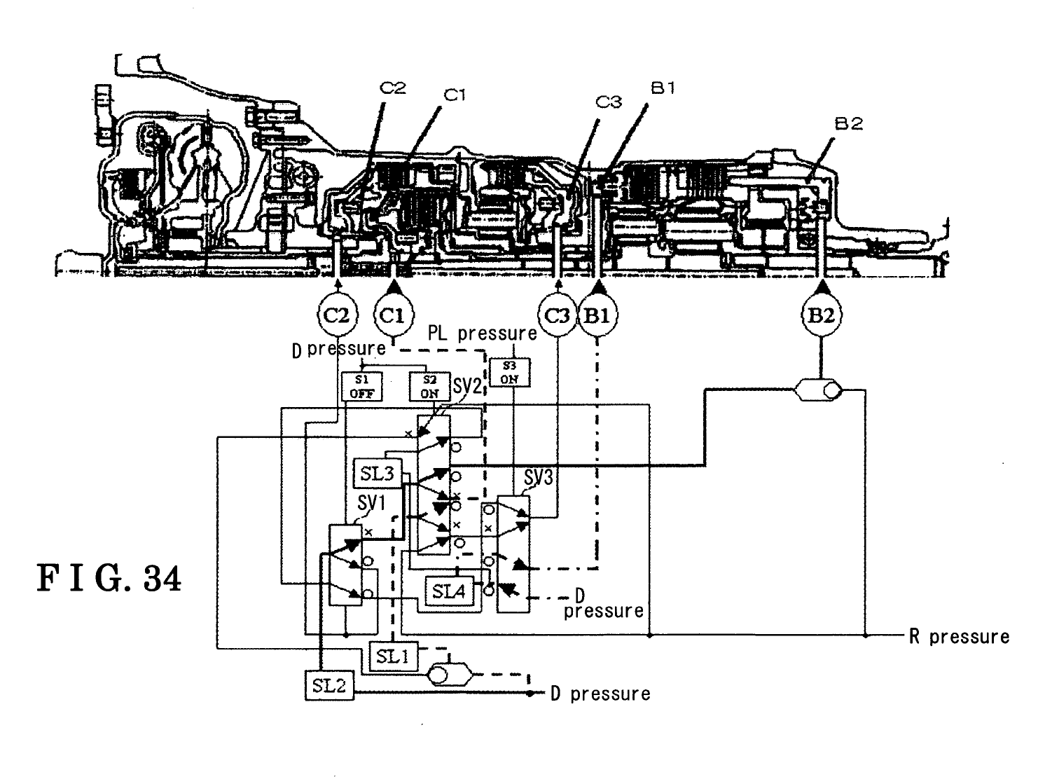

An operation of the oil pressure control apparatus according to the third embodiment of the present invention at each shift pattern will individually be explained hereinafter. The same operation as described in the aforementioned embodiments is not repeatedly explained.

[D-rage 1st-2nd Automatic Shift Mode]
Under the first to second automatic shift mode at the D-range, the ON/OFF solenoid valve S2 is at the ON-state (∘) as illustrated in FIG. 34. Therefore, the output oil passage of the linear solenoid valve SL1 communicates with the clutch C1 through the third bottom switching circuit of the shift valve SV2. Further, because the ON/OFF solenoid valve S3 is turned on, the output oil passage of the linear solenoid valve SL4 communicates with the brake B1 through the first bottom switching circuit and the second bottom switching circuit of the shift valve SV3.

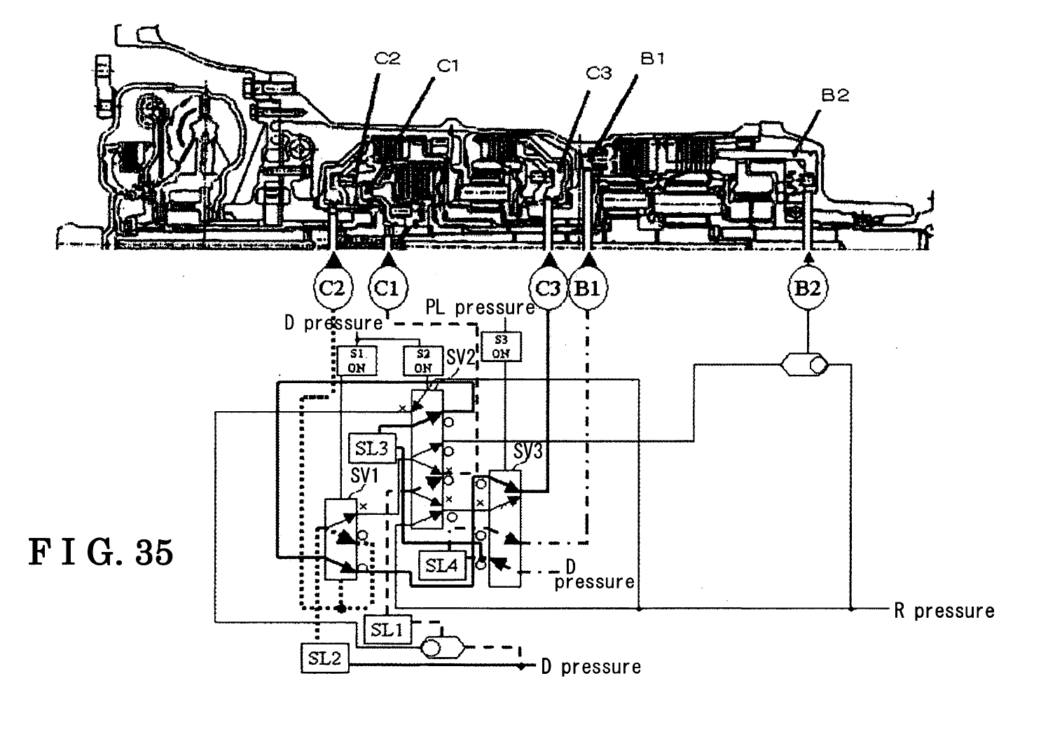

Although the output oil passage of the linear solenoid valve SL3 communicates with the second top switching circuit of the shift valve SV2, because the ON/OFF solenoid valve S1 is at the OFF-state (×), the output oil pressure is interrupted at the first bottom switching circuit of the shift valve SV1 and is not reached the clutch C3. Accordingly, the clutch C1 (SL1), the brake B1 (SL4), and the brake B2 (SL2) can be controlled. Therefore, the shift pattern for automatic shift at lower shift stages can be achieved. More specifically, the automatic shift between the first shift stage using the clutch C1 (SL1) and the brake B2 (SL2) and the second shift stage using the clutch C1 (SL1) and the brake B1 (SL4) can be performed. Further, because the linear solenoid valves SL1 and SL2 are NH type, the first shift stage is automatically established at the all-electric disconnection-state of the linear solenoid valves.

[D-range 2nd-6th Automatic Shift Mode]
Under the second through sixth automatic shift mode at the D-range, the ON/OFF solenoid valves S1, S2, and S3 are at the ON-state (∘) as illustrated in FIG. 35. Therefore, the output oil passage of the linear solenoid valve SL1 communicates with the clutch C1 through the third bottom switching circuit of the shift valve SV2. The output oil passage of the linear solenoid valve SL2 communicates with the clutch C2 through the second top switching circuit of the shift valve SV1. The output oil passage of the linear solenoid valve SL3 communicates with the clutch C3 through the second top switching circuit of the shift valve SV2, the first bottom switching circuit of the shift valve SV1, and the first top switching circuit of the shift valve SV3. The output oil passage of the linear solenoid valve SL4 communicates with the brake B1 through the first bottom switching circuit and the second bottom switching circuit of the shift valve SV3.

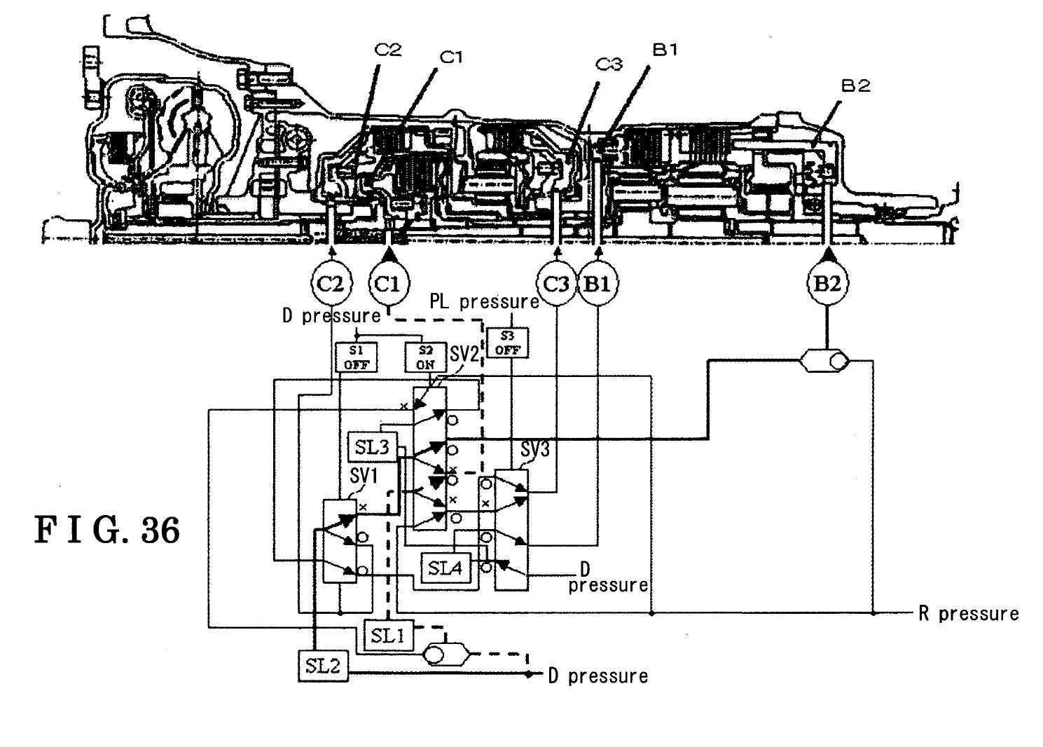

J Accordingly, the clutch C1 (SL1), the clutch C2 (SL2), the clutch C3 (SL3), and the brake B1 (SL4) can be controlled and the shift pattern for the automatic shift at the middle and higher shift stages, in which the skip shift among the following shift stages:
2^{nd} clutch C1 (linear solenoid valve SL1), brake B1 (linear solenoid valve SL4)
3^{rd} clutch C1 (linear solenoid valve SL1), clutch C3 (linear solenoid valve SL3)
4^{th} clutch C1 (linear solenoid valve SL1), clutch C2 (linear solenoid valve SL2)
5^{th} clutch C2 (linear solenoid valve SL2), clutch C3 (linear solenoid valve SL3)
6^{th} clutch C2 (linear solenoid valve SL2), brake B1 (linear solenoid valve SL4)
is performed, can be achieved. Further, because the linear solenoid SL1 and SL2 are the NH type, the fourth shift stage is automatically established at the time of disconnection of all the linear solenoid valves.

[D-range 1st Fixed Shift Mode]
Under the first fixed shift mode at the D-range, the ON/OFF solenoid valve S1 is at the OFF-state (×), the ON/OFF solenoid valve S2 is at the ON-state (∘), and the ON/OFF solenoid valve S3 is at the OFF-state (×) as illustrated in FIG. 36. Therefore, the output oil passage of the linear solenoid valve SL1 communicates with the clutch C1 through the third bottom switching circuit of the shift valve SV2. Further, the output oil passage of the linear solenoid valve SL2 communicates with the brake B2 through the first top switching circuit of the shift valve SV1, the third to switching circuit of the shift valve SV2, and the shuttle valve.

Although the output oil passage of the linear solenoid valve SL3 communicates with the second top switching circuit of the shift valve SV2, because the ON/OFF solenoid valve S1 is at the OFF-state (×), the output oil pressure is interrupted at the first bottom switching circuit of the shift valve SV1 and is not reached the clutch C3. Likewise, the output oil pressure of the linear solenoid valve SL4 is interrupted at the first bottom switching circuit of the shift valve SV3 and is not reached the brake B1.

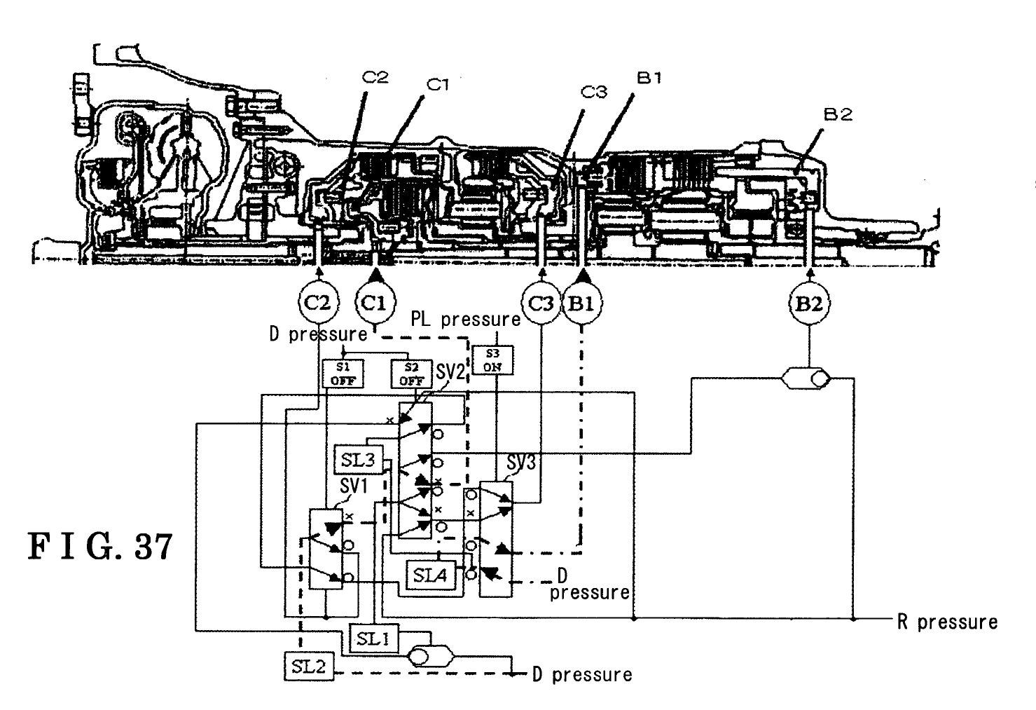

Accordingly, the clutch C1 (SL1) and the brake B2 (SL2) are engaged and the first shift stage is established. Further, because the linear solenoid valves SL1 and SL2 are the NH type, the first shift stage is remained even when all the linear solenoid valves are disconnected. The disconnection of all solenoid valves including the ON/OFF solenoid valves and the disconnection of all the linear solenoid valves are separately considered in the embodiments of the present invention because the ON/OFF solenoid valves are frequently used in the shift operation. Not only the normal disconnection but also the OFF-failure of hardware of the ON/OFF solenoid valve may be considered as the disconnection-state. In a condition where the ignition is turned off, the disconnection of all solenoid valves including the ON/OFF solenoid valves is generated.

[D-range 2nd Fixed Shift Mode]
Under the second fixed shift mode at the D-range, the ON/OFF solenoid valves S1 and S2 are at the OFF-state (×) as illustrated in FIG. 37. Therefore, the output oil passage of the linear solenoid valve SL2 communicates with the clutch C1 through the first top switching circuit of the shift valve SV1 and the fourth top switching circuit of the shift valve SV2. Further, the output oil passage of the linear solenoid valve SL4 communicates with the brake B1 through the first bottom switching circuit and the second bottom switching circuit of the shift valve SV3.

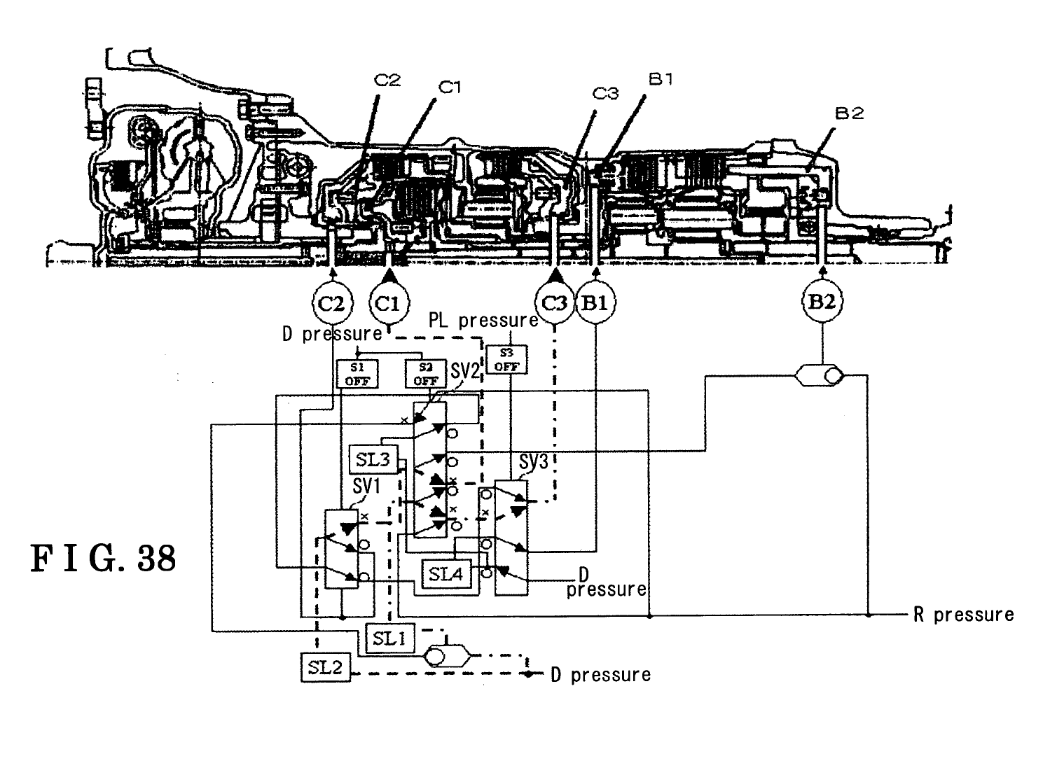

Although the output oil passage of the linear solenoid valve SL1 communicates with the second bottom switching circuit of the shift valve SV2, because the ON/OFF solenoid valve S3 is at the ON-state (∘), the output oil pressure is interrupted at the second bottom switching circuit of the shift valve SV3 and is not reached the clutch C3. Likewise, the output oil passage of the linear solenoid valve SL3 is interrupted at the second top switching circuit of the shift valve SV2 and is not reached the clutch C3. Accordingly, the clutch C1 (SL2) and the brake B1 (SL4) are engaged and the second shift stage is established. Further, because the linear solenoid valve SL2 is the NH type and the linear solenoid valve SL4 is the NL type, the vehicle is brought into N (C1) state at the all-electric disconnection-state of the linear solenoid valves.

[D-range 3rd Fixed Shift Mode]
Under the third fixed shift mode at the D-range, all solenoid valves are disconnected, i.e., the ON/OFF solenoid valves S1, S2, and S3 are at the OFF-state (×) as illustrated in FIG. 38. Therefore, the output oil passage of the linear solenoid valve SL1 communicates with the clutch C3 through the second bottom switching circuit of the shift valve SV2 and the second top switching circuit of the shift valve SV3. Further, the output oil passage of the linear solenoid valve SL2 communicates with the clutch C1 through the first top switching circuit of the shift valve SV1 and the fourth top switching circuit of the shift valve SV2.

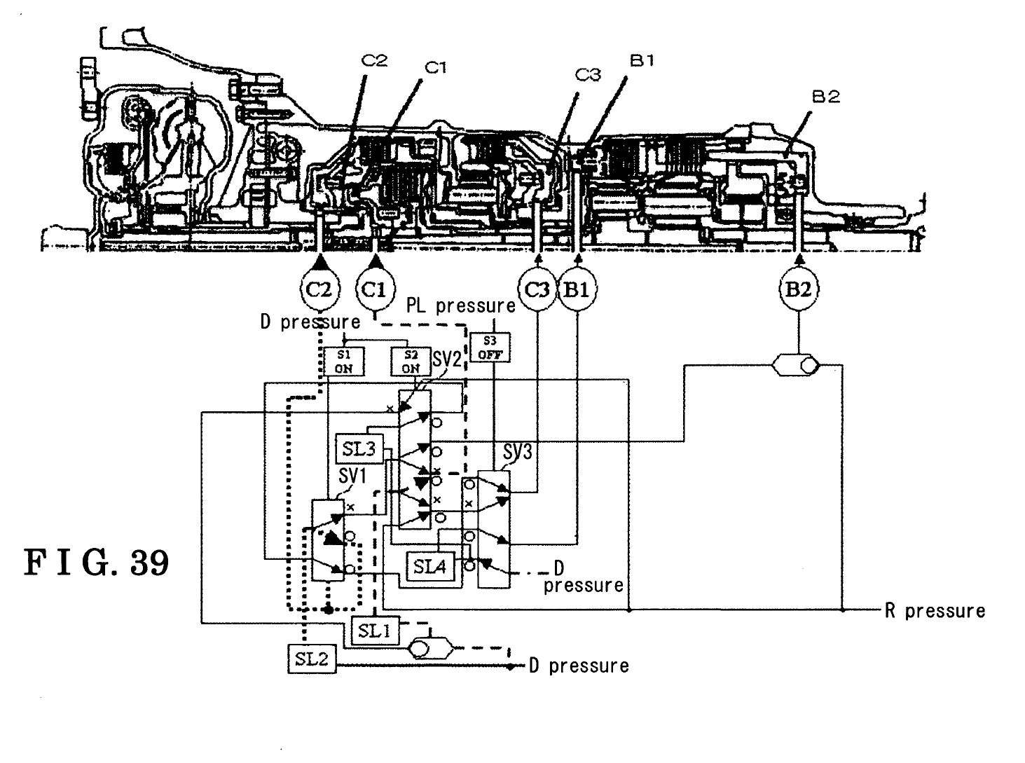

On this occasion, the output oil pressure of the linear solenoid valve SL3 is interrupted at the second top switching circuit of the shift valve SV2 and is not reached the clutch C3. Likewise, the output oil pressure of the linear solenoid valve SL4 is interrupted at the first bottom switching circuit and the second bottom switching circuit of the shift valve SV3 and is not reached the brake B1. Accordingly, the clutch C3 (SL1) and the clutch C1 (SL2) are engaged and the third shift stage is established. Further, because the linear solenoid valves SL1 and SL2 are the NH type, the third shift stage is remained even when all the linear solenoid valves are disconnected.

[D-range 4th Fixed Shift Mode]
Under the fourth fixed shift mode at the D-range, the ON/OFF solenoid valves S1 and S2 are at the ON-state (∘) as illustrated in FIG. 39. Therefore, the output oil passage of the linear solenoid valve SL1 communicates with the clutch C1 through the third bottom switching circuit of the shift valve SV2. Further, the output oil passage of the linear solenoid valve SL2 communicates the clutch C2 through the second top switching circuit of the shift valve SV1. Because a latch circuit is provided between the output oil passage of the linear solenoid valve SL2 and an oil chamber provided at an end of the shift valve SV1, the output oil pressure of the linear solenoid valve SL2 is transmitted to the oil chamber provided at the end of the shift valve SV1 so that the shift valve SV1 remains at ON-state.

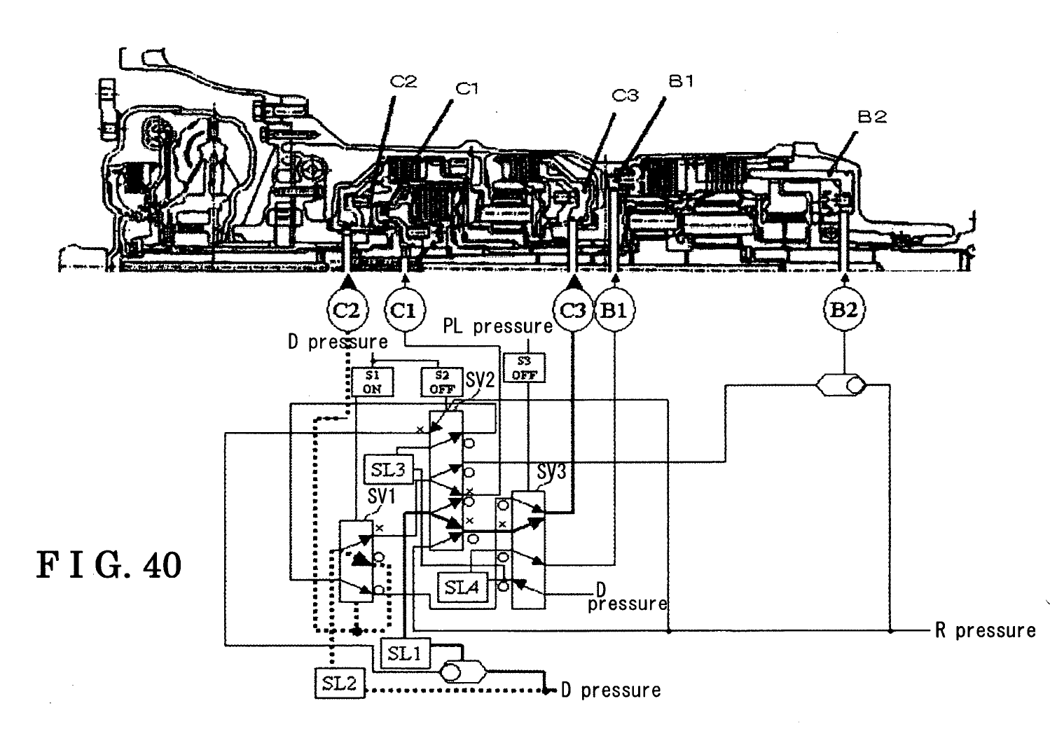

Although the oil pressure passage of the linear solenoid valve SL3 communicates with the second top switching circuit of the shift valve SV2 and the first bottom switching circuit of the shift valve SV1, the output oil pressure is interrupted at the first top switching circuit of the shift valve SV3 and is not reached the clutch C3. Likewise, the output oil passage of the linear solenoid valve SL4 is interrupted at the first bottom switching circuit and the second bottom switching circuit of the shift valve SV3 and is not reached the brake B1. Accordingly, the clutch C3 (SL1) and the clutch C2 (SL2) are engaged and the fourth shift stage is established. Further, because the linear solenoid valves SL1 and SL2 are the NH type, the fourth shift stage is remained even when the all linear solenoid valve are disconnected.

[D-range 5th Fixed Shift Mode]
Under the fifth fixed shift mode at the D-range, the ON/OFF solenoid valve S1 is at the ON-state (∘) and the ON/OFF solenoid valves S2 and S3 are at the OFF-state (×) as illustrated in FIG. 40. Therefore, the output oil passage of the linear solenoid valve SL1 communicates with the clutch C3 through the second bottom switching circuit of the shift valve SV2 and the second top switching circuit of the shift valve SV3. Further, the output oil pressure of the linear solenoid valve SL2 transmitted through the second top switching circuit of the shift valve SV1 latches the shift valve SV1 to the ON-side (∘) and is transmitted to the clutch C3.

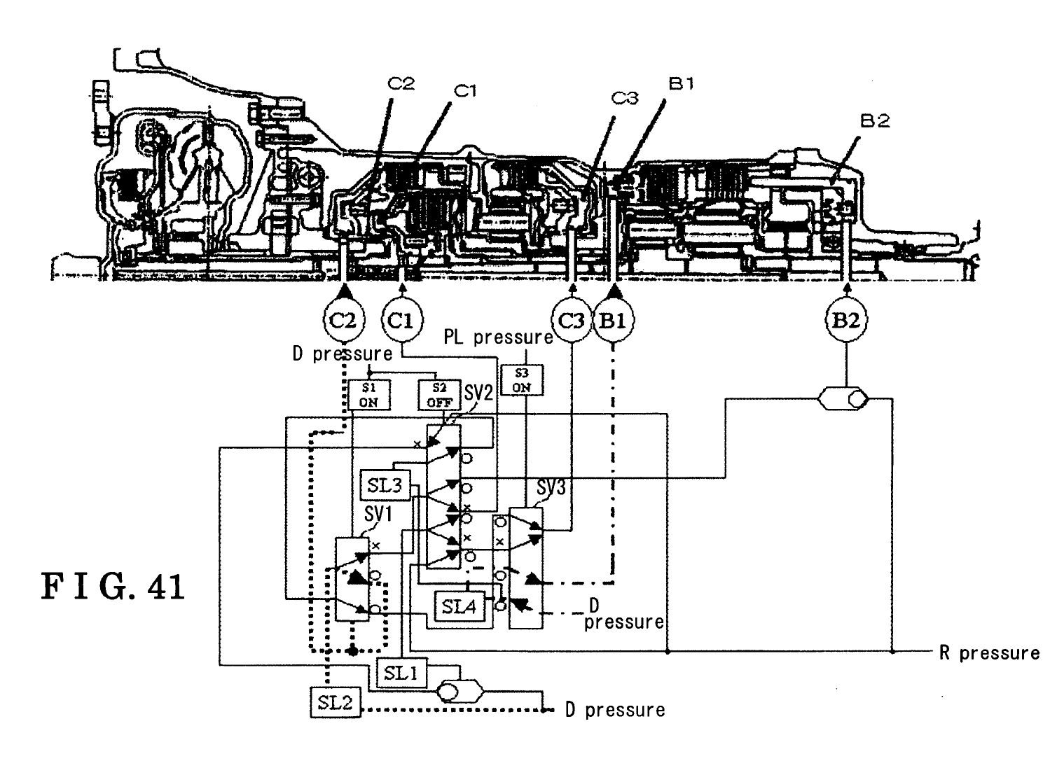

The output oil passage of the linear solenoid valve SL3 is interrupted at the second top switching circuit of the shift valve SV2 and is not reached the clutch C3. Likewise, the output oil passage of the linear solenoid valve SL4 is interrupted at the first bottom switching !circuit and the second bottom switching circuit of the shift valve SV3 and is note reached the brake B1. Accordingly the clutch C3 (SL1) and the clutch C2 (SL2) are engaged and the fifth shift stage is established. Further, because the linear solenoid valves SL1 and SL2 are the NH type, the fifth shift stage is remained even when all the linear solenoid valves are disconnected.

[D-range 6th Fixed Shift Mode]
Under the sixth fixed shift mode at the D-range, the ON/OFF solenoid valves S1 and S3 are at the ON-state (∘) and the ON/OFF solenoid valve S2 is at the OFF-state (×) as illustrated in FIG. 41. Therefore, the output oil passage of the linear solenoid valve SL2 transmitted through the second top switching circuit of the shift valve SV1 latches the shift valve SV1 to the ON-side (∘) and is transmitted to the clutch C2. Further, the output oil passage of the linear solenoid valve SL4 communicates with the brake B1 through the first bottom switching circuit and the second bottom switching circuit of the shift valve SV3.

Although the output oil passage of the linear solenoid valve SL1 communicates with the second bottom switching circuit of the shift valve SV2, the output oil pressure is interrupted at the second top switching valve of the shift valve SV3 and is not reached the clutch C3. Likewise, the output oil pressure of the linear solenoid valve SL3 is interrupted at the second top switching circuit of the shift valve SV2 and is not reached the clutch C3. Accordingly the clutch C2 (SL2) and the brake B1 (SL4) are engaged and the sixth shift stage is established. Further, because the linear solenoid valve SL2 is the NH type and the linear solenoid valve SL4 is the NL type, the vehicle is brought into the N (C2) state when all the linear solenoid valves are disconnected.

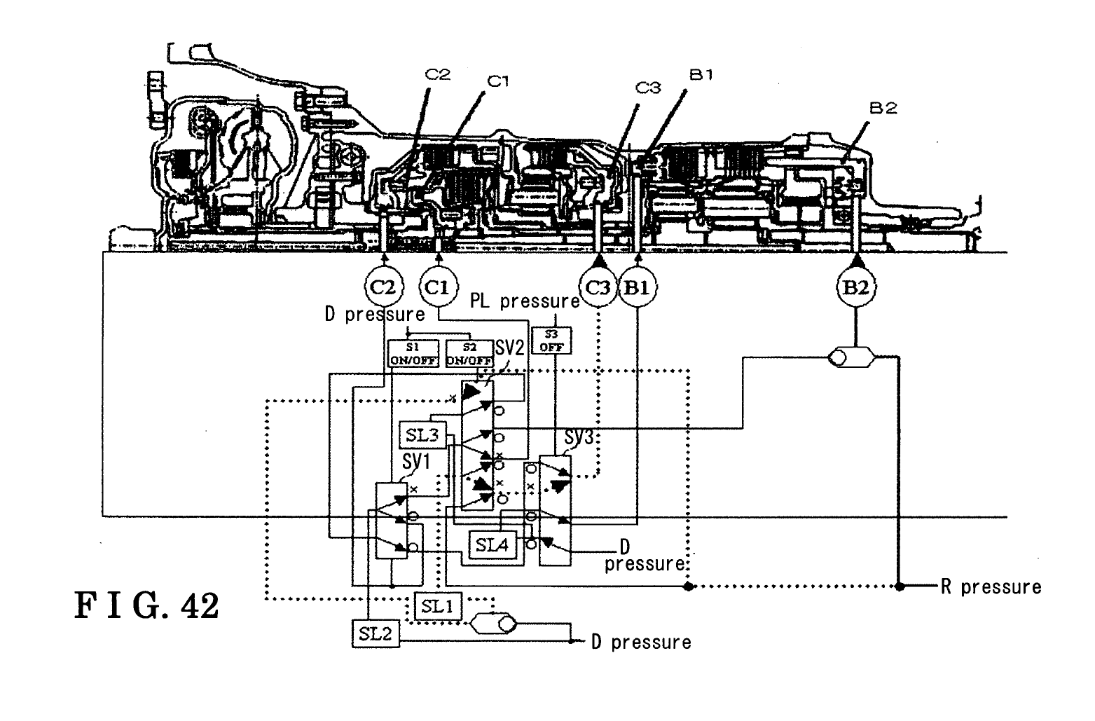

Under the aforementioned D-range, the vehicle comes into the N-state when the second or the sixth fixed shift mode is selected in a condition where all the linear solenoid valves are disconnected. However, if the vehicle is driving under the second fixed shift mode, the shift pattern is transmitted to the first to second automatic shift mode, second though sixth automatic shift mode, or the third fixed shift mode. Accordingly, the vehicle can be driven at those shift stages applicable for the all-electric disconnection-state of the linear solenoid 1O valves. Likewise, if the vehicle is driving under the sixth fixed shift mode, the shift pattern is transmitted to the second through sixth automatic shift mode, fifth fixed shift mode, or the third fixed shift mode. Accordingly, the vehicle can be driven at those shift stages applicable for the all-electric disconnection-state of the linear solenoid valves.

[R-range]
Under the R-range, the ON/OFF solenoid valve S3 is at the OFF-state (×) and the ON/OFF state of the ON/OFF solenoid valves S1 and S2 are not fixed as illustrated in FIG. 42. The R pressure introduced in the oil chamber provided at the end of the shift valve SV2 forcibly control the shift valve SV2 to the OFF-state (×) and is supplied to the brake B2 through the linear solenoid valve SL1 and the shuttle valve. However, the R pressure is not supplied to the linear solenoid valves SL2, SL3, and SL4. Because the shift valve SV2 is at the OFF-state (×), the output oil passage of the linear solenoid valve SL1 communicates with the clutch C3 through the second bottom switching circuit of the shift valve SV2 and the second top switching valve of the shift valve SV3.

Accordingly, the brake B2 (R pressure) and the clutch C3 (SL1) are engaged and the reverse shift stage is established. Further, because the linear solenoid valve SL1 is the NH type, the R-range is remained when all the linear solenoid valves are disconnected.

According to the third embodiment of the present invention, the reverse driving of the vehicle can be remained by transmitting the R pressure to the clutch C3 through the first bottom switching circuit of the shift valve SV2 and the second top switching circuit of the shift valve SV3. If the R-range is selected from, a high speed driving state in a condition where the ON-failure occurs to the linear solenoid valve SL1, transmission of the R pressure to the clutch C3 can be prevented by performing the reverse inhibitor control which controls the ON/OFF solenoid valve S3 at the ON-state (∘).

According to the third embodiment of the present invention, a structure for detecting the interlock is required in case of generation of the ON-failure of the NL type linear solenoid valve at the automatic shift mode. As well as the second embodiment of the present invention, the third embodiment of the present invention is applicable as long as the oil pressure control apparatus includes a function for detecting the ON-failure of the linear solenoid valve at the early stage. Further, the third embodiment of the present invention is applicable as long as the measures to the OFF-failure of the linear solenoid valve are prepared.

### Fourth Embodiment

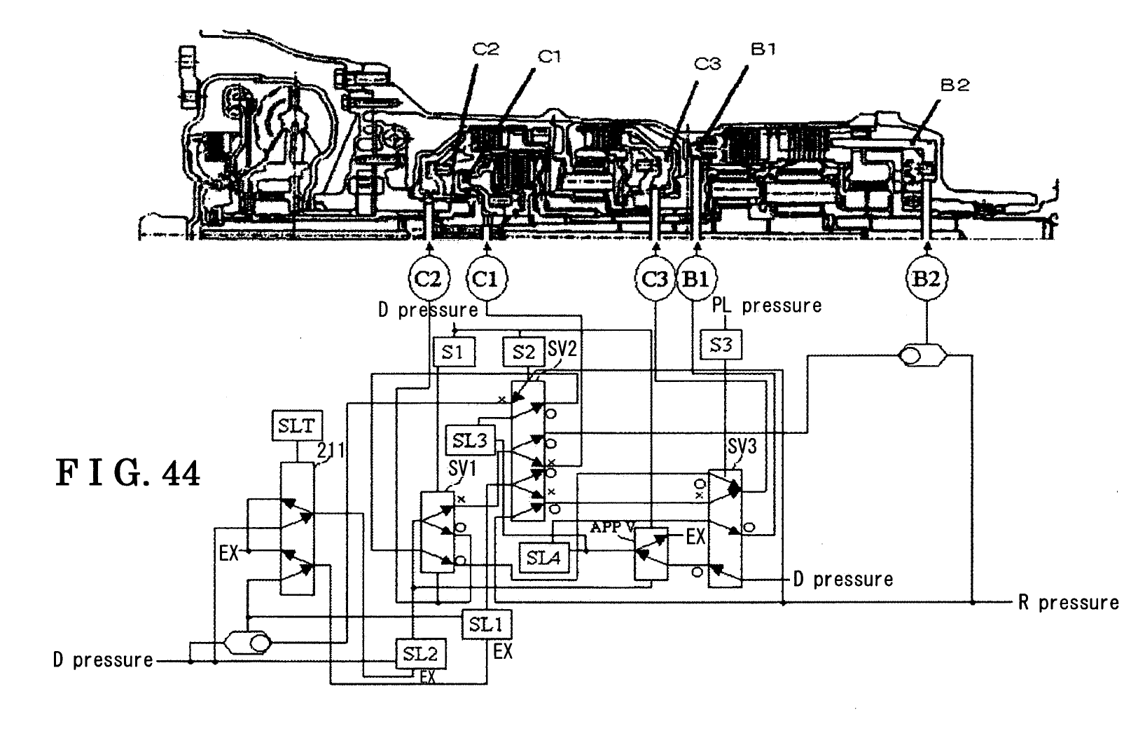

A fourth embodiment of the present invention will be explained hereinafter. The same structure as described in the aforementioned embodiments is not repeatedly explained. With reference to FIG. 44, an apply valve (APP. V) and the switching valve 211 are newly provided. The apply valve (APP. V) is provided at the upstream of the supply port of the linear solenoid valves SL3 and SL4 and the switching valve 211 is activated by the electromagnetic valve. If the output oil pressure of the linear solenoid valve SL2 becomes equal to or more than a predetermined value, the apply valve (APP. V) interrupts the supply pressure (D pressure) of the linear solenoid valves SL3 and SL4 so that the supply pressure is transmitted to the exhaust port.

If the ON-failure occurs to the linear solenoid valve SL2 because of the disconnection-state, or the like, under the second shift stage of the first to second automatic shift mode at the D-range, in which the clutch C1 (SL1) and the brake B1 (SL4) are engaged, the interlock may be generated by means of an engagement of the clutch C1 (SL1), brake B1 (SL4), and the brake B2 (SL2). However, according to the fourth embodiment of the present invention, if the output pressure of the linear solenoid valve SL2 becomes equal to or more than the predetermined value, the apply valve is switched and the brake B1 (SL4) is forcibly released. Therefore, the vehicle can be driven at the first shift stage under the current shift pattern. Further, if the apply valve is stuck, the shift pattern can be shifted to the fixed shift mode by detecting the current state of the apply valve by means of the oil pressure switch SW, which is appropriately arranged. Therefore, the vehicle is not necessarily brought into the N-mode.

According to the fourth embodiment of the present invention, the oil pressure is supplied to the exhausted port of the linear solenoid valves SL1 and SL2 by the switching valve 211 so that the output pressure can forcibly be remained. By means of an ON/OFF operation of the switching valve 211, other solenoid valves such as SLT for controlling the throttle pressure which is not involved in the shift operation can appropriately be used. As well as the second embodiment of the present invention, when the output pressure of the electromagnetic valve reaches a predetermined failure range, the switching valve 211 is activated and supplies the oil pressure to the exhausted port of the linear solenoid valves SL1 and SL2.

According to the fourth embodiment of the present invention, because the linear solenoid valve SL2 is used only at the D-range, the linear solenoid valve SL2 supplies the D pressure. The linear solenoid valve SL1 supplies the D pressure for forward driving and sullies R pressure for reverse driving through the switching circuit of the shift valve SV2 in order to selecting the clutch C3. Accordingly, if the OFF-failure occurs to the linear solenoid valve SL1 or SL2 at each fixed shift mode, the shift stage can be remained by operating the switching valve 211. The oil pressure control apparatus according to the fourth embodiment of the present invention can be configured by adding two valves to the oil pressure control apparatus according to the third embodiment of the present invention. Therefore, the oil pressure control apparatus according to the fourth embodiment of the present invention has an advantage in manufacturing cost relative to the oil pressure control apparatus to which the oil pressure switch SW are added to appropriate positions (SL3, SL4, and SV3).

### Fifth Embodiment

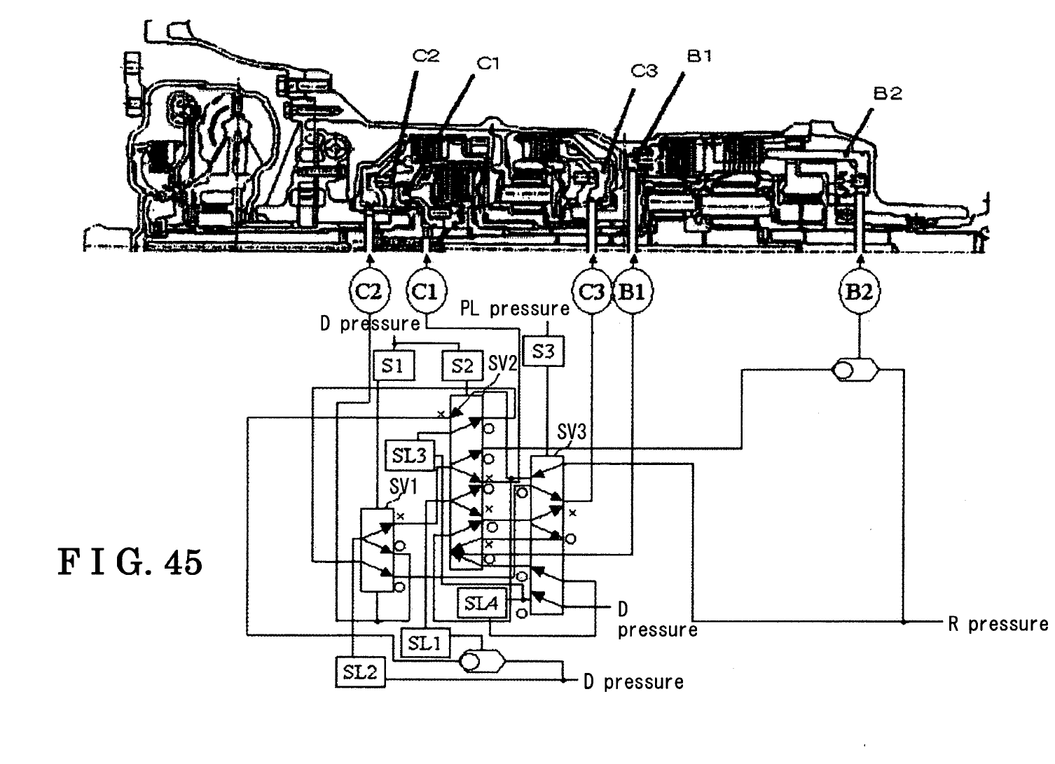

A fifth embodiment of the present invention will be explained hereinafter. In the fifth embodiment of the present invention, one of the six shift stages is always established even when all the linear solenoid valves are disconnected at each fixed shift mode. In FIG. 45, the drain (Ex) is omitted in view of simplification of the figure. However, if the oil pressure is interrupted at the shift valve SV, the Ex (drain) can appropriately be provided at the shift valve SV for draining the oil pressure as well as the first and second embodiments.

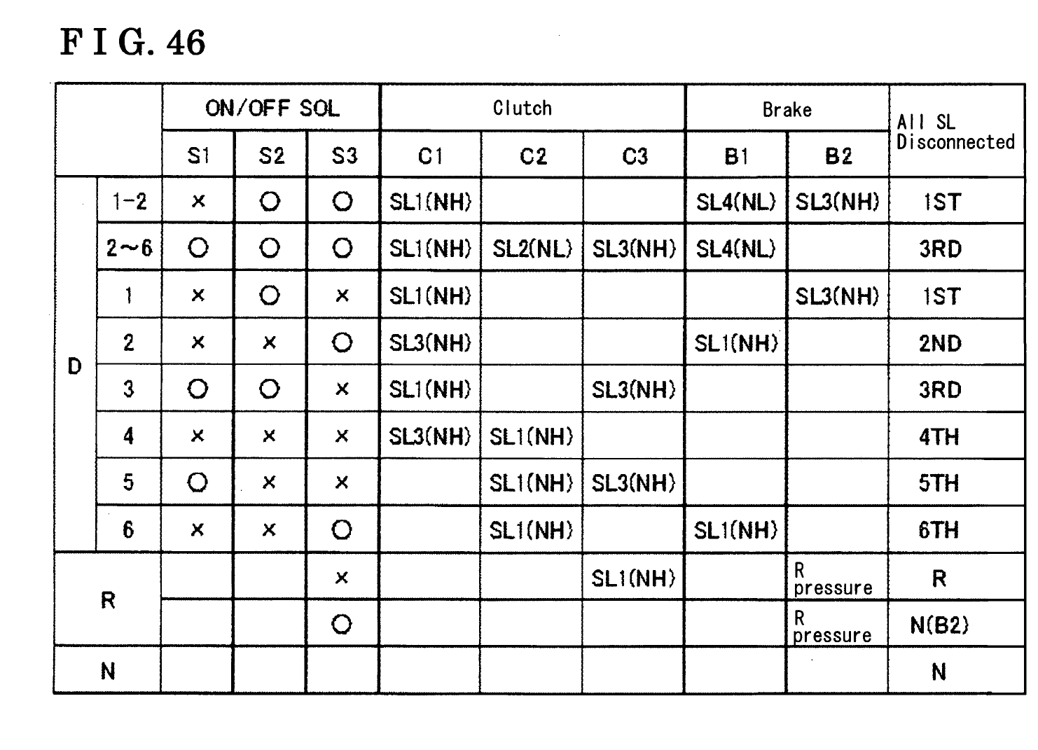

According to the fifth embodiment of the present invention, the switching circuits are added to the shift valves SV2 and SV3 of the third or fourth embodiment of the present invention as illustrated in FIGS. 45 and 46. More particularly, the output oil passage of the linear solenoid valve SL4 does not communicate with the brake B1 right after the shift valve SV3 but communicate with the brake B1 through the shift valve SV2. Further, the output oil passage of the linear solenoid valve SL1 can also communicate with the brake B1 through the shift valves SV3 and SV2. In consequence, the linear solenoid valve SL1 is assigned to a control of the brake B1 at the second fixed shift mode and the sixth fixed shift mode. As illustrated in FIG. 46, at every fixed shift mode, the current shift stage can be remained when all the linear solenoid valves are disconnected. Further, at the second through sixth automatic shift stage, the vehicle can be driven at the third shift stage when all the linear solenoid valves are disconnected.

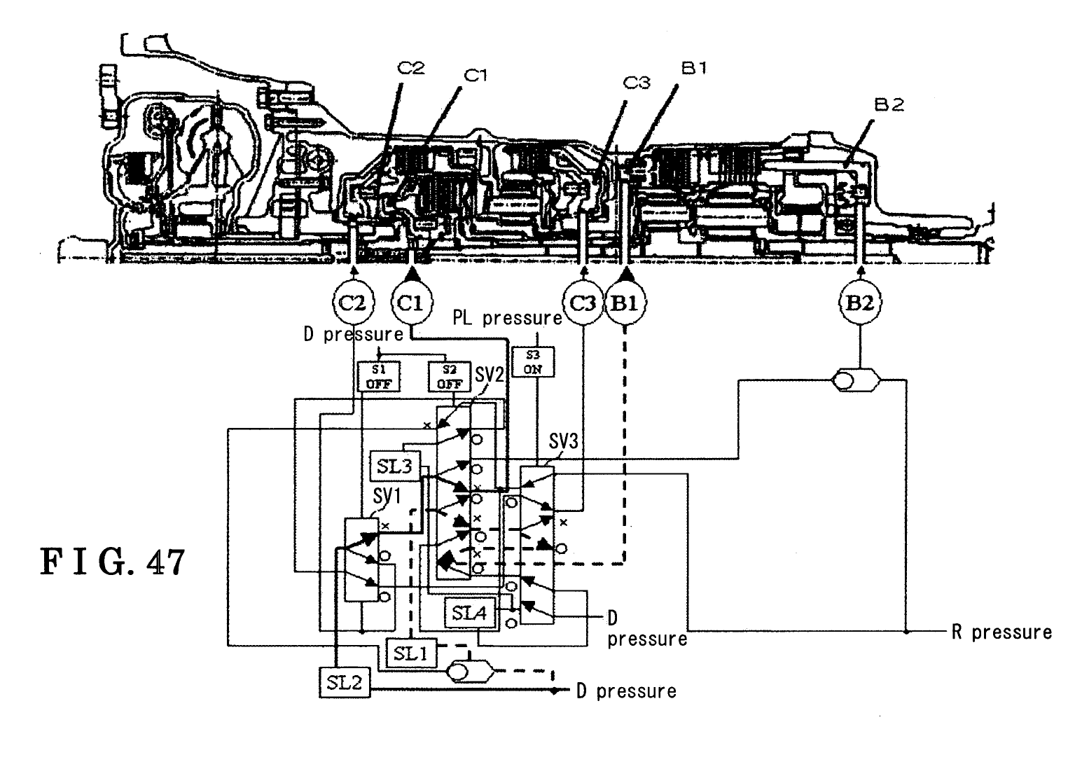

An operation of the oil pressure control apparatus according to the fifth embodiment of the present invention at the second fixed shift mode and the sixth fixed shift mode will be explained hereinafter. The same operation as described in the aforementioned embodiments is not repeatedly explained.

[D-range 2nd Fixed Shift Mode]
Under the second fixed shift mode at the D-range, the ON/OFF solenoid valves S1 and S2 are at the OFF-state (×) as illustrated in FIG. 47. Therefore, the output oil passage of the linear solenoid valve SL1 communicates with the brake B1 through the fourth bottom switching circuit of the shift valve SV2, the fourth top switching circuit of the shift valve SV3, and the second bottom switching circuit of the shift valve SV2. Further, the output oil passage of the linear solenoid valve SL2 communicates with the clutch C1 through the first top switching circuit of the shift valve SV1 and the fourth top switching circuit of the shift valve SV2.

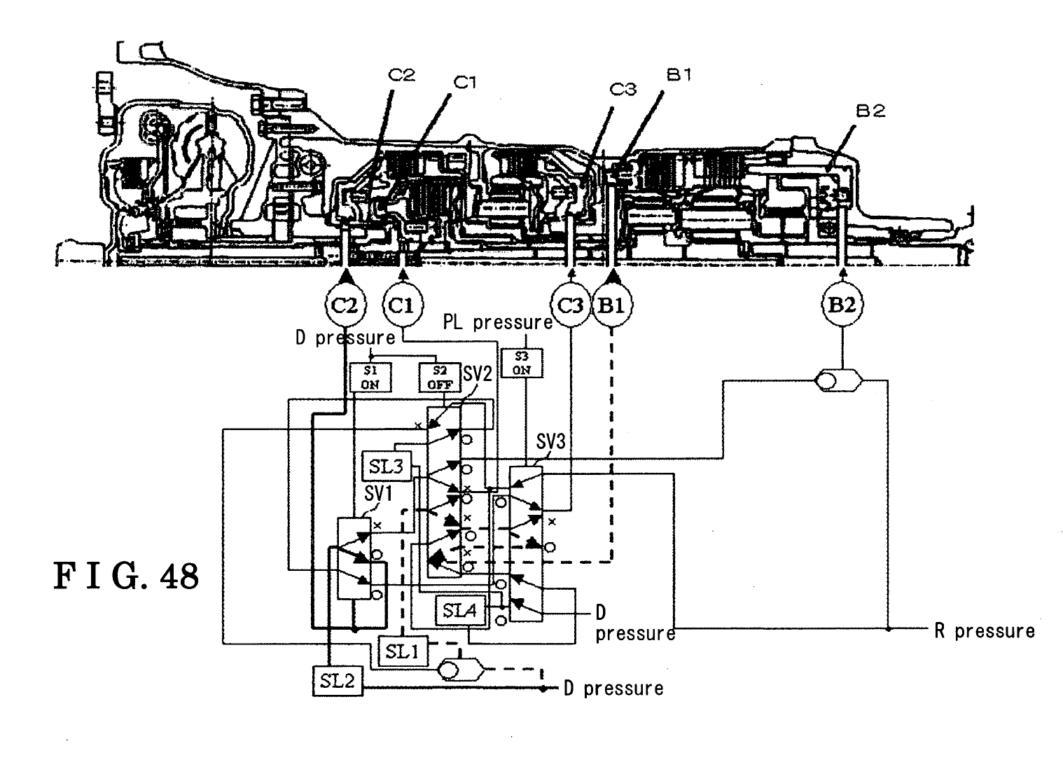

The output oil pressure of the linear solenoid valve SL3 is interrupted at the second top switching circuit of the shift valve SV2 and is not reached the clutch C3. Likewise, although the output oil passage of the linear solenoid valve SL4 communicates with the second bottom switching circuit of the shift valve SV3, the output oil pressure is interrupted at the first bottom switching circuit of the shift valve SV2 and is not reached the brake B1. Accordingly, the clutch C1 (SL2) and the brake B1 (SL1) are engaged and the second shift stage is established. Further, because the linear solenoid valves SL1 and SL2 are the NH type, the second shift stage is remained at the time of disconnection of all the linear solenoid valves.

[D-range 6th Fixed Shift Mode]
Under the sixth fixed shift mode at the D-range, the ON/OFF solenoid valves S1 and S3 are at the ON-state (∘) and the solenoid S2 is at the OFF-state (×) as illustrated in FIG. 48. Therefore, the output oil passage of the linear solenoid valve SL1 communicates with the brake B1 through the fourth bottom switching circuit of the shift valve SV2, the fourth top switching circuit of the shift valve SV3, and the second bottom switching circuit of the shift valve SV2. Further, the output oil pressure transmitted through the second top switching circuit of the shift valve SV1 latches the shift valve SV1 to the ON-side (∘) and is transmitted to the clutch C2.

The output oil passage of the linear solenoid valve SL3 is interrupted at the second top switching circuit of the shift valve SV2 and is not reached the clutch C3. Likewise, although the output oil passage of the linear solenoid valve SL4 communicates with the second bottom switching circuit of the shift valve SV3, the output oil pressure is interrupted at the first bottom switching circuit of the shift valve SV2 and is not reached the brake B1. Accordingly, the clutch C2 (SL2) and the brake B1 (SL1) are engaged and the sixth shift stage is established. Further, because the linear solenoid valves SL1 and SL2 are the NH type, the sixth shift stage is remained at the time of disconnection of all the linear solenoid valves.

### Sixth Embodiment

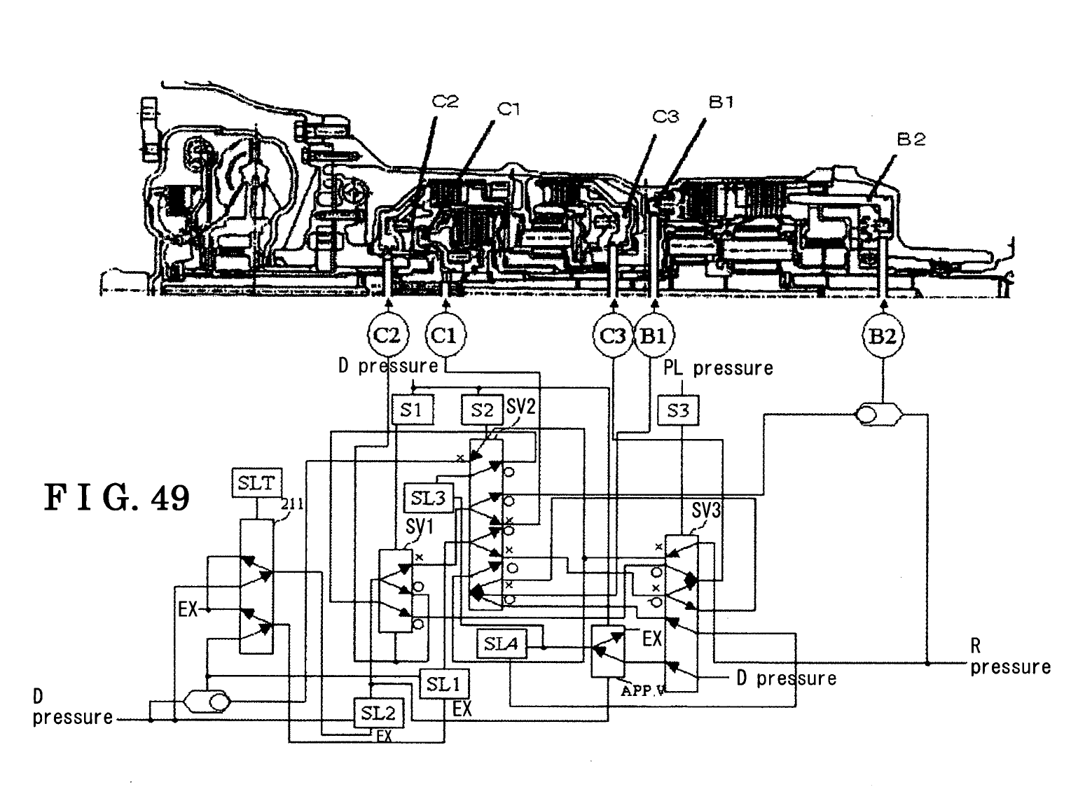

A sixth embodiment of the present invention will be explained hereinafter. The same structure as described in the aforementioned embodiments is not repeatedly explained. As well as the fourth and fifth embodiments of the present invention, the apply valve (APP. V) and the switching valve 211 are newly provided as illustrated in FIG. 49. The apply valve (APP. V) is provided at the upstream of the supply port of the linear solenoid valves SL3 and SL4. The same operation as described in the fourth embodiment of the present invention is not repeatedly explained. Alternatively or in addition, reliability of the oil pressure control apparatus can be improved by adding the oil pressure switch SW.

The embodiments of the present invention have been described in the foregoing specification. However the present invention is not limited thereto. An oil passage or control can be added to the aforementioned embodiments of the present invention. Alternatively or in addition, a lock-up may be performed by connecting the lock-up linear solenoid valve (not shown) only in a condition where the ON/OFF solenoid valve S3 is turned on after the shift pattern is switched to the first to second automatic shift mode. Thereby, even when the failure of the linear solenoid valve is generated at the first shift stage, sudden engine stall can be avoided.

According to the embodiments of the present invention, the oil pressure control apparatus is applicable for the automatic transmission having the five frictional engagement elements for the six forward shift stages. However, the present invention is not limited thereto and the oil pressure control apparatus may be applicable for other types of automatic transmission. According to the aforementioned embodiments of the present invention, the eight shift patterns using the three shift valves are respectively assigned to the two automatic shift modes, and each fixed shift mode. Alternatively, or in addition, if the automatic transmission includes only one automatic shift mode, the shift patterns may respectively be assigned to the one automatic shift mode, each fixed shift mode, and a backup shift mode.

In order to perform the skip shift operation among more than seven shift stages, the number of the linear solenoids for activating each frictional engagement element may be increased. The present invention is applicable for the automatic transmission capable of the skip shift operation among more than seven shift stages and the reliability of the failure-safe mechanism can be improved by increasing the shift patterns by increasing the number of the shift valves.

### Sixth Embodiment

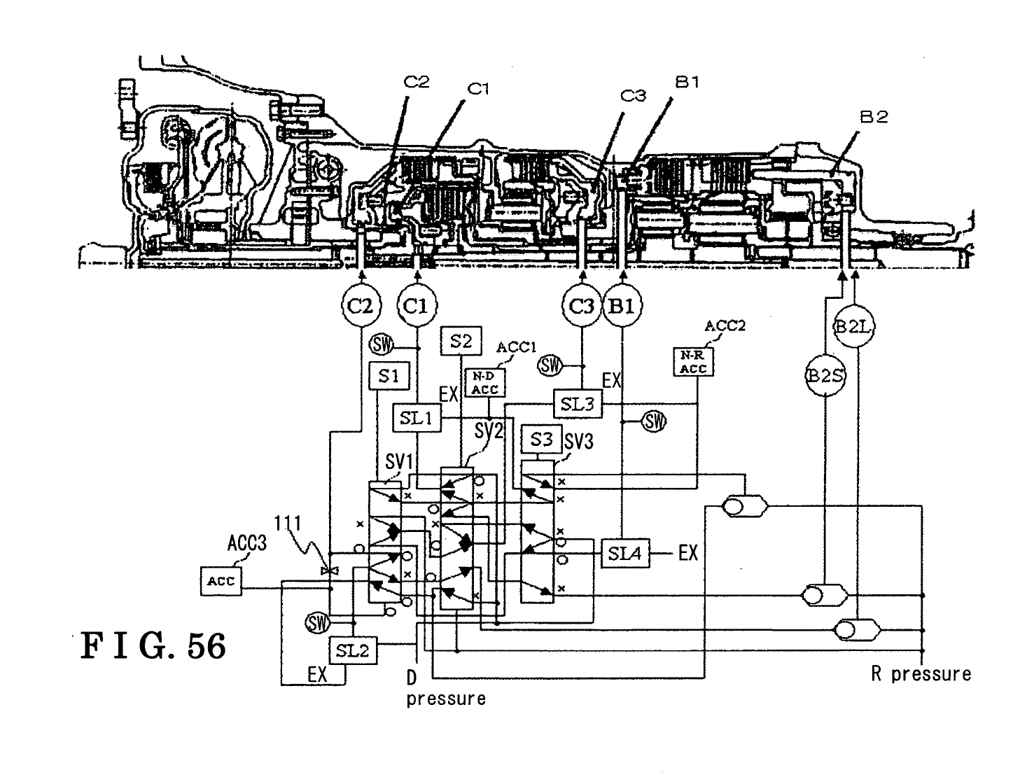

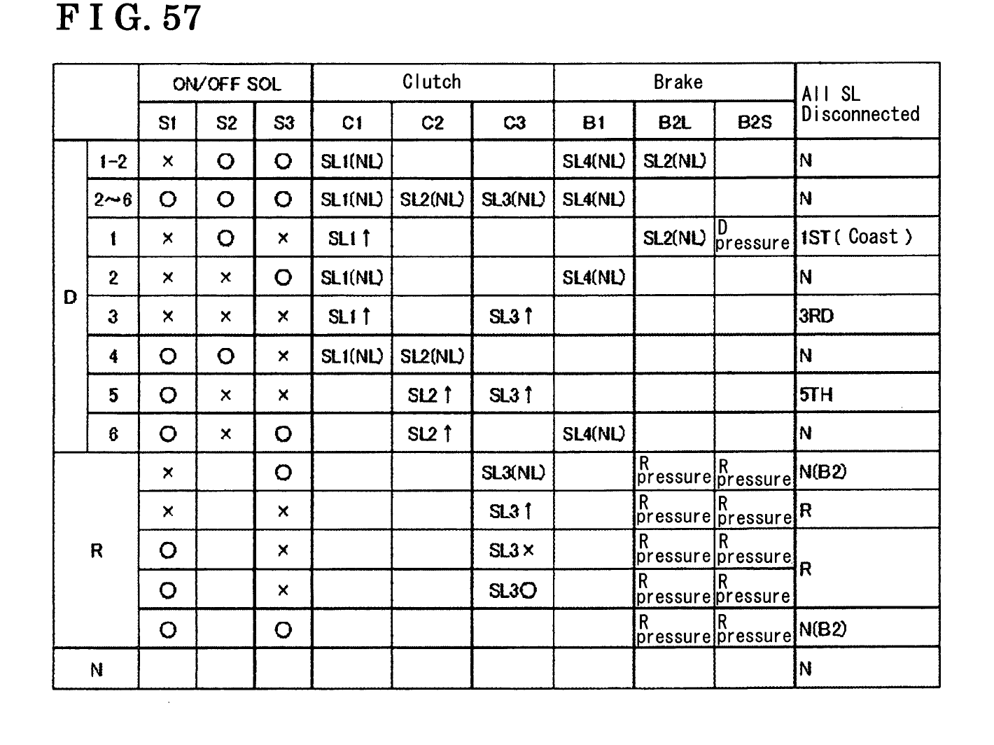

As is illustrated in FIG. 56, an oil pressure control apparatus for an automatic transmission according to a sixth embodiment of the present invention includes: an ECU (Electronic Control Unit, not illustrated); three shift valves, which are denoted with SV1, SV2 and SV3 hereinafter; and solenoid valves, which are denoted with S1, S2 and S3 hereinafter. The solenoid valves S1, S2 and S3 are controlled to switch on and off the shift valves SV1, SV2 and SV3, respectively. With reference to a D-ranged in FIG. 57, eight shift patterns, which are prescribed by the third power of two (2³), are configurable by means of operations of the solenoid valves S1, S2, S3. Two from among the eight shift patters are assigned to a multiple shift pattern (a first automatic shift pattern), in which a skip shift can be achieved, and to a lower shift pattern (a second automatic shift pattern), in which low shift stages, such as a first shift stage and a second shift stage, are selectively established. The other six of the eight shift patterns are assigned to fixed shift stages. A skip shift is implemented for example by changing a shift'stage from a first shift stage to a third shift stage or the other way around.

The automatic transmission illustrated in FIG. 56 can establish, therein, six shift stages in combination of five frictional engagement elements C1, C2, C3, B1 and B2. According to the oil pressure control apparatus for this automatic transmission, under the low shift stage shift pattern, three (SL1, SL2, SL4) of the four linear solenoid valves SL1, SL2, SL3 and SL4 can be controlled so as to attain a shift change from the first shift stage to the second shift stage and the other way around. These manipulations of the linear solenoid valves SL1, SL2 and SL4 are explained by the automatic shift pattern 1-2 at the D-range of FIG. 57. Under the first automatic shift pattern in which a skip shift can be implemented, all of the linear solenoid valves SL1, SL2, SL3 and SL4 are controlled so as to perform a shift change from among a second shift stage (2nd), a third shift stage (3rd), a fourth shift stage (4th), a fifth shift stage (5th) and a sixth shift stage (6th). These manipulations of the linear solenoid valves are explained by the automatic shift pattern 2-6 at the D-range of FIG. 57. Under a fixed shift stage shift pattern of any one of 1st, 2nd, 3rd, 4th, 5th and 6th, two of the four linear solenoid valves SL1, SL2, SL3 and SL4 are automatically engaged for the purpose of establishing a corresponding fixed shift stage, as illustrated in the fixed shift stages 1, 2, 3, 4, 5 and 6 at the-D-range in FIG. 57.

As we can see from FIG. 56, the linear solenoid valves SL2 is manipulated so as to selectively engage and disengage both the clutch C2 and the brake B2. Oil passages of the linear solenoid valve SL2 are selected by the shift valve SV1. Meanwhile, the other linear solenoid valves SL1, SL3 and SL4 are exclusively manipulated for controlling the clutch C1, the clutch C3 and the brake B1, respectively. Therefore, oil passages, which each extend between each linear solenoid valve SL1, SL3, SL4 and the corresponding frictional engagement element, are short.

According to the sixth embodiment of the present invention, the brake B2 includes a brake B2S, which possesses a small oil chamber of which volume varies in response to an operation of a piston, and a brake B2L, which possesses a large oil chamber of which volume varies in response to an operation of a piston. This structure is employed under a garage controlling, and yet, when a single piston type brake is required, an oil passage to the brake B2S can be omitted.

An upward arrow t in FIG. 57 explains that an oil pressure from a manual valve is directly supplied to each clutch C1, C2 and C3 and urges to engage each clutch C1, C2 and C3, regardless of an operation of each linear solenoid valve SL1, SL2 and SL3. For example, when a fixed shift stage 1st or 3rd, in which the solenoid valves S1 and S3 are at the OFF-state (×), is selected, a forward pressure (D pressure) is compulsorily supplied to an exhaust port of the linear solenoid valve SL1, and an output pressure of the linear solenoid valve SL1 is controlled at a D pressure level so as to establish an oil passage for engaging the clutch C1. Likewise, when a fixed shift stage 5th or 6th, in which the solenoid valve S1 is at the ON-state (∘) and the solenoid valve S2 is at the OFF-state (×), is selected, the forward pressure (D pressure) is compulsorily supplied to an exhaust port of the linear solenoid valve SL2, and an output pressure of the linear solenoid valve SL2 is controlled at a D pressure level so as to establish an oil passage for engaging the clutch C2. Still likewise, when a fixed shift stage 3rd or 5th, in which the solenoid valves S2 and S3 are at the OFF-state (×), is selected, the forward pressure (D pressure) is compulsorily supplied to an exhaust port of the linear solenoid valve SL3, and an output pressure of the linear solenoid valve SL3 is controlled at a D pressure level so as to establish an oil passage for engaging the clutch C3.

According to this embodiment, in response to an ON operation of the solenoid valve S1, a shift pattern out of the multi shift pattern for a skip shift, the fixed shift stages of 4th, 5th and 6th can be selectively established in the transmission. In response to an OFF operation of the solenoid valve S1, other lower speed shift stage can be selectively established. Further, as described later, the shift valve SV1 is latched into an ON-side by use of an oil pressure to be supplied to the clutch C2. Therefore, even if the solenoid valve S1 malfunctions, a sudden speed reduction from a high shift stage to a low shift stage can be prevented.

As described above, the aforementioned linear solenoid valves SL1, SL2, SL3 and SL4 are all normal low-type linear solenoid valves. As described later, in case of all the linear solenoid valves being disconnected, a fixed shift stage can be established by selecting a shift valve. It is therefore possible to prevent an occurrence that an engagement element is not engaged because of a primary failure such as all disconnection. It is further possible to preclude an interlocking due to an ON-failure of a linear solenoid valve. Meanwhile, in a case of all valves including the shift valves being electrically disconnected, the solenoid valves S1, S2 and S3 are all switched off, and a fixed shift stage 3rd can be established in the transmission without operating any linear solenoid valves.

Going back to FIG. 56, an orifice 111 is positioned on a latch circuit communicating with an end of the shift valve SV1, and an accumulator ACC3 is connected to the latch circuit. Therefore, when all disconnection occurs during a driving at a high-shift stage, the shift valves SV2 is switched off prior to an operation of the shift valve SV1, and the solenoid valve S1 is maintained at an ON-state and the solenoid valves S2 and S3 are maintained at an OFF-state, wherein a vehicle can travel at the fixed shift stage 5th established in the transmission. As a result, plural change valves, which are intended for an OFF-failure as disclosed in the reference 5, are no longer needed.

Under a shift pattern of the fixed shift stage 1st, the clutch C1 is directly supplied with a line pressure. Therefore, even when a pressure level, which exceeds the maximum output pressure level of a linear solenoid valve, is needed, for example, at a time of a stall-starting, there is no need to provide a lock valve for introducing the line pressure, a gain switching valve and so on, which leads to a simple oil pass configuration and a manufacturing cost reduction.

Under the 1st fixed shift pattern, an oil passage is established, through which a D pressure is introduced from a first top switching circuit of the shift valve SV1 to a shuttle valve connected to the brake B2S via switching circuits of the shift valves SV2 and SV3. Therefore, the D pressure is supplied to the brake B2S, and the linear solenoid valve SL2 is connected to the brake B2L having a large area. While recent developments is leading to a torque-up in response to an increase in the number of shift stages in the transmission, a manufacturing cost reduction, and a downsizing of the transmission has been needed. According to the above structure, a 1-2 one-way clutch (O.W.C) is hence no longer needed for the transmission, which satisfies recent need. That is, even in a case where the linear solenoid valve SL2 is at an OFF-failure, it is possible to perform a vehicle start at the first shift stage by use of the clutch C1 and the brake B2S, and it is further possible to perform a coast control.

As is illustrated in FIG. 56, accumulators ACC1 and ACC2 are respectively provided at oil passages at the side of exhaust ports of the linear solenoid valves SL1 and SL3. The ACC1 works so as to establish a shift operation from an N range to a D-range the other way around, while the ACC2 works so as to establish a shift operation from the N range to an R range the other way around. Therefore, by delaying an oil pressure supply from the manual valve to the linear solenoid valves SL1 and SL3 for a predetermined period of time, the shift operation from N to D and the shift operation from N to R can be achieved respectively without an occurrence of a shift shock due to a direct introduction of a liner pressure. For example, a garage shift operation can be achieved in response to a change from the N range to the D-range and controlling the solenoid valves S1, S2 and S3 at the OFF-, ON-, and OFF-states (×∘×). Further, by controlling the solenoid valves S1, S2 and S3 respectively at the OFF-, ON- and ON-states (×∘∘), an automatic shift operation, in which the pressure of the clutch C1 is controlled by the output pressure of the linear solenoid valve SL1, is achieved. Likewise, the garage shift operation is achieved in response to a change from the N range to the R-range and controlling the solenoid valves S1, S2 and S3 at the OFF-, not-determined-, and OFF-states (×-×).

According to the above-described oil passage configuration, an oil passage, through which the R pressure is guided to a switching circuit of the shift valve SV1, and an oil passage, by which the R pressure is compulsorily urged to the shift valve SV2 and the shift valve SV2 is turned on (∘), are provided. Therefore, even if the shift valve SV1 is at the OFF-state (×), as far as the R pressure has been supplied to the shift valve SV1, the shift valve SV2 is turned on (∘) and the linear solenoid valve SL3 can engage the clutch C3 for the use of a reverse shift stage.

As described above, according to the sixth embodiment of the present invention, an oil passage length between each frictional engagement element and each solenoid valve (linear solenoid valve) can be shortened, and the solenoid valves (linear solenoid valves) can be located at appropriate positions for the positions of the frictional engagement elements in the automatic transmission.

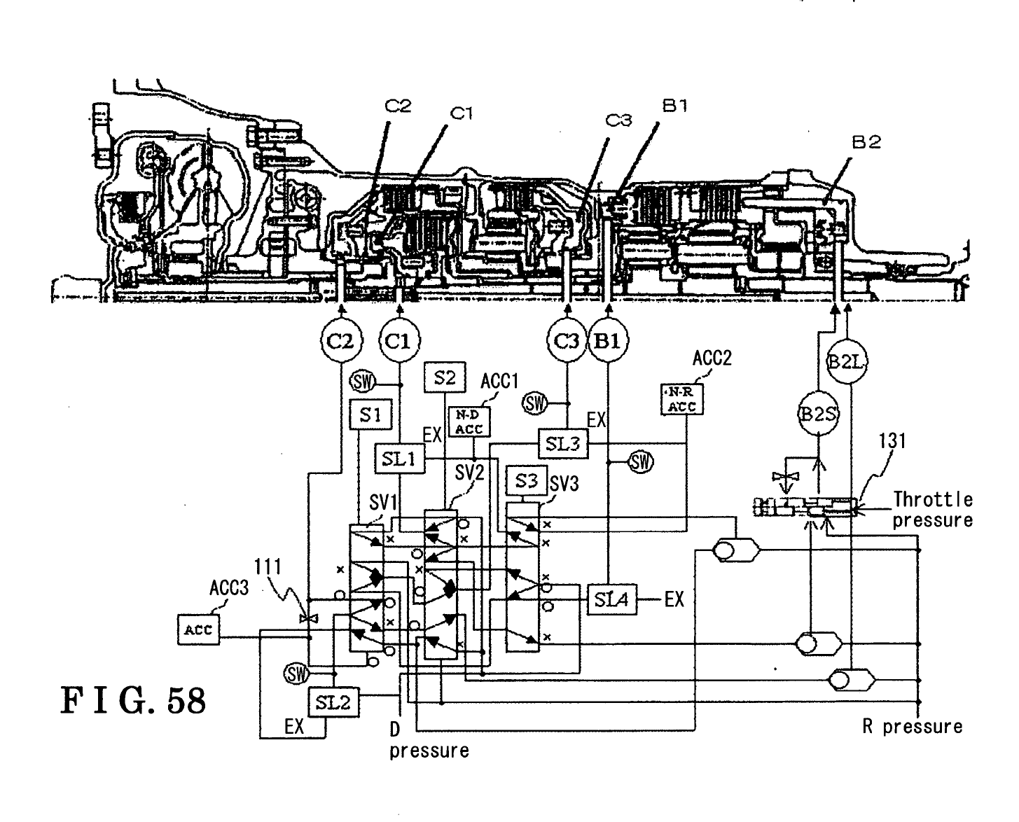

According to an example of an entire oil circuit illustrated in FIG. 56, assuming that the piston area of the brake B2 has been divided appropriately, the D pressure is directly supplied to the brake B2S. However, the cross section of a piston is on occasions too complex to divide the piston area appropriately, and a coast control occasionally needs to be achieved by use of a vehicle or an engine. In such circumstances, as illustrated in FIG. 58, a brake control valve (pressure reducing valve) 131 can be provided between the brake B2S and the shuttle valve. In this case, when a reverse range (R range) is selected, the R pressure enters into a spring chamber of the brake control valve 131, and a spool inside of the brake control valve 131 is shifted to the left side in FIG. 58. The R pressure is then transmitted from the supply port of the brake control valve 131 to the output port thereof via the shuttle valve. The R pressure is then supplied to the brake B2S. On the other hand, when the 1st fixed shift stage is selected, the D pressure, which traveled through the shift valves SV1, SV2, SV3, is guided to the supply port of the brake control valve 131 via the shuttle valve is supplied to an input port of the brake control valve 131 via the shift valves SV1, SV2 and SV3 and the shuttle valve. In this case, if a throttle pressure is controlled to encourage a spring force of the brake control valve 131, the brake B2S is controlled by reducing the D pressure in proportion to the throttle pressure.

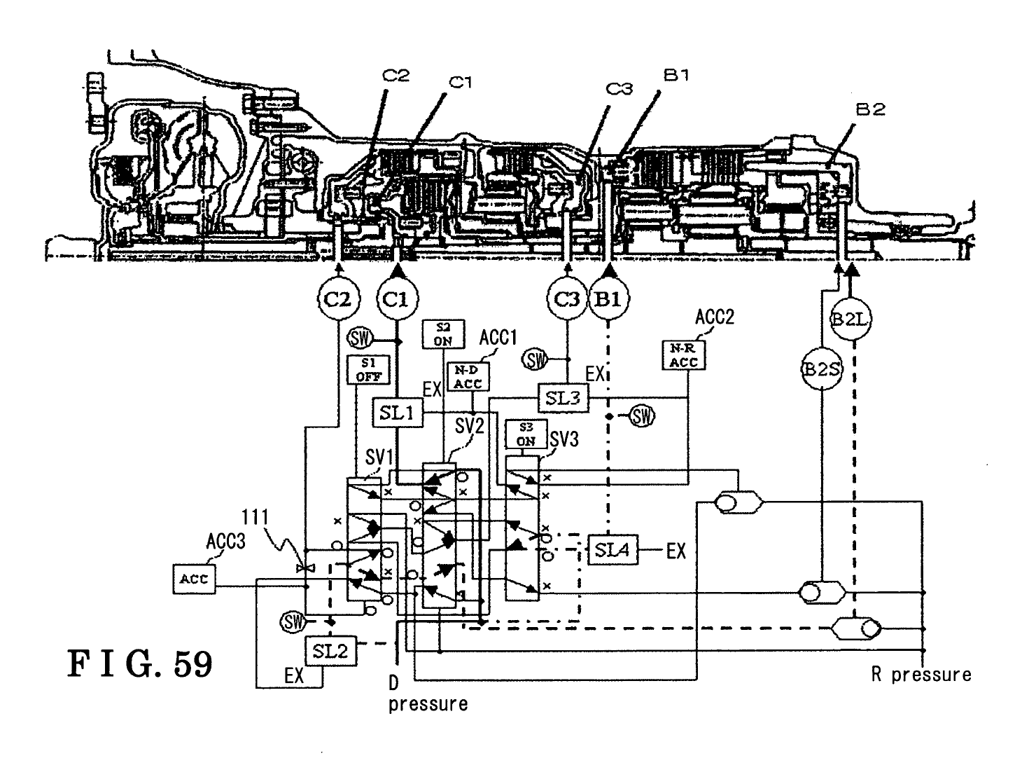

Next, described below is an operation at a time of selecting each shift pattern according to the sixth embodiment.

[D-range 1-2 Shift Mode]
Under the 1-2 shift mode at the D-range, as illustrated in FIG. 59, the D pressure from the manual valve (not illustrated) is normally supplied to the supply port of the linear solenoid valve SL2. Because the solenoid valve S3 is at the ON-state (∘), the D pressure is supplied to the supply port of the linear solenoid valve SL4 via the second bottom switching circuit of the shift valve SV3. Further, because the solenoid valve S2 is at ON-state (∘), the D pressure is also supplied to the supply port of the linear solenoid valve SL1 via a first top switching circuit of the shift valve SV2.

Meanwhile, although there is an oil passage guiding the D pressure to the shift valve SV1 via a second bottom switching circuit of the shift valve SV3, because the shift valve SV1 is at an OFF-state (×), the D pressure is not supplied to the supply port of the linear solenoid valve SL3. The D pressure, which is to be supplied through the first top switching circuit of the shift valve SV1, is cut off by the shift valves SV2 and SV3, so that the D pressure is not supplied to the brake B2S and the exhaust port of the linear solenoid valve SL1. The output oil passage of the linear solenoid valve SL2 communicates with the brake B2L via a second bottom switching circuit of the shift valve SV1, a second bottom switching circuit of the shift valve SV2, and a shuttle valve (a check-ball valve).

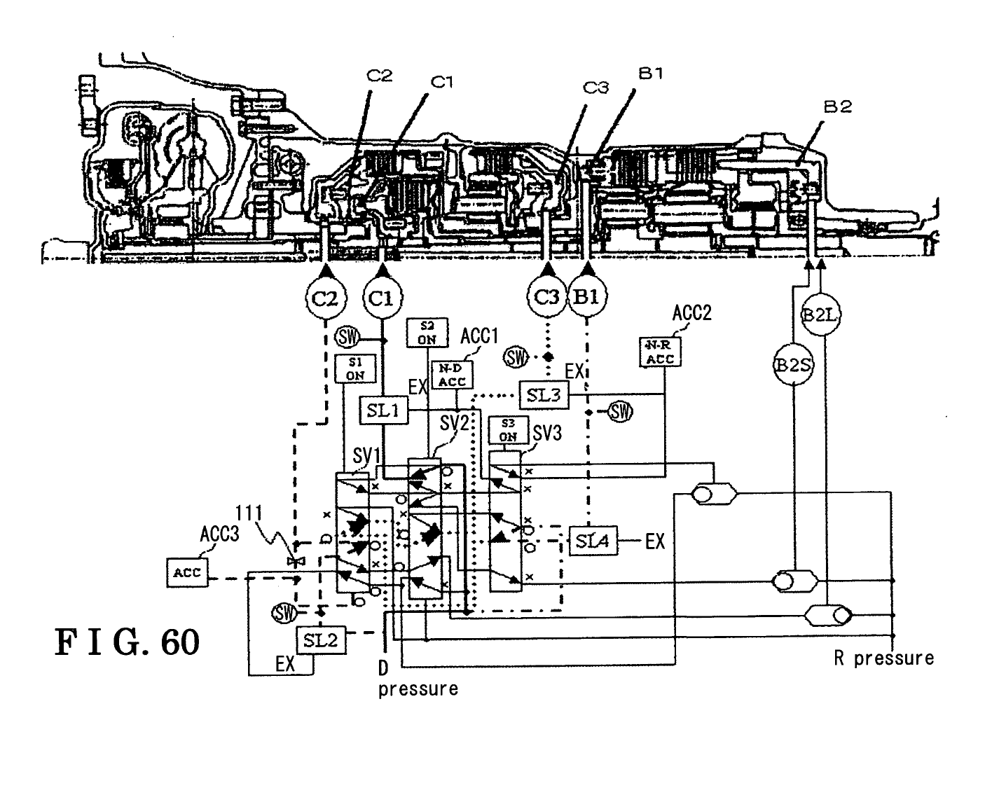

As described above, the clutch C1 (the linear solenoid valve SL1), the brake B1 (the linear solenoid valve SL4) and the brake B2L (the linear solenoid valve SL2) can be controlled, and a lower shift stage automatic shift operation between the first shift stage with the clutch C1 (SL1) and the second shift stage with the brake B1 (the SL4) and the second shift stage with the brake B1 (SL4) can be executed.

[D-range 2-6 Automatic Shift Mode]
Under the 2-6 automatic shift mode at the D-range, as illustrated in FIG. 60, the D pressure from the manual valve (not illustrated) normally communicates with the supply port of the linear solenoid valve SL2. Because the solenoid valve S1 is at the ON-state (∘), the output oil pressure of the linear solenoid valve SL2 is first fed to a third bottom switching circuit of the shift valve SV1, so that the shift valve SV1 is latched to an ON-side (∘) and the clutch C2 is supplied with the output oil pressure of the linear solenoid valve SL2. Further, because the solenoid valve S3 is at the ON-state (∘), the D pressure is supplied to a supply port of the linear solenoid valve SL4 via the second bottom switching circuit of the shift valve SV3. Still further, because the solenoid valve S2 is at the ON-state (∘), the D pressure is supplied to the supply port of the linear solenoid valve SL1 via the first top switching circuit of the shift valve SV2. The D pressure is supplied to a supply port of the linear solenoid valve SL3 via a fourth bottom switching circuit of the shift valve SV1 and the third bottom switching circuit of the shift valve SV2.

Meanwhile, although there is an oil passage for guiding the D pressure to the first top switching circuit of the shift valve SV1, this oil passage is cut off by the shift valve SV1 being at the ON-state (∘). Therefore, the D pressure does not reach the brake B2S and the exhaust port of the linear solenoid valve SL1.

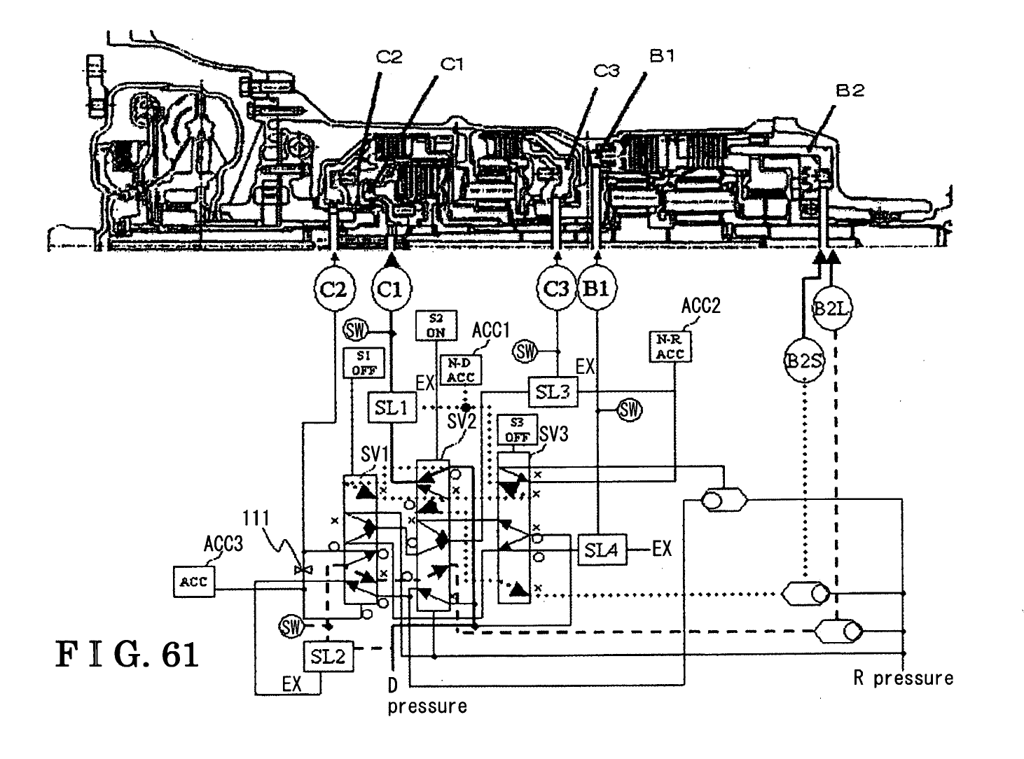

As described above, the clutch C1 (SL1), the clutch C2 (SL2), the clutch C3 (SL3) and the brake B1 (SL4) can be controlled, and a middle shift stage automatic shift pattern, in which a skip shift can be performed, can be executed.
2nd shift stage: C1 (SL1), B1 (SL4);
3rd shift stage: C1 (SL1), C3 (SL3);
4th shift stage: C1 (SL1), C2 (SL2);
5th shift stage: C2 (SL2), C3 (SL3);
6th shift stage: C2 (SL2), B1 (SL4);

[D-range 1st Fixed Shift Mode]
Under the 1st fixed shift mode at the D-range, as illustrated in FIG. 61, the solenoid valve S1 is at the OFF-state (×), the solenoid valve S2 is at the ON-state (∘), and the solenoid valve S3 is at the OFF-state (×). Therefore, the output oil pressure of the linear solenoid valve SL2 is supplied to the brake B2L via the second bottom switching circuit of the shift valve SV1, the second bottom switching circuit of the shift valve SV2 and the shuttle valve. Further, the D pressure is supplied to the supply port of the linear solenoid valve SL1 via the first top switching circuit of the shift valve SV2, and the D pressure is also supplied to the exhaust port of the linear solenoid valve SL1 and the accumulator ACC1 (N-D ACC) via the first top switching circuit of the shift valve SV1 and the second top switching circuit of the shift valve SV3. As a result, the D pressure is supplied to the clutch C1. The D pressure, which traveled through the first top switching circuit of the shift valve SV1, also reaches the brake B2S via the third top switching circuit of the shift valve SV2, the first bottom switching circuit of the shift valve SV3 and the shuttle valve.

Meanwhile, because the solenoid valve S3 is at the OFF-state (×), the second bottom switching circuit of the shift valve SV3 does not allow a further flow of the D pressure so that the D pressure does not reach the supply port of the linear solenoid valve SL4. Likewise, the D pressure, which traveled through the third top switching circuit of the shift valve SV3, is not allowed to further flow by a fourth bottom switching circuit of the shift valve SV2, and does not reach the supply port of the linear solenoid valve SL3.

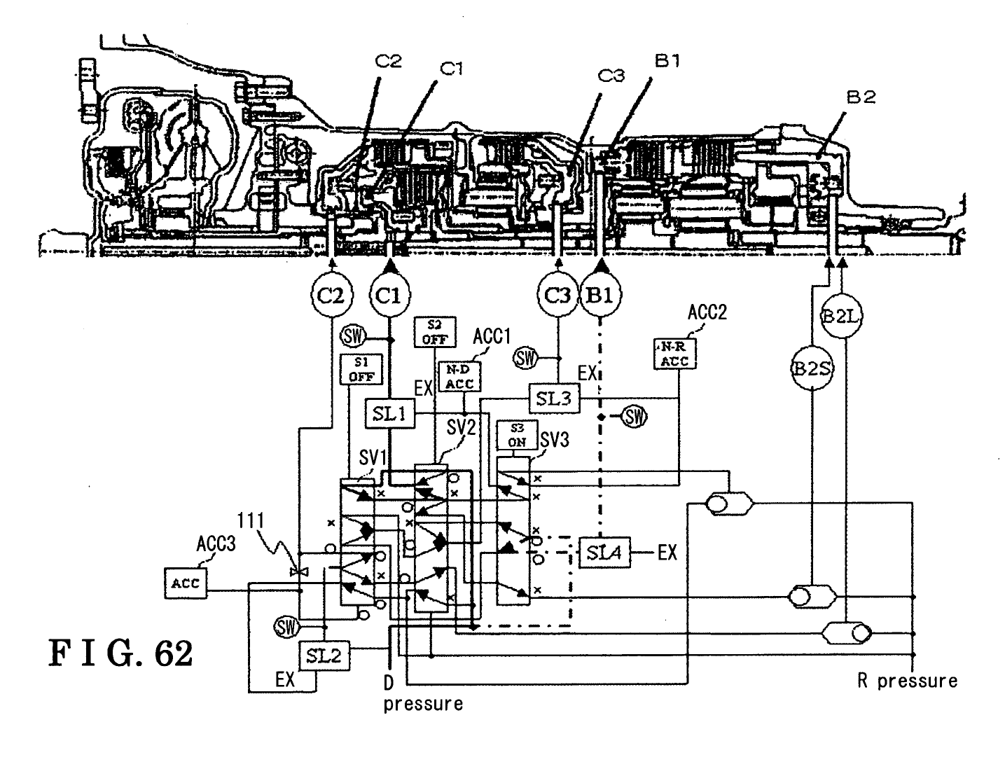

As described above, the clutch C1 (D pressure), the brake B2S (D pressure) and the brake B2L (SL2) are engaged, and the first shift stage is established in the automatic transmission. Here, even in a case where the linear solenoid valve SL2 for operating the brake B2L is brought to an OFF-failure state, a coast control with the brake B2S can be manipulated, and even if a stall-starting is difficult to be carried out, a driving at the first shift stage can be implemented.

[D-range 2nd Fixed Shift Mode]
Under the second fixed shift mode at the D-range, as illustrated in FIG. 62, the solenoid valves S1 and S2 are at the OFF-state (×). Therefore, although the output oil passage of the linear solenoid valve SL2 travels through the second bottom switching circuit of the shift valve SV1, this output oil passage is cut off by the second bottom switching circuit of the shift valve SV2. As a result, the output oil passage of the linear solenoid valve SL2 communicates with neither the brake B2L nor the clutch C2. The solenoid valve S3 is at the ON-state (∘). Therefore, the D pressure is supplied to the supply port of the linear solenoid valve SL4 via the second bottom switching circuit of the shift valve SV3. Likewise, the D pressure is supplied to the supply port of the linear solenoid valve SL1 via the first top switching circuit of the shift valve SV1 and the second top switching circuit of the shift valve SV2.

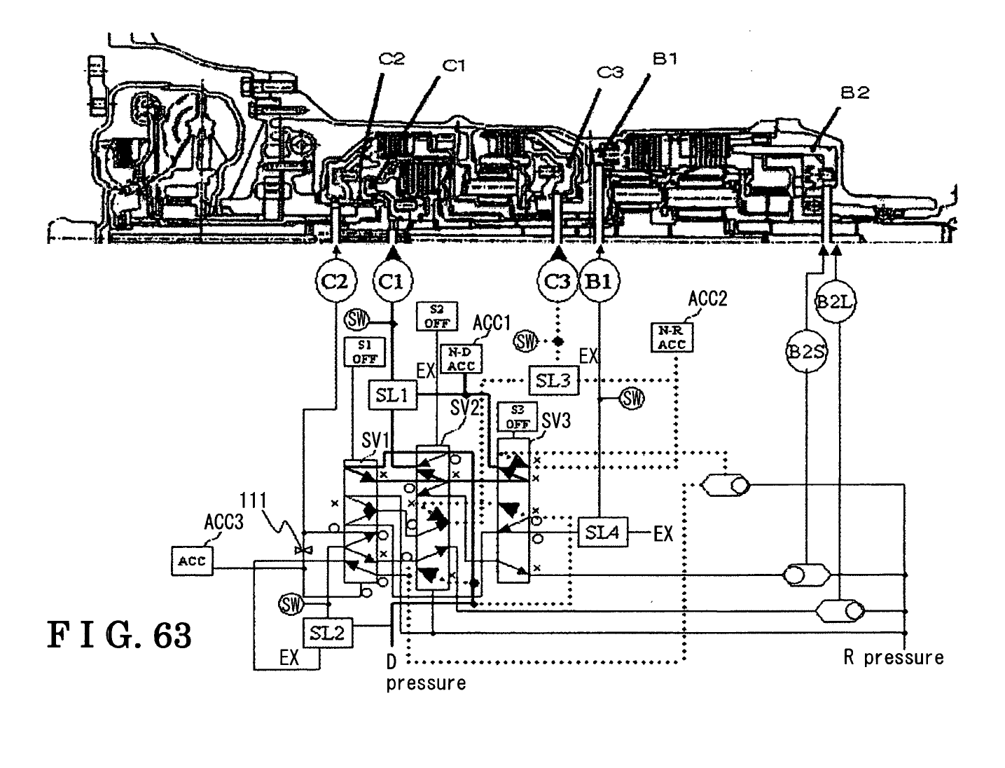

Meanwhile, the D pressure, which travels through the second bottom switching circuit of the shift valve SV3, is cut by the third top switching circuit of the shift valve SV1 so that the supply port of the linear solenoid valve SL3 is not supplied with the D pressure. Likewise, the D pressure, which traveled through the first top switching circuit of the shift valve SV1, reaches the second top switching circuit of the shift valve SV3. However, the D pressure is cut off by the second top switching circuit of the shift valve SV3 and is not supplied to the exhaust port of the linear solenoid valve SL1 and the brake B2S. As described above, the clutch C1 (SL1) and the brake B1 (SL4) are engaged, and the second shift stage is established in the automatic transmission.

[D-range 3rd Fixed Shift Mode]
Under the third fixed shift mode at the D-range, as illustrated in FIG. 63, all the solenoid valves S1, S2 and S3 are disconnected, i.e., the solenoid valves S1, S2, S3 are at the OFF-state (×). Therefore, the output oil passage of the linear solenoid valve SL2 communicates with the second bottom switching circuit of the shift valve SV1. However, this oil passage is cut off by the second bottom switching circuit of the shift valve SV2 and reaches neither the brake B2L nor the clutch C2. The D pressure, which traveled through the third bottom switching circuit of the shift valve SV3 and the fourth top switching circuit of the shift valve SV2, is supplied to the supply port of the linear solenoid valve SL3. The D pressure, which traveled through the first bottom switching circuit SV2, the shuttle valve, the first top switching circuit of the SV3, reaches the exhaust port of the linear solenoid valve SL3 and the accumulator ACC2 (N-R ACC). The D pressure, which travels through the first top switching circuit of the shift valve SV1, is cut off by the third top switching circuit of the shift valve SV2 and does not reach the brake B2S. However, the D pressure, which travels through the second top switching circuit of the shift valve SV2, reaches the supply port of the linear solenoid valve SL1, while the D pressure, which travels through the second top switching circuit of the shift valve SV3, reaches not only the exhaust port of the linear solenoid valve SL1 and the accumulator ACC1 (N-D ACC). As a result, the D pressure is supplied to the clutches C1 and C3.

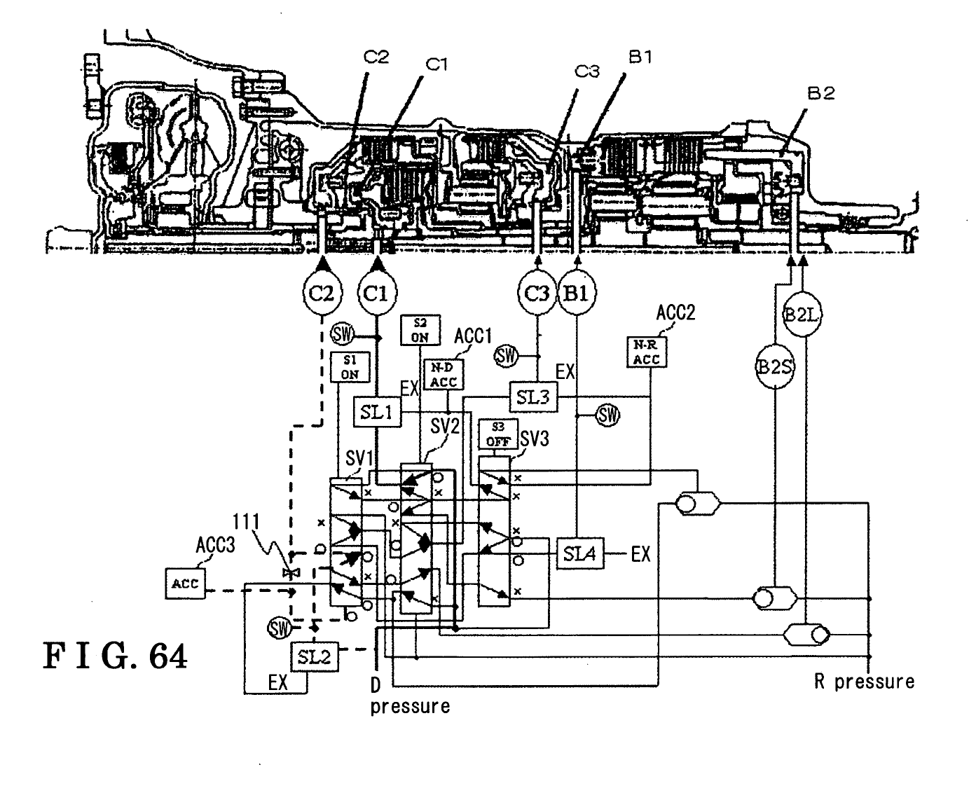

Further, the flow of the D pressure to a supply port of the linear solenoid valve SL4 is not allowed by the second bottom switching circuit of the shift valve SV3. As described above, the clutch C1 (D pressure) and the clutch C3 (linear solenoid valve SL3) are engaged and the third shift stage is established in the automatic transmission. Therefore, a vehicle can travel not only in the event that all the linear solenoid valves are electrically disconnected but also in the event that all the valves including the solenoid valves are electrically disconnected.

[D-range 4th Fixed Shift Mode]
Under the fourth fixed shift mode at the D-range, as illustrated in FIG. 64, the solenoid valves S1 and S2 are both at the ON-state (∘). Therefore, the output oil pressure of the linear solenoid valve SL2 is first fed to the third bottom switching circuit of the shift valve SV1, so that the shift valve SV1 is latched to the ON-side (∘) and the clutch C2 is supplied with the output oil pressure of the linear solenoid valve SL2. Further, the D pressure is supplied to the supply port of the linear solenoid valve SL1 via the first top switching circuit of the shift valve SV2. Meanwhile, the D pressure, which diverges at the near side of the first top switching circuit of the shift valve SV2, is cut off by the first top switching circuit of the shift valve SV1, and is not allowed to flow to the exhaust port of the linear solenoid valve SL1 and the brake B2S.

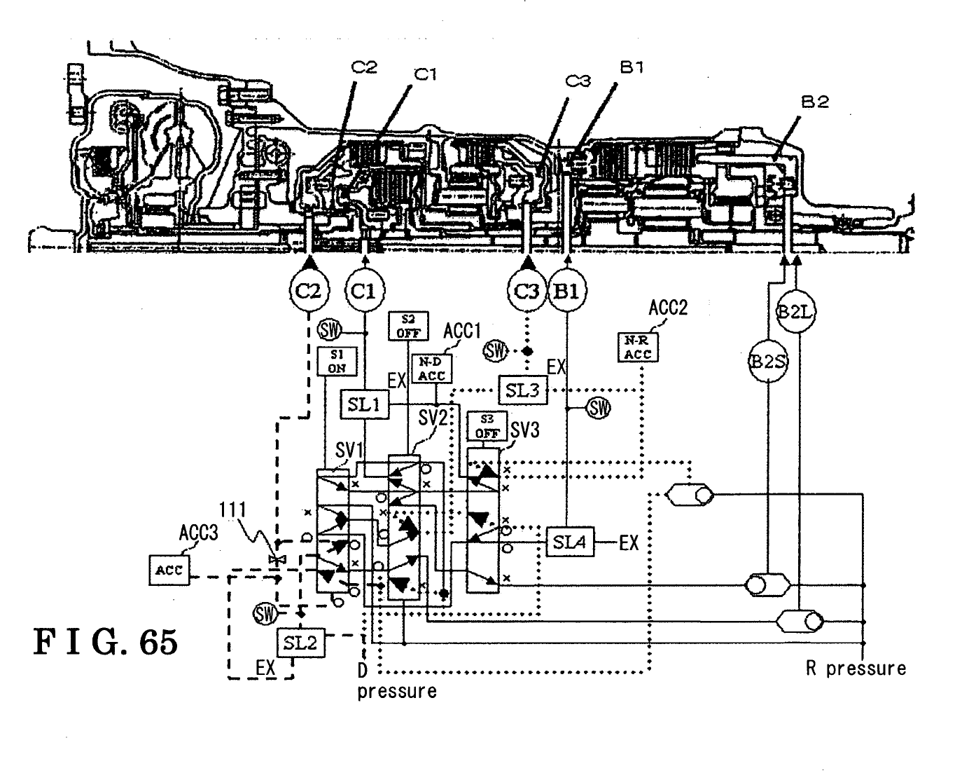

Further, because the solenoid valve S3 is at the OFF-state (×), the D pressure is cut off by the second bottom switching circuit of the shift valve SV3 and does not reach the supply port of the linear solenoid valve SL4. Still further, the D pressure, which travels through the third top switching circuit of the shift valve SV3, is cut off by the fourth bottom switching circuit of the shift valve SV2 and is not allowed to reach the supply port of the linear solenoid valve SL3. As described above, the clutch C1 (SL1) and the clutch C2 (SL2) are engaged, and the fourth shift stage is established in the automatic transmission.

[D-range 5th Fixed Shift Mode]
Under the fifth fixed shift mode at the D-range, as illustrated in FIG. 65, the solenoid valve S1 is at the ON-state (∘). Therefore, the output oil pressure of the linear solenoid valve SL2 travels through the third bottom switching circuit of the shift valve SV1, so that the shift valve SV1 is latched to the ON-side (∘) and the clutch C2 is supplied with the output oil pressure of the linear solenoid valve SL2. Meanwhile, the solenoid valves S2 and S3 are both at the OFF-state (×). Therefore, the D pressure, which traveled through the third bottom switching circuit of the shift valve SV3 and the fourth top switching circuit of the shift valve SV2, is supplied to the supply port of the linear solenoid valve SL3. The D pressure, which has traveled through the first bottom switching circuit of the shift valve SV2, the shuttle valve and the first top switching circuit of the shift valve SV3, reaches the exhaust port of the linear solenoid valve SL3 and the accumulator ACC2 (N-R ACC).

The D pressure is cut off by the second bottom switching circuit of the shift valve SV3, the first top switching circuit of the shift valve SV2 and the first top switching circuit of the shift valve SV1, respectively. The D pressure is hence not supplied to the supply port of the linear solenoid valve SL4, the supply port of the linear solenoid valve SL1, the brake B2S. Therefore, the fifth shift stage is established with the clutch C2 (SL1) and the clutch C3 (SL3) engaged. Therefore, even in the event where all the linear solenoid valves are electrically disconnected, a vehicle can move forward.

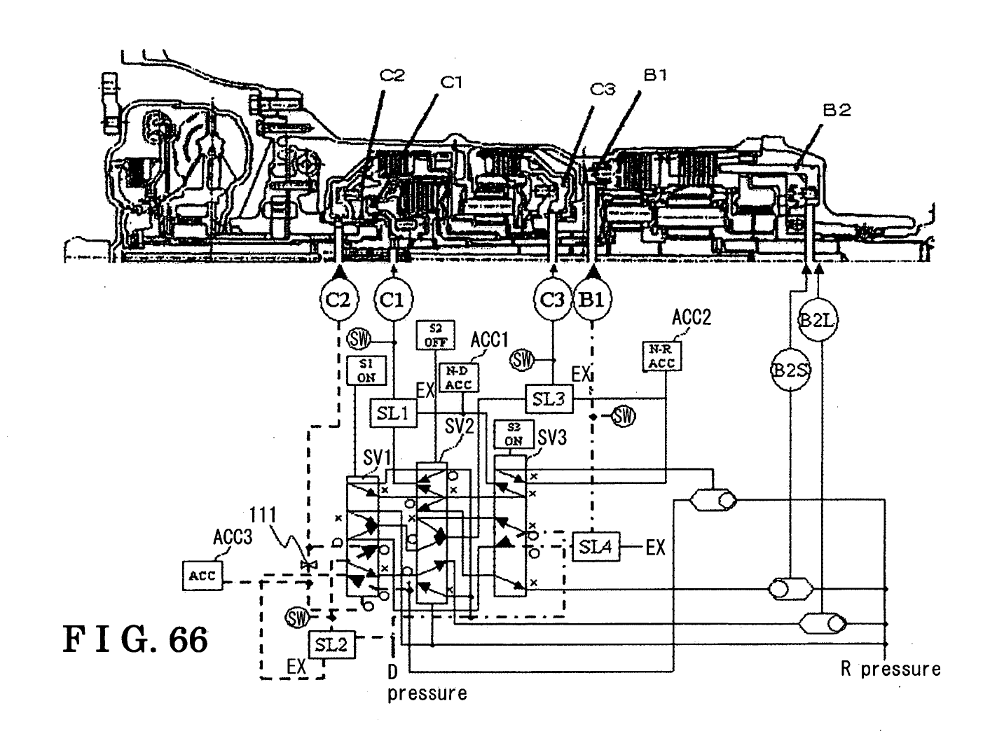

While a vehicle is traveling at a shift stage (including the sixth shift stage described later) being equal to or greater than the fourth shift stage, in which the clutch C2 is frictionally engaged, the accumulator ACC3, which is connected to the latch circuit, works for keeping the shift valve SV1 latched to the ON-side (∘). Therefore, in the case where all solenoid valves are electrically disconnected, even if the solenoid valve SV1 is switched from the ON-state (∘) to the OFF-state (×), the shift valve SV1 is kept latched at the ON-side (∘).
Therefore, the supply and exhaust ports of the linear solenoid valve SL2 is kept supplied with the D pressure, wherein the fifth shift stage is established in the transmission. That is, according to the sixth embodiment of the present invention, in the event of the all disconnection failure in a state where a vehicle is traveling at a shift stage being equal to or greater than the fourth shift stage under the automatic 2-6 shift mode, an actually selected shift stage is switched not to the fixed third shift mode but to the fixed fifth shift mode. Therefore, sudden speed reduction can be precluded. Further, when the pressure supplied to the clutch C2 is reduced in response to an operation of a shift lever from the D-range to one of the D-range, P-range and R-range or in response to an OFF-operation of an ignition key, for example at a time of parking a vehicle, the shift valve SV1 is released from being latched. Therefore, a vehicle can re-start at the third shift stage. Further, when the solenoid valve S2 can be switched to the ON-state (∘), a vehicle can start at the first shift stage.

[D-range 6th Fixed Shift Mode]
Under the sixth fixed shift mode at the D-range, as illustrated in FIG. 66, the solenoid valves S1 and S3 are at the ON-state (∘). Therefore, the output oil pressure of the linear solenoid valve SL2 travels through the third bottom switching circuit of the shift valve SV1. This output oil pressure acts for latching the shift valve SV1 to the ON-side (∘) and is supplied to the clutch C2. The D pressure is supplied to the supply port of the linear solenoid valve SL4 via the second bottom switching circuit of the shift valve SV3.

Meanwhile, because the solenoid valve S2 is at the OFF-state (×), the D pressure, which traveled through the second bottom switching circuit of the shift valve SV3 and the fourth bottom switching circuit of the shift valve SV1, is cut off by the third bottom switching circuit of the shift valve SV2 and is not supplied to the supply port of the linear solenoid valve SL3. The D pressure is cut off by the first top switching circuit of the shift valve SV2 and the first top switching circuit of the shift valve SV1. Therefore, the D pressure does not reach the supply port of the linear solenoid valve SL1, the exhaust port of the linear solenoid valve SL1, and the brake B2S. Therefore, the clutch C2 (SL2) and the brake B1 (SL4) are engaged and the sixth shift stage is established.

The sixth embodiment of the present invention was described above. Substitution of the components by equivalents, addition of oil passages, addition of controls is applicable to this embodiment. For example, according to the sixth embodiment, the accumulator ACC3 for latching the shift valve SV1 is provided between the shift valve SV1 and the clutch C2.

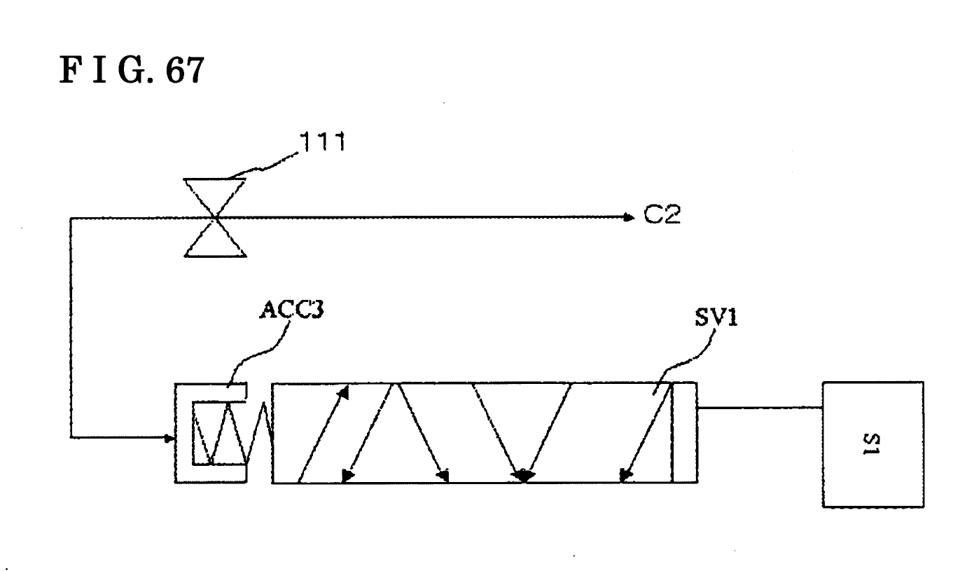

However, as illustrated in FIG. 67, the shift valve SV1 and the accumulator ACC3 can be integrated.

Further, it does not prevent providing a change valve against an ON-failure of the linear solenoid valve. In addition to the oil passage configuration illustrated in FIG. 56, a change valve operated at a time of detection of an ON-failure is provided so that oil pressure is drained at a time of failure.

Still further, according to the sixth embodiment, in order to simplify the configuration of the oil circuit, only the linear solenoid valve SL4 does not include an oil passage to be supplied with the D pressure through its exhaust port. Alternatively, the shift valve SV3 can be provided with a switching circuit communicated at the time of the solenoid valve S3 at the ON-state (∘). When the solenoid valve S2 is at the OFF-state (×) and the solenoid valve S3 is at the ON-state (∘), the D pressure is supplied to the exhaust port of the linear solenoid valve SL4 so that the brake B1 is frictionally engaged mandatorily.

Further, according to the embodiments of the present invention, totally four oil pressure switches are provided at the output sides of the linear solenoid valves, respectively. Alternatively, by detecting interlocking by means of software means on the basis of a turbine rotation or a shift stage, it is possible to abolish the above oil pressure switches.

### Seventh Embodiment

According to the sixth embodiment, a vehicle can be driven in the event of the OFF-failure by use of only the NL-type linear solenoid valves. However, the linear solenoid valves SL2 and SL3 can be NH-type. In this case, it does not prevent abolishing an accumulator, and there is no need to change the configuration of the oil pressure circuit. As is obvious from FIG. 57, if a shift pattern can be changed to a fixed shift stage mode, it is possible to assure a shift stage while a vehicle is driving. Hereinafter, a structure, in which the linear solenoid valves SL2 and SL3 are changed to normal high-type linear solenoid valves, and an accumulator is abolished, is described with reference to the attached drawing figures.

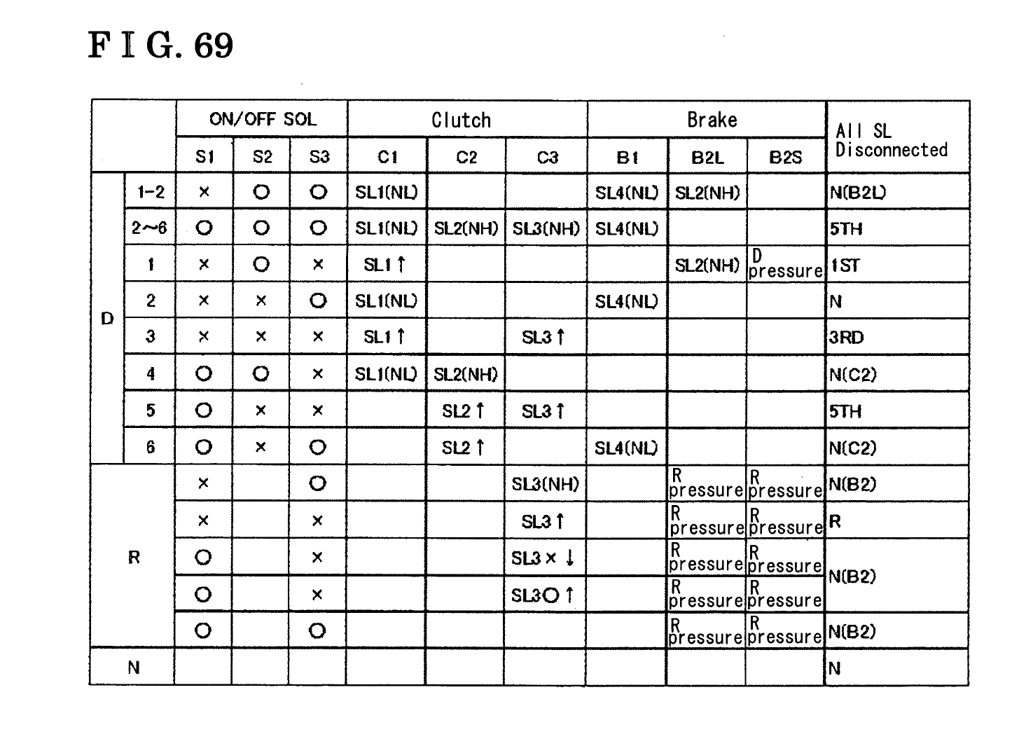

As is obvious from FIG. 69, by designing the linear solenoid valves SL2 and SL3 as the NH-type valves, it is possible to establish the fifth shift stage in the transmission, even in the event of all the SL electrically disconnected while a vehicle is driving at the automatic 2-6 shift mode at the D range. Further, even in the event of all the SL electrically disconnected under the first fixed shift mode, it is possible to start a vehicle at a stall condition with the brake B2L frictionally engaged.

Further, in the state where the solenoid valves S1 is at the ON-state (∘) during the R range, if all the linear solenoid valves are electrically disconnected, the R range is shifted to the N range. However, a shift range is controlled at the R range by changing the solenoid valve S1 to the Off-state (×).

As described above, if an NH-type linear solenoid valve, which excels in assuring a requisite amount of oil with high precision, is used, the oil pressure circuit can be operated with an excellent failure resistance, and the number of components can be reduced.

### Eighth Embodiment

Described below is a third embodiment of the present invention, according to which a manufacturing cost reduction is further improved.

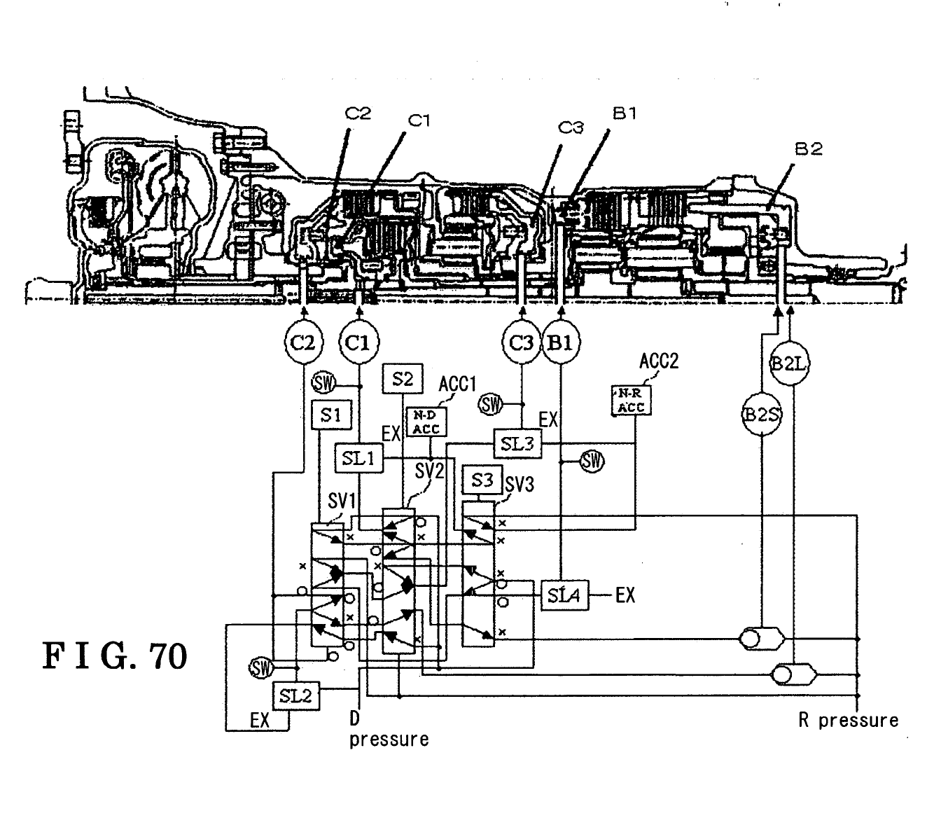

As illustrated in FIG. 70, the linear solenoid valve SL3 is an NH-type. Therefore, by abolishing the line pressure supply to the clutch C3 during the third or fifth shift stage, a single shuttle valve, which was employed in the first and second embodiments, is abolished.

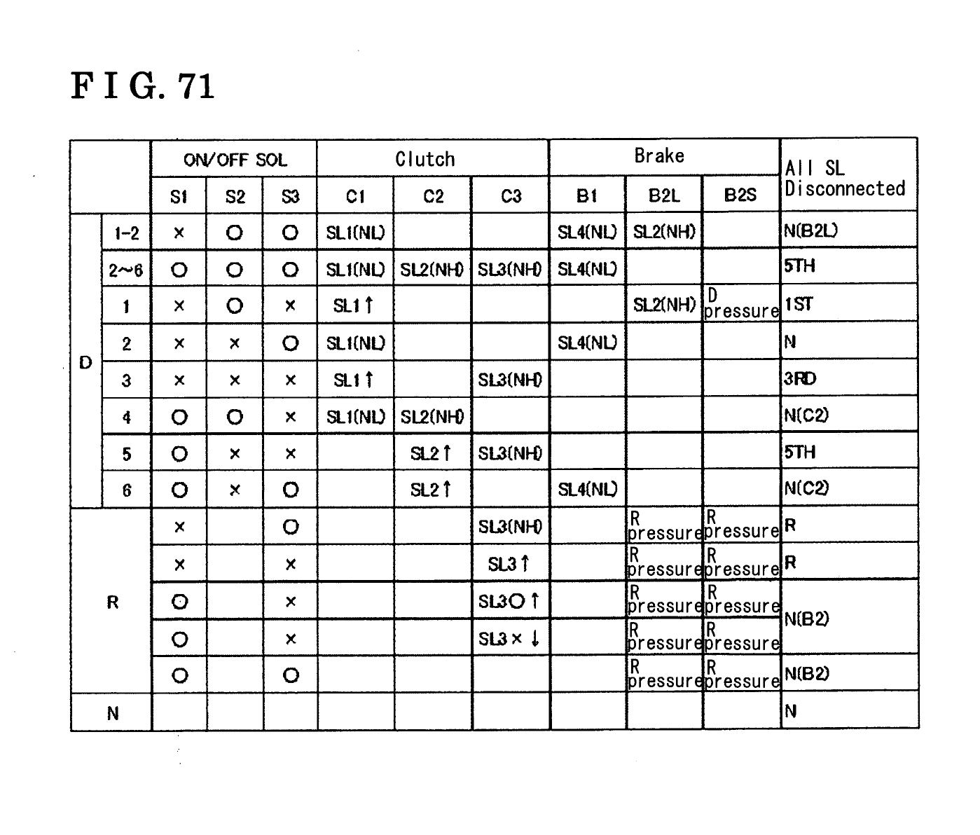

As is obvious from FIG. 71, also according to the eighth embodiment of the present invention, a vehicle can drive even in the event that all the linear solenoid valves are electrically disconnected. Moreover, a vehicle can drive at the fifth fixed shift stage also even in the event of the OFF-failure of the linear solenoid valve SL4. When the linear solenoid valve SL2 suffers from the OFF-failure, it is possible for a vehicle to drive at the sixth fixed shift stage. Further, when the linear solenoid valve suffers from the OFF-failure, it is possible for a vehicle to drive at both the sixth fixed shift stage and the fourth fixed shift stage. When the linear solenoid valve suffers from the OFF-failure, it is possible for a vehicle to drive at both the fifth and sixth shift stages.

### Ninth Embodiment

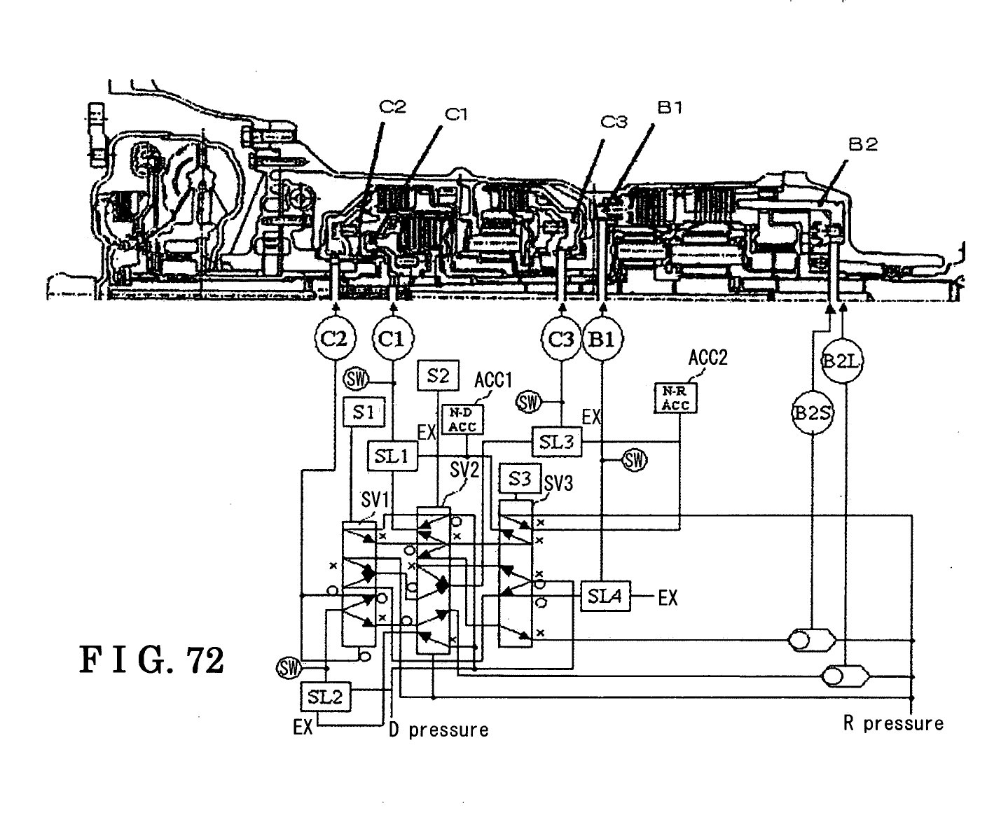

Described below is a ninth embodiment of the present invention. FIG. 72 is a block view illustrating an oil pressure circuit for an oil pressure control apparatus for an automatic transmission according to the ninth embodiment of the present invention. A table, which explains a relationship between the frictional engagement elements (clutches, brakes) and the linear solenoid valves under each operation pattern of the shift valves, is the same as the table of FIG. 71 so that the table for the ninth embodiment will be omitted here.

With reference to FIG. 72, the shift valve SV1 according to the ninth embodiment of the present invention does not have the first bottom switching circuit of the shift valve SV1. Therefore, an axial length of the shift valve SV1 is shorter than the one of the shift valve SV1 according to the eighth embodiment, which contributes to size reduction and saving a space. Further, this configuration of the shift valve SV1 contributes to a reduction of the total number of oil passages. In the same manner as the third embodiment (see FIG. 71), when the solenoid valves S2 is at the OFF-state (×), i.e., when one of the fifth or sixth shift stage is selected, the D pressure is supplied to the exhaust port of the linear solenoid valve SL2 so that the line pressure is supplied to the clutch C2.

As described above, the configuration of the shift valve SV1 according to the ninth embodiment is different from that of the eighth embodiment, in which the shift valve SV1 of the ninth embodiment does not possess the first bottom switching circuit. As a result, while a vehicle is running at a low shift stage, such as the third shift stage or lower, under the 2-6 automatic shift mode at the D range, if all electric disconnection occurs and the solenoid valve S2 is operated prior to the operation of the solenoid valve SV1, there is a possibility that an actually selected shift stage is controlled not at the third shift stage but at the fifth shift stage. In other words, the configuration of the shift valve SV1 of the ninth embodiment does not cause a downshifting. It is apparent that, if a shift lever is switched from the D range to the other range, or if an ignition key is operated again, after a vehicle stop, the vehicle can drive at the third shift stage.

### Tenth Embodiment

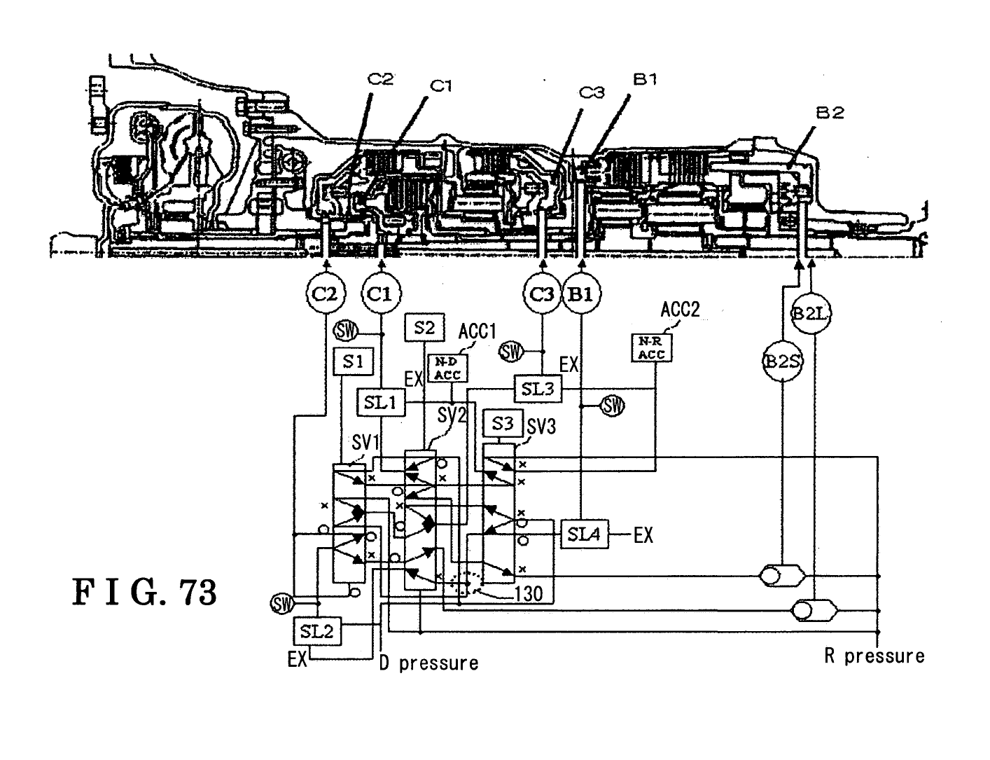

With reference to FIG. 73, only when the sixth shift stage is selected in the transmission, the line pressure is supplied to the clutch C2 by connecting the output oil passage of the second bottom switching circuit of the shift valve SV3 of the ninth embodiment to the input oil passage of the first bottom switching circuit SV2.

In the description of the ninth embodiment, it became apparent that the third shift stage is not maintained and is shifted to the fifth shift stage, if the solenoid valve S2 is operated prior to the operation of the solenoid valve S1 in the event of the all electric disconnection while a vehicle is running at the third shift stage or lower under the 2-6 automatic shift mode at the D-range. According to the tenth embodiment, it is possible to avoid the shift operation to the fifth shift stage under the aforementioned circumstance.

Further, according to the tenth embodiment, it is possible for a vehicle to drive at the fifth shift stage in the event of the OFF-failure of the linear solenoid valve SL4 and to drive at the sixth shift stage in the event of the OFF-failure of the linear solenoid valve SL3. Therefore, driving performance can be assured at the same level as the eighth embodiment.

It is also to be understood that the words used are words of description, rather than limitation, and that in actual practice various changed may be made without departing from the spirit and scope of the present invention. More particularly, it is applicable to add oil passages or controls. For example, according to the above-described embodiments, only when the solenoid valve S3 is at the ON-state (∘), a linear solenoid valve for lock-up, which is not illustrated, is connected. If the lock-up is performed after detecting a shifting to the 1-2 automatic shift mode based on a vehicle speed and so on, even if the linear solenoid valves malfunctions at the first shift stage, engine stall can be prevented immediately.

Further, according to the above embodiments, the oil pressure control apparatus is applied for an automatic transmission that establishes the forward six shift stages in combination with the five frictional engagement elements. However, the oil pressure control apparatus is applicable for other types of automatic transmissions. For example, according to the above embodiments, the eight shift patterns, which are prescribed by the third power of two (23), are configurable with three shift valves. Two of the eight shift patterns are assigned to automatic shift patterns. The other six of the eight shift patterns are assigned to fixed shift stages. Alternatively, when one of the eight shift patterns is assigned to a single automatic shift pattern, another one can be assigned to an auxiliary automatic shift pattern, or the other seven of the eight shift patterns can be seven fixed shift stages.

In order to implement a skip shift operation while a vehicle is running at the seventh shift stage or greater, the number of linear solenoid valves, which respectively actuates the frictional engagement elements, is increased. In this case, the present invention is applicable as well. Further, it is possible to enhance reliability of this apparatus against failures, by increasing the number of shift valves and shift patterns as needed.

The principles, of the preferred embodiments and mode of operation of the present invention have been described in the foregoing specification. However, the invention, which is intended to be protected, is not to be construed as limited to the particular embodiment disclosed. Further, the embodiment described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. An oil pressure control apparatus for an automatic transmission, comprising:
plural frictional engagement elements engageable and disengageable and operated to establish plural N forward shift stages by being engaged or disengaged;
solenoid valves allocated for at least a corresponding frictional engagement element among from the plural frictional engagement elements and operated to achieve an automatic shift mode in which the plural N forward shift stages are switched;
a controller for controlling oil pressure supplied to the frictional engagement elements via the solenoid valves so that engagement and disengagement of the frictional engagement elements are controlled; and
shift valves shifted ON and OFF by the controller in accordance with a shift pattern for each shift stage among from the plural N forward shift stages and configured to establish an oil passage between the respective solenoid valves and the at least corresponding frictional engagement element by being shifted ON and OFF, a specific combination of ON and OFF states of the shift valves being assigned to an automatic shift pattern for operating the solenoid valves for each shift stage of the automatic shift mode, one of other combinations of the ON and OFF states of the shift valves being assigned to a first fixed shift pattern of a first forward shift stage at which two predetermined solenoid valves from among the solenoid valves are employed, an other one of the other combinations being assigned to a second fixed shift pattern of a second forward shift stage at which other solenoid valves from among the solenoid valves are employed, one of the first and second fixed shift patterns being selected in response to operations of the shift valves for driving a vehicle.

2. An oil pressure control apparatus for an automatic transmission according to claim 1, wherein the two predetermined solenoid valves each are a normal high-type solenoid valve.

3. An oil pressure control apparatus for an automatic transmission according to claim 2, wherein the first fixed shift pattern, at which oil pressure is supplied to at least one of the frictional engagement elements for the first forward shift stage, is selected when all the shift valves are at the OFF state.

4. An oil pressure control apparatus for an automatic transmission according to claim 2, wherein the automatic shift pattern is switched between a 2-N automatic shift mode and a 1-2 automatic shift mode at which oil pressure is supplied to at least one of the frictional engagement elements for a reverse shift stage in combination with the ON and OFF states of the shift valves.

5. An oil pressure control apparatus for an automatic transmission according to claim 3, wherein a higher shift stage shift pattern and a lower shift stage shift pattern are determined in response to the ON and OFF states of predetermined shift valves from among the shift valves, the oil pressure control apparatus further comprises:
a latch circuit for maintaining current states of the predetermined shift valves by use of oil pressure from at least one frictional engagement element from among the frictional engagement element for the higher shift stage,
wherein a sudden decrease in oil pressure of normal-low type solenoid valves from among the solenoid vales which occurs due to a malfunction of the shift valve is prevented.

6. An oil pressure control apparatus for an automatic transmission according to claim 3, further comprising:
a switching oil passage allowing and prohibiting a communication between an exhaust port of at least one of the normal high-type solenoid valves and a predetermined oil pressure supply passage, the switching oil passage being established by the shift valves, and, when one of the first and second fixed shift patterns is selected in combination with the ON and OFF states of the shift valves, the switching oil passage introduces oil pressure from a supply port and the exhaust port of the at least one of the normal high-type solenoid valves so that one of the frictional engagement elements is frictionally engaged regardless of a failure mode of the at least one of the normal high-type solenoid valves.

7. An oil pressure control apparatus for an automatic transmission according to claim 3, further comprising:
a switching oil passage allowing and prohibiting a communication between an exhaust port of at least one of the normal high-type solenoid valves and a predetermined oil pressure supply passage, the switching oil passage being established by the shift valves, and, when one of the first and second fixed shift patterns is selected in combination with the ON and OFF states of the shift valves, the switching oil passage introduces oil pressure from a supply port and the exhaust port of the at least one of the normal high-type solenoid valves so that one of the frictional engagement elements is frictionally engaged regardless of a failure mode of the at least one of the normal high-type solenoid valves.

8. An oil pressure control apparatus for an automatic transmission according to claim 3, further comprising:
a switching oil passage allowing and prohibiting a communication between an exhaust port of at least one of the normal high-type solenoid valves and a predetermined oil pressure supply passage, the switching oil passage being established by the shift valves, and, when one of the first and second fixed shift patterns is selected in combination with the ON and OFF states of the shift valves, the switching oil passage introduces oil pressure from a supply port and the exhaust port of the at least one of the normal high-type solenoid valves so that one of the frictional engagement elements is frictionally engaged regardless of a failure mode of the at least one of the normal high-type solenoid valves.

9. An oil pressure control apparatus for an automatic transmission according to claim 6, wherein an accumulator and an orifice are arranged at an upstream of the switching oil passage.

10. An oil pressure control apparatus for an automatic transmission according to claim 7, wherein an accumulator and an orifice are arranged at an upstream of the switching oil passage.

11. An oil pressure control apparatus for an automatic transmission according to claim 8, wherein an accumulator and an orifice are arranged at an upstream of the switching oil passage.

12. An oil pressure control apparatus for an automatic transmission according to claim 1, wherein oil pressure is supplied mandatorily from the respective solenoid valves to the at least corresponding frictional engagement element.

13. An oil pressure control apparatus for an automatic transmission according to claim 1, wherein, when all the shift valves are at the OFF state, a fixed shift pattern, at which oil pressure is supplied to one of the frictional engagement elements for one of the first and second forward shift stages, is selected, oil pressure is introduced from a supply port and an exhaust port of at least one of the solenoid valves to one of the frictional engagement elements so that the frictional engagement elements are frictionally engaged.

14. An oil pressure control apparatus for an automatic transmission according to claim 12, wherein the automatic shift pattern is switched between a 2-n automatic shift mode and a 1-2 automatic shift mode at which oil pressure is supplied to a frictional engagement element for a reverse shift stage in combination with the ON and OFF states of the shift valves.

15. An oil pressure control apparatus for an automatic transmission according to claim 13, wherein the automatic shift pattern is switched between a 2-n automatic shift mode and a 1-2 automatic shift mode at which oil pressure is supplied to a frictional engagement element for a reverse shift stage in combination with the ON and OFF states of the shift valves.

16. An oil pressure control apparatus for an automatic transmission according to claim 12, wherein a higher shift stage side shift pattern and a lower shift stage side shift pattern are determined in response to the ON and OFF state of a predetermined shift valve from among the shift valves, the oil pressure control apparatus further comprises:
a latch circuit for maintaining a current state of the predetermined shift valve by use of oil pressure from a frictional engagement element for the higher shift stage, and
an accumulator and an orifice arranged at an upstream of the latch circuit, wherein one of the shift valves is maintained for a predetermined period of time even when an oil pressure supply to the latch circuit is interrupted so that sudden reduction of oil pressure due to a malfunction of one of the shift valves is prevented.

17. An oil pressure control apparatus for an automatic transmission according to claim 13, wherein a higher shift stage side shift pattern and a lower shift stage side shift pattern are determined in response to the ON and OFF state of a predetermined shift valve from among the shift valves, the oil pressure control apparatus further comprises:
a latch circuit for maintaining a current state of the predetermined shift valve by use of oil pressure from a frictional engagement element for the higher shift stage, and an accumulator and an orifice arranged at an upstream of the latch circuit, wherein one of the shift valves is maintained for a predetermined period of time even when an oil pressure supply to the latch circuit is interrupted so that sudden reduction of oil pressure due to a malfunction of one of the shift valves is prevented.

18. An oil pressure control apparatus for an automatic transmission according to claim 13, wherein a higher shift stage side shift pattern and a lower shift stage side shift pattern are determined in response to the ON and OFF state of a predetermined shift valve from among the shift valves, the oil pressure control apparatus further comprises:
a latch circuit for maintaining a current state of the predetermined shift valve by use of oil pressure from a frictional engagement element for the higher shift stage, and an accumulator and an orifice arranged at an upstream of the latch circuit, wherein one of the shift valves is maintained for a predetermined period of time even when an oil pressure supply to the latch circuit is interrupted so that sudden reduction of oil pressure due to a malfunction of one of the shift valves is prevented.

19. An oil pressure control apparatus for an automatic transmission according to claim 14, wherein a higher shift stage side shift pattern and a lower shift stage side shift pattern are determined in response to the ON and OFF state of a predetermined shift valve from among the shift valves, the oil pressure control apparatus further comprises:
a latch circuit for maintaining a current state of the predetermined shift valve by use of oil pressure from a frictional engagement element for the higher shift stage, and an accumulator and an orifice arranged at an upstream of the latch circuit, wherein one of the shift valves is maintained for a predetermined period of time even when an oil pressure supply to the latch circuit is interrupted so that sudden reduction of oil pressure due to a malfunction of one of the shift valves is prevented.

20. An oil pressure control apparatus for an automatic transmission according to claim 15, wherein a higher shift stage side shift pattern and a lower shift stage side shift pattern are determined in response to the ON and OFF state of a predetermined shift valve from among the shift valves, the oil pressure control apparatus further comprises:
a latch circuit for maintaining a current state of the predetermined shift valve by use of oil pressure from a frictional engagement element for the higher shift stage, and an accumulator and an orifice arranged at an upstream of the latch circuit, wherein one of the shift valves is maintained for a predetermined period of time even when an oil pressure supply to the latch circuit is interrupted so that sudden reduction of oil pressure due to a malfunction of one of the shift valves is prevented.
